(19) United States
(12) Patent Application Publication
(10) Pub. No.: US 2024/0114573 A1
(43) Pub. Date: Apr. 4, 2024

(54) WIRELESS COMMUNICATION METHOD USING MULTI-LINK AND WIRELESS COMMUNICATION TERMINAL USING SAME

(71) Applicant: WILUS INSTITUTE OF STANDARDS AND TECHNOLOGY INC., Gyeonggi-do (KR)

(72) Inventors: Geonjung KO, Gyeonggi-do (KR); Juhyung SON, Gyeonggi-do (KR); Sanghyun KIM, Gyeonggi-do (KR); Jinsam KWAK, Gyeonggi-do (KR)

(21) Appl. No.: 18/534,580

(22) Filed: Dec. 9, 2023

Related U.S. Application Data
(63) Continuation of application No. PCT/KR2022/008329, filed on Jun. 13, 2022.

(30) Foreign Application Priority Data
Jun. 11, 2021 (KR) 10-2021-0076370
Jun. 23, 2021 (KR) 10-2021-0081934
Jun. 24, 2021 (KR) 10-2021-0082740
May 12, 2022 (KR) 10-2022-0058640
May 27, 2022 (KR) 10-2022-0065373

(51) Int. Cl. H04W 76/15; H04W 28/02

(52) U.S. Cl. CPC H04W 76/15; H04W 28/0278

(57) ABSTRACT

Disclosed is a non-access point (non-AP) multi-link device comprising a plurality of stations operating at respective plurality of links. The multi-link device comprises a transceiver and a processor. The processor receives, from an AP multi-link device, a beacon frame including a TIM element and a Multi-Link Traffic element, and, based on a Partial Virtual Bitmap subfield of the TIM element, determines whether traffic for the non-AP multi-link device is buffered to the AP multi-link device.

### TECHNICAL FIELD

The present disclosure relates to a wireless communication method using multiple links and a wireless communication terminal using the same.

### BACKGROUND ART

In recent years, with supply expansion of mobile apparatuses, a wireless LAN technology that can provide a rapid wireless Internet service to the mobile apparatuses has been significantly spotlighted. The wireless LAN technology allows mobile apparatuses including a smart phone, a smart pad, a laptop computer, a portable multimedia player, an embedded apparatus, and the like to wirelessly access the Internet in home or a company or a specific service providing area based on a wireless communication technology in a short range.

Institute of Electrical and Electronics Engineers (IEEE) 802.11 has commercialized or developed various technological standards since an initial wireless LAN technology is supported using frequencies of 2.4 GHz. First, the IEEE 802.11b supports a communication speed of a maximum of 11 Mbps while using frequencies of a 2.4 GHz band. IEEE 802.11a which is commercialized after the IEEE 802.11b uses frequencies of not the 2.4 GHz band but a 5 GHz band to reduce an influence by interference as compared with the frequencies of the 2.4 GHz band which are significantly congested and improves the communication speed up to a maximum of 54 Mbps by using an OFDM technology. However, the IEEE 802.11a has a disadvantage in that a communication distance is shorter than the IEEE 802.11b. In addition, IEEE 802.11g uses the frequencies of the 2.4 GHz band similarly to the IEEE 802.11b to implement the communication speed of a maximum of 54 Mbps and satisfies backward compatibility to significantly come into the spotlight and further, is superior to the IEEE 802.11a in terms of the communication distance.

Moreover, as a technology standard established to overcome a limitation of the communication speed which is pointed out as a weak point in a wireless LAN, IEEE 802.11n has been provided. The IEEE 802.11n aims at increasing the speed and reliability of a network and extending an operating distance of a wireless network. In more detail, the IEEE 802.11n supports a high throughput (HT) in which a data processing speed is a maximum of 540 Mbps or more and further, is based on a multiple inputs and multiple outputs (MIMO) technology in which multiple antennas are used at both sides of a transmitting unit and a receiving unit in order to minimize a transmission error and optimize a data speed. Further, the standard can use a coding scheme that transmits multiple copies which overlap with each other in order to increase data reliability.

As the supply of the wireless LAN is activated and further, applications using the wireless LAN are diversified, the need for new wireless LAN systems for supporting a higher throughput (very high throughput (VHT)) than the data processing speed supported by the IEEE 802.11n has come into the spotlight. Among them, IEEE 802.11ac supports a wide bandwidth (80 to 160 MHz) in the GHz frequencies. The IEEE 802.11ac standard is defined only in the 5 GHz band, but initial 11ac chipsets will support even operations in the 2.4 GHz band for the backward compatibility with the existing 2.4 GHz band products. Theoretically, according to the standard, wireless LAN speeds of multiple stations are enabled up to a minimum of 1 Gbps and a maximum single link speed is enabled up to a minimum of 500 Mbps. This is achieved by extending concepts of a wireless interface accepted by 802.11n, such as a wider wireless frequency bandwidth (a maximum of 160 MHz), more MIMO spatial streams (a maximum of 8), multi-user MIMO, and high-density modulation (a maximum of 256 QAM). Further, as a scheme that transmits data by using a 60 GHz band instead of the existing 2.4 GHz/5 GHz, IEEE 802.11ad has been provided. The IEEE 802.11ad is a transmission standard that provides a speed of a maximum of 7 Gbps by using a beamforming technology and is suitable for high bit rate moving picture streaming such as massive data or non-compression HD video. However, since it is difficult for the 60 GHz frequency band to pass through an obstacle, it is disadvantageous in that the 60 GHz frequency band can be used only among devices in a short-distance space.

As a wireless LAN standard after 802.11ac and 802.11ad, the IEEE 802.11ax (high efficiency WLAN, HEW) standard for providing a high-efficiency and high-performance wireless LAN communication technology in a high-density environment, in which APs and terminals are concentrated, is in the development completion stage. In an 802.11ax-based wireless LAN environment, communication with high frequency efficiency should be provided indoors/outdoors in the presence of high-density stations and access points (APs), and various technologies have been developed to implement the same.

In order to support new multimedia applications, such as high-definition video and real-time games, the development of a new wireless LAN standard has begun to increase a maximum transmission rate. In IEEE 802.11be (extremely high throughput, EHT), which is a 7th generation wireless LAN standard, development of standards is underway aiming at supporting a transmission rate of up to 30 Gbps via a wider bandwidth, an increased spatial stream, multi-AP cooperation, and the like in a 2.4/5/6 GHz band.

### DISCLOSURE OF INVENTION

### Technical Problem

An aspect of an embodiment of the present disclosure is to provide a wireless communication method using multiple links and a wireless communication terminal using the same.

### Solution to Problem

In accordance with an embodiment of the present disclosure, a non-access point (non-AP) multi-link device including multiple stations each operating in multiple links may include a transceiver and a processor. The processor may be configured to receive a beacon frame including a TIM element and a Multi-Link Traffic element from an AP multi-link device, and to determine, based on a Partial Virtual Bitmap subfield of the TIM element, whether traffic for the non-AP multi-link device has been buffered to the AP multi-link device. The Partial Virtual Bitmap subfield may include one or more first bits and one or more second bits, a bit set to 1 among the one or more first bits may indicate that traffic for a non-AP multi-link device corresponding to the bit has been buffered to the AP multi-link device, and a bit set to 1 among the one or more second bits may indicate whether traffic for a non-AP station corresponding to the bit has been buffered to the AP multi-link device. The processor may be configured to, when the traffic for the non-AP multi-link device has been buffered to the AP multi-link device, determine, based on a Per-Link Traffic Indication List subfield of the Multi-Link Traffic element, which of the multiple links is a link in which the traffic for the non-AP multi-link device has been buffered or which of the multiple links is a link in which the AP multi-link device recommends the non-AP multi-link device to retrieve traffic transmission. The Per-Link Traffic Indication List subfield may include n Per-Link Traffic Indication Bitmap subfields, wherein n is a value obtained by summing the number of bits set to 1 among the one or more first bits and the number of bits set to 1 among the one or more second bits, and the n Per-Link Traffic Indication Bitmap subfields may be mapped to a non-AP multi-link device corresponding to the bit set to 1 among the one or more first bits and a non-AP station corresponding to the bit set to 1 among the one or more second bits, respectively.

The Per-Link Traffic Indication Bitmap subfield that is mapped to the non-AP station corresponding to the bit set to 1 among the one or more second bits may be configured as a reserved bit.

The reserved bit may have a value of 0.

When the non-AP multi-link device successfully performs TID-to-link mapping with the AP multi-link device and that not all TIDs are mapped to all links, the Per-Link Traffic Indication Bitmap subfield mapped to the non-AP multi-link device may indicate whether the traffic for the non-AP multi-link device is buffered in each of the multiple links.

When default mapping is applied to a link between the non-AP multi-link device and the AP multi-link device, the Per-Link Traffic Indication Bitmap subfield mapped to the non-AP multi-link device may indicate which of the multiple links is a link in which the non-AP multi-link device is recommended to retrieve traffic transmission. In the default mapping, all TIDs are mapped to all links.

Among bits in the Per-Link Traffic Indication Bitmap subfield mapped to the non-AP multi-link device, a bit corresponding to a link that is not set up by the AP multi-link device or the non-AP multi-link device may be configured as a reserved bit.

Among the bits in the Per-Link Traffic Indication Bitmap subfield mapped to the non-AP multi-link device, a bit corresponding to a disabled link of the non-AP multi-link device may be configured as a reserved bit. The disabled link may be a link in which uplink transmission and downlink transmission have been stopped.

The multiple link IDs may be mapped, in ascending order, to the bits in the Per-Link Traffic Indication Bitmap subfield mapped to the non-AP multi-link device.

When an AP having transmitted the beacon frame in the AP multi-link device does not belong to a multiple BSSID set, the range of values that the AP multi-link device is capable of assigning as an association ID (AID) may be determined based on a value of a Group Addressed BU Indication Exponent subfield. The value of the Group Addressed BU Indication Exponent subfield may indicate the number of bits that is to be used to indicate a buffered group addressed frame corresponding to an AP different from the AP having transmitted the beacon frame in the AP multi-link device.

When the AP having transmitted the beacon frame in the AP multi-link device belongs to the multiple BSSID set, the range of values that the AP multi-link device is capable of assigning as an AID may be determined based on the value of the Group Addressed BU Indication Exponent subfield and a bitmap limit. The bitmap limit may be 48 bits.

According to an embodiment of the present disclosure, an access point (AP) multi-link device including multiple stations each operating in multiple links includes a transceiver and a processor. The processor is configured to configure a TIM element and a Multi-Link Traffic element which is to be included in a beacon frame to be transmitted to a non-AP multi-link device. The TIM element includes a Partial Virtual Bitmap subfield. The Partial Virtual Bitmap subfield includes one or more first bits and one or more second bits, a bit set to 1 among the one or more first bits indicates that traffic for a non-AP multi-link device corresponding to the bit has been buffered to the AP multi-link device, and a bit set to 1 among the one or more second bits may indicate whether traffic for a non-AP station corresponding to the bit has been buffered to the AP multi-link device. The processor is configured to, when the traffic for the non-AP multi-link device has been buffered to the AP multi-link device, configure a Per-Link Traffic Indication List subfield of the Multi-Link Traffic element, based on which of the multiple links is a link in which the traffic for the non-AP multi-link device has been buffered or which of the multiple links is a link in which the AP multi-link device recommends the non-AP multi-link device to retrieve traffic transmission.

The processor is configured to transmit the beacon frame by using the transceiver.

The Per-Link Traffic Indication List subfield includes n Per-Link Traffic Indication Bitmap subfields. n is a value obtained by summing the number of bits set to 1 among the one or more first bits and the number of bits set to 1 among the one or more second bits. In addition, the n Per-Link Traffic Indication Bitmap subfields are mapped to a non-AP multi-link device corresponding to the bit set to 1 among the one or more first bits and a non-AP station corresponding to the bit set to 1 among the one or more second bits, respectively.

The processor may be configured to configure, as a reserved bit, the Per-Link Traffic Indication Bitmap subfield that is mapped to the non-AP station corresponding to the bit set to 1 among the one or more second bits.

The reserved bit may have a value of 0.

When the non-AP multi-link device successfully performs TID-to-link mapping with the AP multi-link device and that not all TIDs are mapped to all links, the Per-Link Traffic Indication Bitmap subfield mapped to the non-AP multi-link device may indicate whether the traffic for the non-AP multi-link device is buffered in each of the multiple links.

When default mapping is applied to a link between the non-AP multi-link device and the AP multi-link device, the Per-Link Traffic Indication Bitmap subfield mapped to the non-AP multi-link device may indicate which of the multiple links is a link in which the non-AP multi-link device is recommended to retrieve traffic transmission. In the default mapping, all TIDs are mapped to all links.

The processor may be configured to configure, as a reserved bit, a bit corresponding to a link that is not set up by the AP multi-link device or the non-AP multi-link device among bits in the Per-Link Traffic Indication Bitmap subfield mapped to the non-AP multi-link device.

The processor may be configured to configure, as a reserved bit, a bit corresponding to a disabled link of the non-AP multi-link device among the bits in the Per-Link Traffic Indication Bitmap subfield mapped to the non-AP multi-link device. The disabled link may be a link in which uplink transmission and downlink transmission have been stopped.

The multiple link IDs may be mapped, in ascending order, to the bits in the Per-Link Traffic Indication Bitmap subfield mapped to the non-AP multi-link device.

When an AP having transmitted the beacon frame in the AP multi-link device does not belong to a multiple BSSID set, the range of values that the AP multi-link device is capable of assigning as an association ID (AID) may be determined based on a value of a Group Addressed BU Indication Exponent subfield. The value of the Group Addressed BU Indication Exponent subfield may indicate the number of bits that is to be used to indicate a buffered group addressed frame corresponding to an AP different from the AP having transmitted the beacon frame in the AP multi-link device.

When the AP having transmitted the beacon frame in the AP multi-link device belongs to the multiple BSSID set, the range of values that the AP multi-link device is capable of assigning as an AID may be determined based on the value of the Group Addressed BU Indication Exponent subfield and a bitmap limit. The bitmap limit may be 48 bits.

A method for operating a non-access point (non-AP) multi-link device including multiple stations each operating in multiple links includes: receiving a beacon frame including a TIM element and a Multi-Link Traffic element from an AP multi-link device; determining, based on a Partial Virtual Bitmap subfield of the TIM element, whether traffic for the non-AP multi-link device has been buffered to the AP multi-link device, wherein the Partial Virtual Bitmap subfield includes one or more first bits and one or more second bits, a bit set to 1 among the one or more first bits indicates that traffic for a non-AP multi-link device corresponding to the bit has been buffered to the AP multi-link device, and a bit set to 1 among the one or more second bits indicates whether traffic for a non-AP station corresponding to the bit has been buffered to the AP multi-link device, and when the traffic for the non-AP multi-link device has been buffered to the AP multi-link device, determining based on a Per-Link Traffic Indication List subfield of the Multi-Link Traffic element, which of the multiple links is a link in which the traffic for the non-AP multi-link device has been buffered or which of the multiple links is a link in which the AP multi-link device recommends the non-AP multi-link device to retrieve traffic transmission. The Per-Link Traffic Indication List subfield may include n Per-Link Traffic Indication Bitmap subfields, wherein n is a value obtained by summing the number of bits set to 1 among the one or more first bits and the number of bits set to 1 among the one or more second bits, and the n Per-Link Traffic Indication Bitmap subfields are mapped to a non-AP multi-link device corresponding to the bit set to 1 among the one or more first bits and a non-AP station corresponding to the bit set to 1 among the one or more second bits, respectively.

The Per-Link Traffic Indication Bitmap subfield that is mapped to the non-AP station corresponding to the bit set to 1 among the one or more second bits may be configured as a reserved bit.

### Advantageous Effects of Invention

An embodiment of the present disclosure provides a wireless communication method efficiently using multiple links and a wireless communication terminal using the same.

### BRIEF DESCRIPTION OF DRAWINGS

FIG. 1 illustrates a wireless LAN system according to an embodiment of the present invention.

FIG. 2 illustrates a wireless LAN system according to another embodiment of the present invention.

FIG. 3 illustrates a configuration of a station according to an embodiment of the present invention.

FIG. 4 illustrates a configuration of an access point according to an embodiment of the present invention.

FIG. 5 schematically illustrates a process in which a STA and an AP set a link.

FIG. 6 illustrates a carrier sense multiple access (CSMA)/collision avoidance (CA) method used in wireless LAN communication.

FIG. 7 illustrates an example of a format of a PLCP Protocol data unit (PPDU) for each of various standard generations.

FIG. 8 illustrates an example of various extremely high throughput (EHT) physical protocol data unit (PPDU) formats and a method for indicating the same according to an embodiment of the present invention.

FIG. 9 illustrates a multi-link device according to an embodiment of the present disclosure.

FIG. 10 illustrates multiple links mapped based on a multi-link mapping method according to an embodiment of the present disclosure.

FIG. 11 illustrates a power management operation performed by a station according to an embodiment of the present disclosure.

FIG. 12 illustrates the format of a TIM element according to an embodiment of the present disclosure.

FIG. 13 illustrates the format of a Multi-Link Traffic element according to an embodiment of the present disclosure.

FIG. 14 illustrates a method by which a Multi-Link Traffic element and a Partial Virtual Bitmap subfield in a TIM element according to an embodiment of the present disclosure is used to signal traffic buffered to an AP multi-link device.

FIG. 15 illustrates a method for configuring a Multi-Link Traffic element according to an embodiment of the present disclosure.

FIG. 16 illustrates a method for configuring a Per-Link Traffic Bitmap subfield in a Multi-Link Traffic element when a link set in which an AP multi-link device according to an embodiment of the present disclosure operates is different from a link set in which a non-AP multi-link device communicating with the AP multi-link device operates.

FIG. 17 illustrates a method by which a link indicated by a Per-Link Traffic Bitmap subfield is determined based on TID-to-link mapping according to an embodiment of the present disclosure.

FIG. 18 illustrates a method by which an AP multi-link device according to another embodiment of the present disclosure configures a Per-Link Traffic Indication Bitmap subfield in a Multi-Link Traffic element.

FIG. 19 illustrates an EHT Operation element according to an embodiment of the present disclosure.

FIG. 20 illustrates a traffic indication virtual bitmap according to an embodiment of the present disclosure.

FIG. 21 illustrates a traffic indication virtual bitmap according to an embodiment of the present disclosure.

FIG. 22 illustrates signaling related to MediumSyncDelay and a Multi-Link element according to an embodiment of the present disclosure.

FIG. 23 illustrates a multi-link setup process according to an embodiment of the present disclosure.

FIG. 24 illustrates the format of a Reduced Neighbor Report element according to an embodiment of the present disclosure.

FIG. 25 illustrates a method for configuring an ID of a multi-link device according to an embodiment of the present disclosure.

FIG. 26 illustrates a method of assigning an AID to a non-AP station belonging to a multi-link device according to an embodiment of the present disclosure.

FIG. 27 illustrates a method of assigning an AID to a non-AP station belonging to a multi-link device according to an embodiment of the present disclosure.

FIG. 28 illustrates a TID-to-link mapping negotiation through which an AP multi-link device transmits a TID-to-link mapping request according to an embodiment of the present disclosure.

FIG. 29 illustrates a TID-to-link mapping negotiation through which an AP multi-link device transmits a TID-to-link mapping request according to an embodiment of the present disclosure.

FIG. 30 illustrates a TID-to-link mapping negotiation when a link set for requesting TID-to-link mapping is different from a link set configured by a TID-to-link mapping response according to an embodiment of the present disclosure.

FIG. 31 illustrates a method by which a non-AP multi-link device according to an embodiment of the present disclosure determines traffic buffered to an AP multi-link device.

### BEST MODE FOR CARRYING OUT THE INVENTION

Terms used in the specification adopt general terms which are currently widely used by considering functions in the present invention, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

Throughout this specification and the claims that follow, when it is described that an element is “coupled” to another element, the element may be “directly coupled” to the other element or “electrically coupled” to the other element through a third element. Further, unless explicitly described to the contrary, the word “comprise” and variations such as “comprises” or “comprising”, will be understood to imply the inclusion of stated elements but not the exclusion of any other elements. Moreover, limitations such as “or more” or “or less” based on a specific threshold may be appropriately substituted with “more than” or “less than”, respectively.

Hereinafter, in the present invention, a field and a subfield may be interchangeably used.

FIG. 1 illustrates a wireless LAN system according to an embodiment of the present invention.

FIG. 1 is a diagram illustrating a wireless LAN system according to an embodiment of the present invention. The wireless LAN system includes one or more basic service sets (BSS) and the BSS represents a set of apparatuses which are successfully synchronized with each other to communicate with each other. In general, the BSS may be classified into an infrastructure BSS and an independent BSS (IBSS) and FIG. 1 illustrates the infrastructure BSS between them.

As illustrated in FIG. 1, the infrastructure BSS (BSS1 and BSS2) includes one or more stations STA1, STA2, STA3, STA4, and STA5, access points AP-1 and AP-2 which are stations providing a distribution service, and a distribution system (DS) connecting the multiple access points AP-1 and AP-2.

The station (STA) is a predetermined device including medium access control (MAC) following a regulation of an IEEE 802.11 standard and a physical layer interface for a wireless medium, and includes both a non-access point (non-AP) station and an access point (AP) in a broad sense. Further, in the present specification, a term ‘terminal’ may be used to refer to a non-AP STA, or an AP, or to both terms. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally connected with the processor and transmits and receives frames through the wireless network for the station. According to the present invention, a terminal may be used as a term which includes user equipment (UE).

The access point (AP) is an entity that provides access to the distribution system (DS) via wireless medium for the station associated therewith. In the infrastructure BSS, communication among non-AP stations is, in principle, performed via the AP, but when a direct link is configured, direct communication is enabled even among the non-AP stations. Meanwhile, in the present invention, the AP is used as a concept including a personal BSS coordination point (PCP) and may include concepts including a centralized controller, a base station (BS), a node-B, a base transceiver system (BTS), and a site controller in a broad sense. In the present invention, an AP may also be referred to as a base wireless communication terminal. The base wireless communication terminal may be used as a term which includes an AP, a base station, an eNB (i.e. eNodeB) and a transmission point (TP) in a broad sense. In addition, the base wireless communication terminal may include various types of wireless communication terminals that allocate medium resources and perform scheduling in communication with a plurality of wireless communication terminals.

A plurality of infrastructure BSSs may be connected with each other through the distribution system (DS). In this case, a plurality of BSSs connected through the distribution system is referred to as an extended service set (ESS).

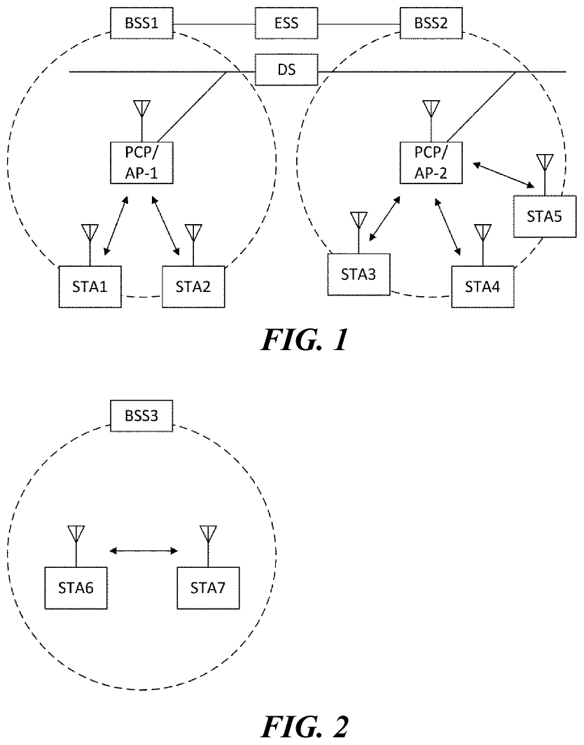

FIG. 2 illustrates an independent BSS which is a wireless LAN system according to another embodiment of the present invention. In the embodiment of FIG. 2, duplicative description of parts, which are the same as or correspond to the embodiment of FIG. 1, will be omitted.

Since a BSS3 illustrated in FIG. 2 is the independent BSS and does not include the AP, all stations STA6 and STA7 are not connected with the AP. The independent BSS is not permitted to access the distribution system and forms a self-contained network. In the independent BSS, the respective stations STA6 and STA7 may be directly connected with each other.

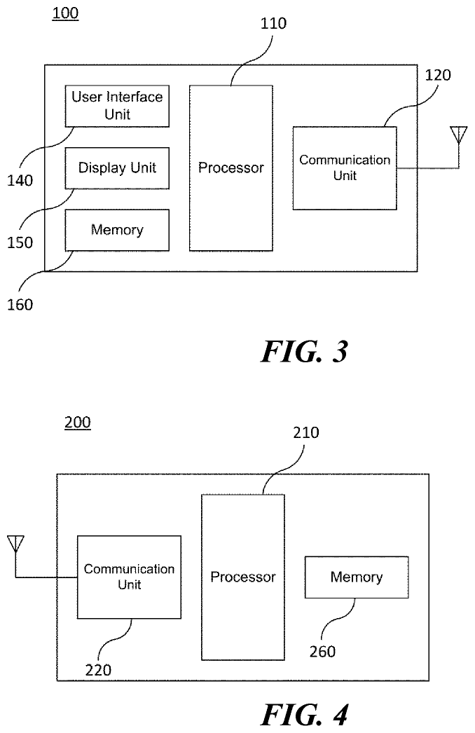

FIG. 3 is a block diagram illustrating a configuration of a station 100 according to an embodiment of the present invention. As illustrated in FIG. 3, the station 100 according to the embodiment of the present invention may include a processor 110, a communication unit 120, a user interface unit 140, a display unit 150, and a memory 160.

First, the communication unit 120 transmits and receives a wireless signal such as a wireless LAN packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHz, 5 GHz, 6 GHz and 60 GHz. According to an embodiment, the station 100 may include a communication module using a frequency band of 7.125 GHz or more and a communication module using a frequency band of 7.125 GHz or less. The respective communication modules may perform wireless communication with the AP or an external station according to a wireless LAN standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present invention, the communication unit 120 may represent a radio frequency (RF) communication module for processing an RF signal.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like. Further, the memory 160 stores a control program used in the station 100 and various resulting data. The control program may include an access program required for the station 100 to access the AP or the external station.

The processor 110 of the present invention may execute various commands or programs and process data in the station 100. Further, the processor 110 may control the respective units of the station 100 and control data transmission/reception among the units. According to the embodiment of the present invention, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 of the present invention may represent a main control unit of the station 100 and according to the embodiment, the processor 110 may represent a control unit for individually controlling some component of the station 100, for example, the communication unit 120, and the like. That is, the processor 110 may be a modem or a modulator/demodulator for modulating and demodulating wireless signals transmitted to and received from the communication unit 120. The processor 110 controls various operations of wireless signal transmission/reception of the station 100 according to the embodiment of the present invention. A detailed embodiment thereof will be described below.

The station 100 illustrated in FIG. 3 is a block diagram according to an embodiment of the present invention, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present invention, some components of the station 100, for example, the user interface unit 140 and the display unit 150 may be optionally provided in the station 100.

FIG. 4 is a block diagram illustrating a configuration of an AP 200 according to an embodiment of the present invention. As illustrated in FIG. 4, the AP 200 according to the embodiment of the present invention may include a processor 210, a communication unit 220, and a memory 260. In FIG. 4, among the components of the AP 200, duplicative description of parts which are the same as or correspond to the components of the station 100 of FIG. 2 will be omitted.

Referring to FIG. 4, the AP 200 according to the present invention includes the communication unit 220 for operating the BSS in at least one frequency band. As described in the embodiment of FIG. 3, the communication unit 220 of the AP 200 may also include a plurality of communication modules using different frequency bands. That is, the AP 200 according to the embodiment of the present invention may include two or more communication modules among different frequency bands, for example, 2.4 GHz, 5 GHz, 6 GHz and 60 GHz together. Preferably, the AP 200 may include a communication module using a frequency band of 7.125 GHz or more and a communication module using a frequency band of 7.125 GHz or less. The respective communication modules may perform wireless communication with the station according to a wireless LAN standard of a frequency band supported by the corresponding communication module. The communication unit 220 may operate only one communication module at a time or simultaneously operate multiple communication modules together according to the performance and requirements of the AP 200. In an embodiment of the present invention, the communication unit 220 may represent a radio frequency (RF) communication module for processing an RF signal.

Next, the memory 260 stores a control program used in the AP 200 and various resulting data. The control program may include an access program for managing the access of the station. Further, the processor 210 may control the respective units of the AP 200 and control data transmission/reception among the units. According to the embodiment of the present invention, the processor 210 may execute the program for accessing the station stored in the memory 260 and transmit communication configuration messages for one or more stations. In this case, the communication configuration messages may include information about access priority conditions of the respective stations. Further, the processor 210 performs an access configuration according to an access request of the station. According to an embodiment, the processor 210 may be a modem or a modulator/demodulator for modulating and demodulating wireless signals transmitted to and received from the communication unit 220. The processor 210 controls various operations such as wireless signal transmission/reception of the AP 200 according to the embodiment of the present invention. A detailed embodiment thereof will be described below.

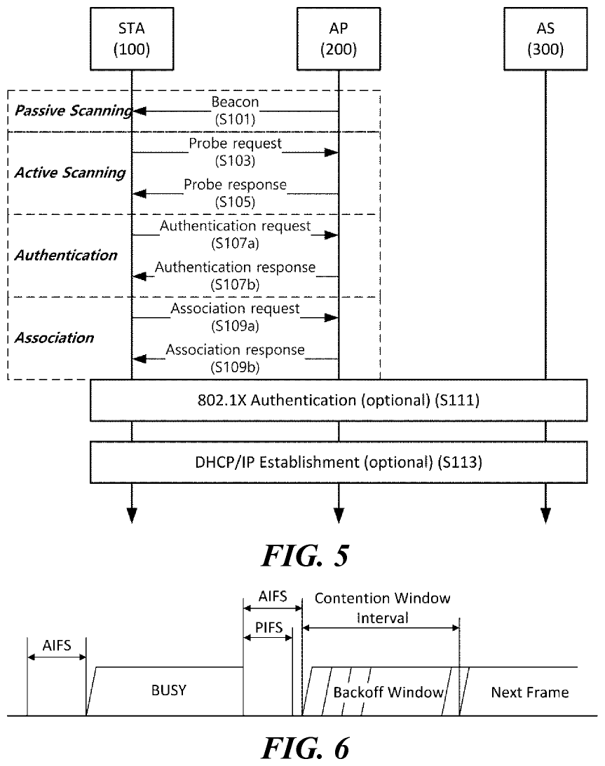

FIG. 5 is a diagram schematically illustrating a process in which a STA sets a link with an AP.

Referring to FIG. 5, the link between the STA 100 and the AP 200 is set through three steps of scanning, authentication, and association in a broad way. First, the scanning step is a step in which the STA 100 obtains access information of BSS operated by the AP 200. A method for performing the scanning includes a passive scanning method in which the AP 200 obtains information by using a beacon message (S101) which is periodically transmitted and an active scanning method in which the STA 100 transmits a probe request to the AP (S103) and obtains access information by receiving a probe response from the AP (S105).

The STA 100 that successfully receives wireless access information in the scanning step performs the authentication step by transmitting an authentication request (S107a) and receiving an authentication response from the AP 200 (S107b). After the authentication step is performed, the STA 100 performs the association step by transmitting an association request (S109a) and receiving an association response from the AP 200 (S109b). In this specification, an association basically means a wireless association, but the present invention is not limited thereto, and the association may include both the wireless association and a wired association in a broad sense.

Meanwhile, an 802.1X based authentication step (S111) and an IP address obtaining step (S113) through DHCP may be additionally performed. In FIG. 5, the authentication server 300 is a server that processes 802.1X based authentication with the STA 100 and may be present in physical association with the AP 200 or present as a separate server.

FIG. 6 is a diagram illustrating a carrier sense multiple access (CSMA)/collision avoidance (CA) method used in wireless LAN communication.

A terminal that performs a wireless LAN communication checks whether a channel is busy by performing carrier sensing before transmitting data. When a wireless signal having a predetermined strength or more is sensed, it is determined that the corresponding channel is busy and the terminal delays the access to the corresponding channel. Such a process is referred to as clear channel assessment (CCA) and a level to decide whether the corresponding signal is sensed is referred to as a CCA threshold. When a wireless signal having the CCA threshold or more, which is received by the terminal, indicates the corresponding terminal as a receiver, the terminal processes the received wireless signal. Meanwhile, when a wireless signal is not sensed in the corresponding channel or a wireless signal having a strength smaller than the CCA threshold is sensed, it is determined that the channel is idle.

When it is determined that the channel is idle, each terminal having data to be transmitted performs a backoff procedure after an inter frame space (IFS) time depending on a situation of each terminal, for instance, an arbitration IFS (AIFS), a PCF IFS (PIFS), or the like elapses. According to the embodiment, the AIFS may be used as a component which substitutes for the existing DCF IFS (DIFS). Each terminal stands by while decreasing slot time(s) as long as a random number determined by the corresponding terminal during an interval of an idle state of the channel and a terminal that completely exhausts the slot time(s) attempts to access the corresponding channel. As such, an interval in which each terminal performs the backoff procedure is referred to as a contention window interval. In this instance, a random number is referred to as a backoff counter. That is, the initial value of the backoff counter may be set by an integer number which is a random number that a UE obtains. In the case that the UE detects that a channel is idle during a slot time, the UE may decrease the backoff counter by 1. In addition, in the case that the backoff counter reaches 0, the UE may be allowed to perform channel access in a corresponding channel. Therefore, in the case that a channel is idle during an AIFS time and the slot time of the backoff counter, transmission by the UE may be allowed.

When a specific terminal successfully accesses the channel, the corresponding terminal may transmit data through the channel. However, when the terminal which attempts the access collides with another terminal, the terminals which collide with each other are assigned with new random numbers, respectively to perform the backoff procedure again. According to an embodiment, a random number newly assigned to each terminal may be decided within a range (2*CW) which is twice larger than a range (a contention window, CW) of a random number which the corresponding terminal is previously assigned. Meanwhile, each terminal attempts the access by performing the backoff procedure again in a next contention window interval and in this case, each terminal performs the backoff procedure from slot time(s) which remained in the previous contention window interval. By such a method, the respective terminals that perform the wireless LAN communication may avoid a mutual collision for a specific channel.

### <Examples of Various PPDU Formats>

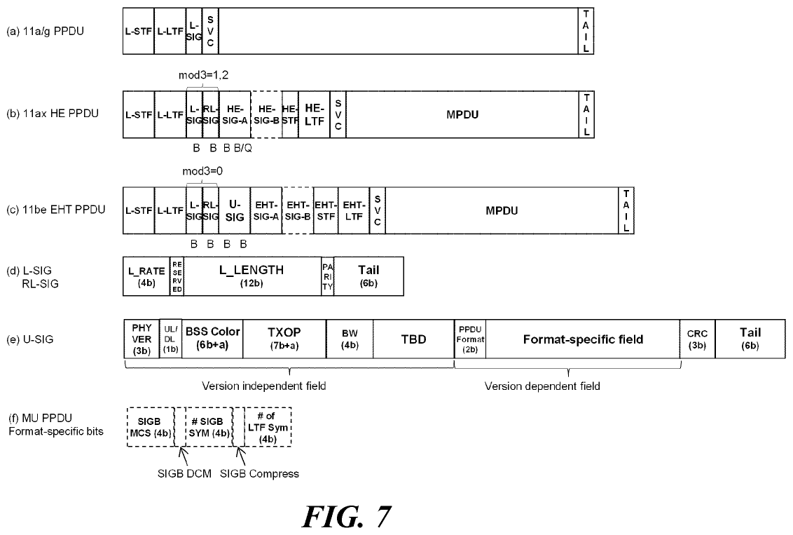

FIG. 7 illustrates an example of a format of a PLCP Protocol data unit (PPDU) for each of various standard generations. More specifically, (a) of FIG. 7 illustrates an embodiment of a legacy PPDU format based on 802.11a/g, (b) of FIG. 7 illustrates an embodiment of an HE PPDU format based on 802.11ax, and (c) of FIG. 7 illustrates an embodiment of a non-legacy PPDU (i.e., EHT PPDU) format based on 802.11be. (d) of FIG. 7 illustrates detailed field configurations of RL-SIG and L-SIG commonly used in the PPDU formats.

Referring to (a) of FIG. 7, a preamble of the legacy PPDU includes a legacy short training field (L-STF), a legacy long training field (L-LTF), and a legacy signal field (L-SIG). In an embodiment of the present invention, the L-STF, the L-LTF, and the L-SIG may be referred to as a legacy preamble.

Referring to (b) of FIG. 7, a preamble of the HE PPDU additionally includes, in the legacy preamble, a repeated legacy short training field (RL-SIG), a high efficiency signal A field (HE-SIG-A), a high efficiency signal B field (HE-SIG-B), a high efficiency short training field (HE-STF), and a high efficiency long training field (HE-LTF). In an embodiment of the present invention, the RL-SIG, HE-SIG-A, the HE-SIG-B, the HE-STF and the HE-LTF may be referred to as an HE preamble. A specific configuration of the HE preamble may be modified according to an HE PPDU format. For example, HE-SIG-B may be used only in an HE MU PPDU format.

Referring to (c) of FIG. 7, a preamble of the EHT PPDU additionally includes, in the legacy preamble, a repeated legacy short training field (RL-SIG), a universal signal field (U-SIG), and an extremely high throughput signal A field (EHT-SIG-A), an extremely high throughput signal B field (EHT-SIG-B), an extremely high throughput short training field (EHT-STF), and an extremely high throughput long training field (EHT-LTF). In an embodiment of the present invention, the RL-SIG, EHT-SIG-A, the EHT-SIG-B, the EHT-STF and the EHT-LTF may be referred to as an EHT preamble. A specific configuration of a non-legacy preamble may be modified according to an EHT PPDU format. For example, EHT-SIG-A and EHT-SIG-B may be used only in a part of the EHT PPDU format.

64-FFT OFDM is applied in an L-SIG field included in the preamble of the PPDU, and the L-SIG field includes a total of 64 subcarriers. Among 64 subcarriers, 48 subcarriers excluding a guard subcarrier, a DC subcarrier, and a pilot subcarrier are used for transmission of L-SIG data. BPSK and a modulation and coding scheme (MCS) of rate=1/2 are applied in L-SIG, and therefore the L-SIG may include a total of 24 bits of information. (d) of FIG. 7 illustrates a 24-bit information configuration of L-SIG.

Referring to (d) of FIG. 7, the L-SIG includes an L_RATE field and an L_LENGTH field. The L_RATE field includes 4 bits and indicates an MCS used for data transmission. Specifically, the L_RATE field indicates one value among transmission rates of 6/9/12/18/24/36/48/54 Mbps obtained by combining a modulation scheme of BPSK/QPSK/16-QAM/64-QAM, etc. and an inefficiency of 1/2, 2/3, 3/4, etc. A total length of a corresponding PPDU may be indicated by combining information of the L_RATE field and information of the L_LENGTH field. In a non-legacy PPDU format, the L_RATE field is configured to a minimum rate of 6 Mbps.

A unit of the L_LENGTH field is a byte and a total of 12 bits are allocated to signal up to 4095, and a length of the PPDU may be indicated in combination with the L_RATE field. A legacy terminal and a non-legacy terminal may interpret the L_LENGTH field in different ways.

First, a method of interpreting the length of a PPDU using a L_LENGTH field by a legacy terminal or a non-legacy terminal is as follows. When the L_RATE field is set to 6 Mbps, 3 bytes (i.e., 24 bits) can be transmitted for 4 us, which is one symbol duration of 64 FFT. Therefore, by adding 3 bytes corresponding to the SVC field and the Tail field to the value of the L_LENGTH field and dividing it by 3 bytes, which is the transmission amount of one symbol, the number of symbols after the L-SIG is obtained on the 64FFT basis. The length of the corresponding PPDU, that is, the reception time (i.e., RXTIME) is obtained by multiplying the obtained number of symbols by 4 us, which is one symbol duration, and then adding a 20 us which is for transmitting L-STF, L-LTF and L-SIG. This can be expressed by the following Equation 1.

$$RXTIME ( us ) ( ⌈ \frac{L\_LENGTH + 3}{3} ⌉ ) \times 4 + 20 \qquad [ Equation 1 ]$$

In this case, denotes the smallest natural number greater than or equal to x. Since the maximum value of the L_LENGTH field is 4095, the length of the PPDU can be set up to 5.464 ms. The non-legacy terminal transmitting the PPDU should set the L_LENGTH field as shown in Equation 2 below.

$$L\_LENGTH ( byte ) ( ⌈ \frac{TXTIME - 20}{4} ⌉ ) \times 3 - 3 \qquad [ Equation 2 ]$$

Herein, TXTIME is the total transmission time constituting the corresponding PPDU, and is expressed by Equation 3 below. In this case, TX represents the transmission time of X.

$$TXTIME ( us ) = ( {T}_{L - STF} + {T}_{L - LTF} + {T}_{L - SIG} + {T}_{RL - SIG} + {T}_{U - SIG} + ( {T}_{ENT - SIG - A} ) + ( {T}_{EHT - SIG - B} ) + {T}_{EHT - STF} + {N}_{EHT - LTF} \cdot {T}_{EHT - LTF} + {T}_{DATA} \qquad [ Equation 3 ]$$

Referring to the above equations, the length of the PPDU is calculated based on a rounded up value of L_LENGTH/3. Therefore, for a random value of k, three different values of L_LENGTH={3k+1, 3k+2, 3(k+1)} indicate the same PPDU length.

Referring to (e) of FIG. 7, a universal SIG (U-SIG) field continues to exist in an EHT PPDU and a WLAN PPDU of a subsequent generation, and serves to classify a generation of a PPDU, which includes 11be. U-SIG is a 64 FFT-based OFDM 2 symbol and may transfer a total of 52 bits of information. In 52 bits, 43 bits excluding 9 bits for CRC/Tail are largely divided into a version independent (VI) field and a version dependent (VD) field.

A VI bit enables a current bit configuration to be maintained even later on, so that even if a PPDU of a subsequent generation is defined, current 11be terminals may obtain information on the PPDU via the VI fields of the PPDU. To this end, the VI field includes PHY version, UL/DL, BSS color, TXOP, and reserved fields. The PHY version field is 3 bits, and serves to sequentially classify 11be and subsequent generation wireless LAN standards into versions. 11be has a value of 000b. The UL/DL field identifies whether the PPDU is an uplink/downlink PPDU. BSS color indicates an identifier for each BSS defined in 11ax, and has a value of 6 bits or more. TXOP indicates transmit opportunity duration transmitted in a MAC header, wherein, by adding the TXOP to a PHY header, the PPDU may infer a length of the TXOP included therein without having to decode an MPDU, and the TXOP has a value of 7 bits or more.

The VD field is signaling information useful only for an 11be version of the PPDU, and may include a field commonly used in any PPDU format, such as PPDU format and BW, and a field defined differently for each PPDU format. The PPDU format is a classifier that classifies EHT single user (SU), EHT multiple user (MU), EHT trigger-based (TB), EHT extended range (ER) PPDU, etc. The BW field signals five basic PPDU BW options (BW, which is expressible in the form of an exponential power of 20*2, may be referred to as basic BW) of 20, 40, 80, 160 (80+80), and 320 (160+160) MHz and various remaining PPDU BWs configured via preamble puncturing. After being signaled at 320 MHz, signaling may be performed in a form in which some 80 MHz is punctured. A punctured and modified channel type may be signaled directly in the BW field, or may be signaled using the BW field with a field (e.g., a field within the EHT-SIG field) appearing after the BW field. If the BW field is configured to 3 bits, a total of 8 BW signaling may be performed, and therefore only up to 3 signaling may be performed in a puncturing mode. If the BW field is configured to 4 bits, a total of 16 BW signaling may be performed, and therefore up to 11 signaling may be performed in the puncturing mode.

A field located after the BW field varies depending on the type and format of the PPDU, an MU PPDU and an SU PPDU may be signaled in the same PPDU format, a field for classification between the MU PPDU and the SU PPDU may be located before an EHT-SIG field, and additional signaling may be performed for the same. Both the SU PPDU and the MU PPDU include the EHT-SIG field, but some fields that are not required in the SU PPDU may be compressed. Information on the field to which the compression has been applied may be omitted or may have a size smaller than a size of an original field included in the MU PPDU. For example, in a case of the SU PPDU, a common field of the EHT-SIG may be omitted or replaced, or the SU PPDU may have a different configuration in which a user specific field is replaced, reduced to one, or the like.

Alternatively, the SU PPDU may further include a compression field indicating whether compression is performed, and a part of field (e.g., RA fields, etc.) may be omitted according to a value of the compressed field.

If a part of the EHT-SIG field of the SU PPDU is compressed, information to be included in the compressed field may be signaled also in an uncompressed field (e.g., the common field, etc.). The MU PPDU corresponds to a PPDU format for concurrent reception by multiple users, and therefore the EHT-SIG field is required to be transmitted subsequently to the U-SIG field, and the amount of signaled information may vary. That is, a plurality of MU PPDUs are transmitted to a plurality of STAs, so that the respective STAs should recognize locations of RUs, at which the MU PPDUs are transmitted, the STAs to which the RUs have been allocated respectively, and whether the transmitted MU PPDUs have been transmitted to the STAs themselves. Therefore, an AP should transmit information described above, by including the same in the EHT-SIG field. To this end, information for efficient transmission of the EHT-SIG field is signaled in the U-SIG field, and this may correspond to an MCS that is a modulation method and/or the number of symbols in the EHT-SIG field. The EHT-SIG field may include information on a size and location of an RU allocated to each user.

In the case of the SU PPDU, a plurality of RUs may be allocated to an STA, and the plurality of RUs may be continuous or discontinuous. If the RUs allocated to the STA are discontinuous, the STA should recognize a punctured RU in the middle in order to efficiently receive the SU PPDU. Accordingly, the AP may transmit the SU PPDU including information (e.g., a puncturing pattern of the RUs, etc.) of punctured RUs among the RUs allocated to the STA. That is, in the case of the SU PPDU, a puncturing mode field, which includes information indicating, in a bitmap format, etc., a puncturing pattern and whether the puncturing mode is applied, may be included in the EHT-SIG field, and the puncturing mode field may signal a discontinuous channel type appearing within a bandwidth.

The signaled discontinuous channel type is limited, and indicates discontinuous channel information and BW of the SU PPDU in combination with a value of the BW field. For example, the SU PPDU is a PPDU transmitted only to a single terminal, so that the STA may recognize a bandwidth allocated to itself via the BW field included in the PPDU, and the SU PPDU may recognize a punctured resource in the allocated bandwidth via the puncturing mode field of the EHT-SIG field or the U-SIG field included in the PPDU. In this case, the terminal may receive the PPDU in resource units remaining after excluding a specific channel of the punctured resource unit. The plurality of RUs allocated to the STA may be configured by different frequency bands or tones.

Only a limited discontinuous channel type is signaled in order to reduce signaling overhead of the SU PPDU. Puncturing may be performed for each 20 MHz sub-channel, so that if puncturing is performed for BW having a large number of 20 MHz sub-channels, such as 80, 160, and 320 MHz, a discontinuous channel (if puncturing of only edge 20 MHz is considered to be discontinuous) type should be signaled in the case of 320 MHz by expressing whether each of 15 20 MHz sub-channels remaining after excluding a primary channel is used. As such, allocating 15 bits to signal a discontinuous channel type of single user transmission may act as excessively large signaling overhead in consideration of a low transmission rate of a signaling part.

The present invention proposes a technique for signaling a discontinuous channel type of an SU PPDU, and illustrates a discontinuous channel type determined according to the proposed technique. The present invention also proposes a technique for signaling each of puncturing types of primary 160 MHz and secondary 160 MHz in a 320 MHz BW configuration of an SU PPDU.

An embodiment of the present invention proposes a technique for differently configuring a PPDU indicated by preamble puncturing BW values according to a PPDU format signaled in a PPDU format field. It is assumed that a BW field is 4 bits, and in a case of an EHT SU PPDU or a TB PPDU, EHT-SIG-A of 1 symbol may be additionally signaled after U-SIG, or EHT-SIG-A may not be signaled at all, so that, in consideration of this, it is necessary to completely signal up to 11 puncturing modes via only the BW field of U-SIG. However, in a case of an EHT MU PPDU, EHT-SIG-B is additionally signaled after U-SIG, so that up to 11 puncturing modes may be signaled in a method different from that of the SU PPDU. In a case of an EHT ER PPDU, a BW field may be configured to 1 bit to signal whether the EHT ER PPDU is a PPDU using a 20 MHz or 10 MHz band.

(f) of FIG. 7 illustrates a configuration of a format-specific field of a VD field when the EHT MU PPDU is indicated in the PPDU format field of U-SIG. In the case of the MU PPDU, SIG-B, which is a signaling field for concurrent reception by multiple users, is essentially required, and SIG-B may be transmitted without separate SIG-A after U-SIG. To this end, information for decoding of SIG-B should be signaled in U-SIG. These fields include SIG-B MCS, SIG-B DCM, Number of SIG-B Symbols, SIG-B Compression, and Number of EHT-LTF Symbols.

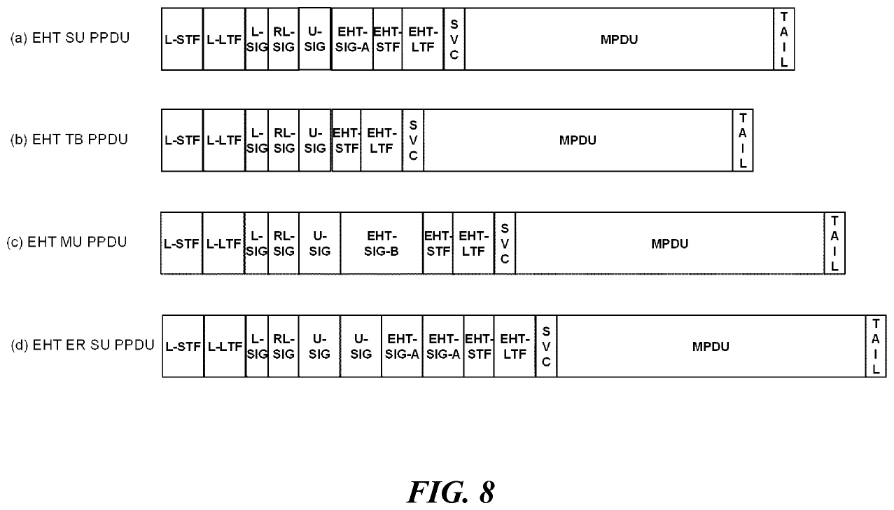

FIG. 8 illustrates an example of various extremely high throughput (EHT) physical protocol data unit (PPDU) formats and a method for indicating the same according to an embodiment of the present invention.

Referring to FIG. 8, a PPDU may include a preamble and a data part, and an EHT PPDU format, that is a PPDU type, may be classified according to a U-SIG field included in the preamble. Specifically, based on a PPDU format field included in the U-SIG field, whether the format of the PPDU is an EHT PPDU may be indicated.

(a) of FIG. 8 shows an example of an EHT SU PPDU format for a single STA. An EHT SU PPDU is a PPDU used for single user (SU) transmission between an AP and a single STA, and an EHT-SIG-A field for additional signaling may be located after the U-SIG field.

(b) of FIG. 8 shows an example of an EHT trigger-based PPDU format which corresponds to an EHT PPDU transmitted based on a trigger frame. An EHT Trigger-based PPDU is an EHT PPDU transmitted based on a trigger frame and is an uplink PPDU used for a response to the trigger frame. Unlike in the EHT SU PPDU, an EHT-SIG-A field is not located after a U-SIG field in the EHT PPDU.

(c) of FIG. 8 shows an example of an EHT MU PPDU format which corresponds to an EHT PPDU for multiple users. An EHT MU PPDU is a PPDU used to transmit the PPDU to one or more STAs. In the EHT MU PPDU format, an HE-SIG-B field may be located after a U-SIG field.

(d) of FIG. 8 shows an example of an EHT ER SU PPDU format used for single user transmission with an STA in an extended range. An EHT ER SU PPDU may be used for single user transmission with an STA of a wider range compared to the EHT SU PPDU described in (a) of FIG. 8, and a U-SIG field may be repeatedly located on a time axis.

The EHT MU PPDU described in (c) of FIG. 8 may be used by an AP to perform downlink transmission to a plurality of STAs. Here, the EHT MU PPDU may include scheduling information so that the plurality of STAs may concurrently receive the PPDU transmitted from the AP. The EHT MU PPDU may transfer, to the STAs, AID information of a transmitter and/or a receiver of the PPDU transmitted via a user specific field of EHT-SIG-B. Accordingly, the plurality of terminals having received the EHT MU PPDU may perform a spatial reuse operation based on the AID information of the user specific field included in a preamble of the received PPDU.

Specifically, a resource unit allocation (RA) field of the HE-SIG-B field included in the HE MU PPDU may include information on a configuration of a resource unit (e.g., a division form of the resource unit) in a specific bandwidth (e.g., 20 MHz, etc.) of a frequency axis. That is, the RA field may indicate configurations of resource units segmented in a bandwidth for transmission of the HE MU PPDU, in order for the STA to receive the PPDU. Information on the STA allocated (or designated) to each segmented resource unit may be included in the user specific field of EHT-SIG-B so as to be transmitted to the STA. That is, the user specific field may include one or more user fields corresponding to the respective segmented resource units.

For example, a user field corresponding to at least one resource unit used for data transmission among the plurality of segmented resource units may include an AID of a receiver or a transmitter, and a user field corresponding to the remaining resource unit(s) which is not used for data transmission may include a preconfigured null STA ID.

For convenience of description, in this specification, a frame or a MAC frame may be used interchangeably with an MPDU.

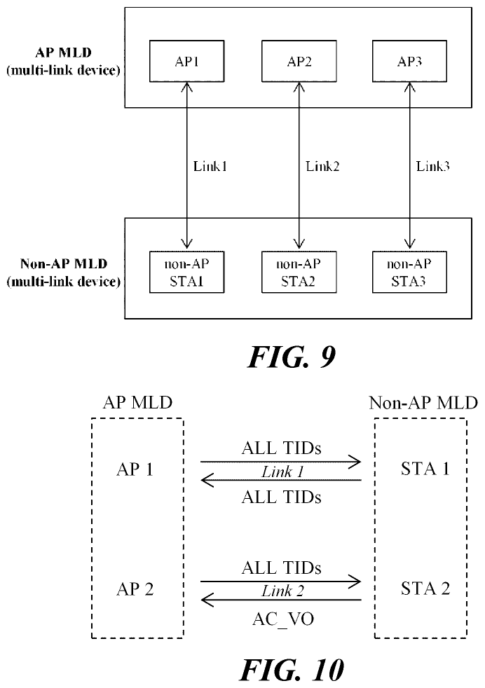

When a wireless communication device communicates using multiple links, the communication efficiency of the wireless communication device may be increased. Each of the links is a physical path which may be configured as a single wireless medium that can be used to carry MAC service data units (MSDUs). For example, when the frequency band of one link is occupied by another wireless communication device, the wireless communication device may continue to communicate through a different link. In this way, a wireless communication device may usefully use multiple channels. In addition, when wireless communication devices use multiple links to communicate simultaneously, the overall throughput may be increased. However, conventional wireless LANs are based on the assumption that a single wireless communication device uses a single link. Therefore, a wireless LAN operation method for using multiple links is needed. With reference to FIGS. 9 to 26, a wireless communication method of a wireless communication device using multiple links will be described. First, a specific form of a wireless communication device using multiple links will be described with reference to FIG. 9.

FIG. 9 illustrates a multi-link device according to an embodiment of the present disclosure.

A multi-link device (MLD) may be defined for the above-described wireless communication method using multiple links. The multi-link device may represent a device having one or more affiliated stations. According to specific embodiments, a multi-link device may represent a device having two or more affiliated stations. In addition, multi-link devices may exchange multi-link elements. A multi-link element includes information about one or more stations or one or more links. The multi-link element may include a multi-link setup element which will be described later. The multi-link device may be a logical entity. Specifically, a multi-link device may have multiple affiliated stations. The multi-link device may be referred to as a multi-link logical entity (MLLE) or a multi-link entity (MLE). The multi-link device may have one medium access control service access point (MAC service access point (SAP)) up to the logical link control (LLC). In addition, the MLD may have one MAC data service.

Multiple stations in a multi-link device may operate in multiple links. Further, the multiple stations included in the multi-link device may operate on multiple channels. Specifically, the multiple stations included in the multi-link device may operate on multiple different links and/or multiple different channels. For example, the multiple stations included in the multi-link device may operate on multiple different channels of 2.4 GHz, 5 GHz, and 6 GHz.

The operation of the multi-link device may be referred to as a multi-link operation, an MLD operation, or a multi-band operation. In addition, when a station affiliated with a multi-link device is an AP, the multi-link device may be referred to as an AP MLD. Also, when a station affiliated with a multi-link device is a non-AP station, the multi-link device may be referred to as a non-AP MLD.

FIG. 9 illustrates an operation in which a non-AP MLD and an AP MLD communicate with each other. Specifically, the non-AP MLD and AP MLD communicate with each other by using three links each. The AP MLD includes a first AP (AP1), a second AP (AP2), and a third AP (AP3). The non-AP MLD includes a first non-AP STA (non-AP STAT), a second non-AP STA (non-AP STA2), and a third non-AP STA (non-AP STA3). The first AP (AP1) and the first non-AP STA (non-AP STAT) communicate with each other via a first link (Link1). In addition, the second AP (AP2) and the second non-AP STA (non-AP STA2) communicate with each other via a second link (Link2). Furthermore, the third AP (AP3) and the third non-AP STA (non-AP STA3) communicate with each other via a third link (Link3).

The multi-link operation may include a multi-link setup operation. The multi-link setup corresponds to the association operation of the single-link operation described above, and may need to be performed first for frame exchange on a multi-link. The multi-link device may obtain information required for multi-link setup from a multi-link setup element. Specifically, the multi-link setup element may include capability information related to the multi-link. The capability information may include information indicating whether one of multiple devices included in the multi-link device can perform transmission and simultaneously another device can perform reception. In addition, the capability information may include information about a link that are available to each station included in the MLD. Furthermore, the capability information may include information about a channel that is available to each station included in the MLD.

The multi-link setup may be performed through negotiation between peer stations. Specifically, multi-link setup may be performed through communication between stations without communication with an AP. Furthermore, the multi-link setup may be performed through any one link. For example, even when a first link to a third link are set up through multiple links, a multi-link setup may be performed through the first link.

Additionally, mapping between a traffic identifier (TID) and a link may be configured. Specifically, frames corresponding to a TID of a specific value may only be exchanged through a predesignated link. The mapping between a TID and a link may be configured in a directional-based manner. For example, when multiple links are set up between a first multi-link device and a second multi-link device, the first multi-link device may be configured to transmit a frame of a first TID to a first link among the multiple links, and the second multi-link device may be configured to transmit a frame of a second TID to the first link. In addition, there may be a default configuration for the mapping between a TID and a link. Specifically, when there is no additional setup in the multi-link setup, a multi-link device may exchange, based on the default configuration, a frame corresponding to a TID on each link. The default configuration may be that all TIDs are exchanged on any one link.

The TID will be described in detail. A TID is an ID for classifying traffic and data to support quality of service (QoS). Additionally, TID may be used or assigned at a layer higher than an MAC layer. A TID may also represent a traffic category (TC) or a traffic stream (TS). Furthermore, a TID may be distinguished into 16 values. For example, a TID may be assigned any one among 0 to 15. Depending on an access policy, a channel access, or a medium access method, the TID value used may be designated differently. For example, when enhanced distributed channel access (EDCA) or hybrid coordination function contention-based channel access (HCAF) is used, TID values may be assigned from 0 to 7. When EDCA is used, the TID may indicate a user priority (UP). The UP may be designated based on TC or TS. UP may be assigned at a higher layer than the MAC. In addition, when HCF controlled channel access (HCCA) or SPCA is used, TID values may be assigned from 8 to 15. When HCCA or SPCA is used, a TID may represent a TSID. Also, when HEMM or SEMM is used, TID values may be assigned from 8 to 15. When HEMM or SEMM is used, a TID may represent the TSID.

A UP and an AC may be mapped. The AC may be a label for providing QoS in EDCA. The AC may be a label for indicating an EDCA parameter set. An EDCA parameter or the EDCA parameter set is a parameter that is used in channel contention in EDCA. A QoS station may use the AC to guarantee QoS. Furthermore, the AC may include AC_BK, AC_BE, AC_VI, and AC_VO. AC_BK, AC_BE, AC_VI, and AC_VO may represent background, best effort, video, and voice, respectively. In addition, AC_BK, AC_BE, AC_VI, and AC_VO may be classified as sub-ACs. For example, AC_VI may be subdivided into AC_VI primary and AC_VI alternate. Also, AC_VO may be subdivided into AC_VO primary and AC_VO alternate. Furthermore, a UP or a TID may be mapped to an AC. For example, UP or TID values 1, 2, 0, 3, 4, 5, 6, and 7 may be mapped to AC_BK, AC_BK, AC_BE, AC_BE, AC_VI, AC_VI, AC_VO, and AC_VO, respectively. In addition, UP or TID values 1, 2, 0, 3, 4, 5, 6, and 7 may be mapped to AC_BK, AC_BK, AC_BE, AC_BE, AC_VI alternate, AC_VI primary, AC_VO primary, and AC_VO alternate, respectively. Also, UP or TID values 1, 2, 0, 3, 4, 5, 6, and 7 may be in ascending order of priority. That is, 1 may be a low priority and 7 may be a high priority. Therefore, the priority may increase in the order of AC_BK, AC_BE, AC_VI, and AC_VO. Also, AC_BK, AC_BE, AC_VI, and AC_VO may correspond to AC index (ACI) 0, 1, 2, and 3. Because of these characteristics of TID, mapping between a TID and a link may represent mapping between an AC and a link. In addition, mapping between a link and an AC may represent mapping between a TID and a link.

As described above, a TID may be mapped to each of multiple links. The mapping may be to designate a link in which traffic corresponding to a specific TID or AC can be exchanged. Additionally, within a link, a TID or an AC that can be transmitted in each transmission direction may be designated. As described above, there may be a default configuration in the mapping between a TID and a link. Specifically, when there is no additional setup in a multi-link setup, the multi-link device may exchange, based on the default configuration, a frame corresponding to a TID on each link. The default configuration may be that all TIDs are exchanged in any one link. At any given time, any TID or AC may be mapped to at least one link. A management frame and a control frame may be transmitted in all links.

When a link is mapped to a TID or an AC, only a data frame corresponding to the TID or the AC mapped to the link may be transmitted in the link. Therefore, when a link is mapped to a TID or AC, a frame that do not correspond to the TID or AC mapped to the link may not be transmitted in the link. When a link is mapped to a TID or AC, ACK may also be transmitted based on the link mapped to the TID or AC. For example, a block ACK agreement may be determined based on the mapping between the TID and the link. In another specific embodiment, mapping between a TID and a link may be determined based on a block ACK agreement. Specifically, a block ACK agreement may be established for a TID mapped to a specific link.

Through the above-described mapping between a TID and a link, QoS may be ensured. Specifically, a higher priority AC or TID may be mapped to a link in which relatively few stations operate or channel conditions are good. In addition, the above-described mapping between a TID and a link enables stations to remain in a power-saving state for a longer time.

FIG. 10 illustrates multiple links mapped based on a multi-link mapping method according to an embodiment of the present disclosure.

Referring to FIG. 10, as described in FIG. 9, there may be a mapping relationship between a TID and a link. In the present disclosure, the mapping relationship between a TID and a link may be referred to as TID-to-link mapping, TID to link mapping, TID mapping, link mapping, and the like. The TID may be a traffic identifier. In addition, the TID may be an identifier for classifying traffic, data, etc. to support quality of service (QoS).

In addition, the TID may be an ID used or assigned at a layer higher than the MAC layer. The TID may represent traffic categories (TC), traffic streams (TS), etc. Further, the TID may have 16 values, for example, represented by values of 0 to 15. In addition, depending on an access policy, channel access, or a medium access method, the TID value used may be different. For example, when enhanced distributed channel access (EDCA) (hybrid coordination function (HCF) contention-based channel access) is used, possible TID values may be 0 to 7. In addition, when EDCA is used, the TID value may represent a user priority (UP), and the UP may relate to TC or TS. The UP may also be a value assigned at a higher layer than the MAC. Also, when HCF controlled channel access (HCCA) or SPCA is used, possible TID values may be 8 to 15. In addition, when HCCA or SPCA is used, the TID may represent TSID. Also, when HEMM or SEMM is used, possible TID values may be 8 to 15. Also, when using HEMM or SEMM, the TID may represent TSID.

In addition, there may be a mapping relationship between a UP and an access category (AC). The AC may be a label for providing QoS in EDCA, or a label that indicates an EDCA parameter or a set of EDCA parameters. The EDCA parameter or the set of EDCA parameters may be used for channel connection. The AC may be used by a QoS STA.

The value of an AC may be configured as one of AC_BK, AC_BE, AC_VI, and AC_VO. AC_BK, AC_BE, AC_VI, and AC_VO may represent background, best effort, video, and voice, respectively. In addition, it is possible to subdivide AC_BK, AC_BE, AC_VI, and AC_VO. For example, AC_VI may be subdivided into AC_VI primary and AC_VI alternate. In addition, AC_VO may be subdivided into AC_VO primary and AC_VO alternate. Furthermore, a UP value or a TID value is mapped to an AC value. For example, UP values or TID values 1, 2, 0, 3, 4, 5, 6, and 7 may be mapped to AC_BK, AC_BK, AC_BE, AC_BE, AC_VI, AC_VI, AC_VO, and AC_VO, respectively. Alternatively, UP values or TID values 1, 2, 0, 3, 4, 5, 6, and 7 may be mapped to AC_BK, AC_BK, AC_BE, AC_BE, AC_VI alternate, AC_VI primary, AC_VO primary, and AC_VO alternate, respectively. In addition, UP values or TID values 1, 2, 0, 3, 4, 5, 6, and 7 may be in ascending order of priority. That is, 1 may be the lowest priority, and 7 may be the highest priority. Therefore, the priority may increase in order of AC_BK, AC_BE, AC_VI, and AC_VO. In addition, AC_BK, AC_BE, AC_VI, and AC_VO may correspond to AC index (ACI) 0, 1, 2, and 3.

Thus, it is possible for a relationship to exist between a TID and an AC. Therefore, it is also possible that the TID-to-link mapping of the present disclosure is a mapping relationship between an AC and a link. Also, in the present disclosure, describing that a TID has been mapped may imply that an AC has been mapped, and vice versa.

According to an embodiment of the present disclosure, there may be a TID mapped to each link of the multi-link. For example, there may be mapping regarding a link, among the multiple links, in which a specific TID or a specific AC is allowed to be transmitted or received. In addition, the mapping may be defined separately for each of two directions of a link. In addition, as described above, there may be a default configuration in the mapping between a TID and a link. For example, the mapping between a TID and a link may be that all TIDs are mapped to a link. In addition, according to an embodiment, at a specific time point, a TID or an AC may be mapped to at least one link. In addition, it may be possible for a management frame or a control frame to be transmitted in all links.

In the present disclosure, a data frame corresponding to a TID or an AC mapped to any direction of a link may be transmitted. Also, a data frame corresponding to a TID or an AC that is not mapped to any direction of the link may not be transmitted.

According to an embodiment, TID-to-link mapping may also be applied to an acknowledgment. For example, a block ack agreement may be based on TID-to-link mapping. Alternatively, the TID-to-link mapping may be based on a block ack agreement. For example, there may be a block ack agreement for a TID that has undergone TID-to-link mapping.

It is possible to provide QoS service by performing TID-to-link mapping. For example, by mapping a high-priority AC or TID to a link with good channel conditions or fewer STAs, it may be possible to quickly transmit data of the AC or the TID. Alternatively, TID-to-link mapping may help an STA on a specific link save power (or enter a doze state).

Referring to FIG. 10, there may be an AP MLD that includes AP 1 and AP 2. In addition, there may be a non-AP MLD that includes STA 1 and STA 2. In addition, there may be multiple links, Link 1 and Link 2, in the AP MLD. AP 1 and STA 1 may have been associated with each other on Link 1, and AP 2 and STA 2 may have been associated with each other on Link 2.

Therefore, Link 1 may include a link in which transmission is performed from AP 1 to STA 1 and/or a link in which transmission is performed from STA 1 to AP 1, and Link 2 may include a link in which transmission is performed from AP 2 to STA 2 and/or a link in which transmission is performed from STA 2 to AP 2. Each link may have a TID and/or AC mapped thereto.

For example, all TDIs or all Acs may be mapped to the link of Link 1, in which transmission is performed from AP 1 to STA 1, and the link of Link 1, in which transmission is performed from STA 1 to AP 1. In addition, only AC_VO or a TID corresponding to AC_VO may be mapped to the link of Link 2, in which transmission is performed from STA 2 to AP 2. In addition, it is possible that only data regarding the mapped TID and/or AC is transmitted in the link. In addition, data on a TID or an AC that is not mapped to a link may not be transmitted in the link.

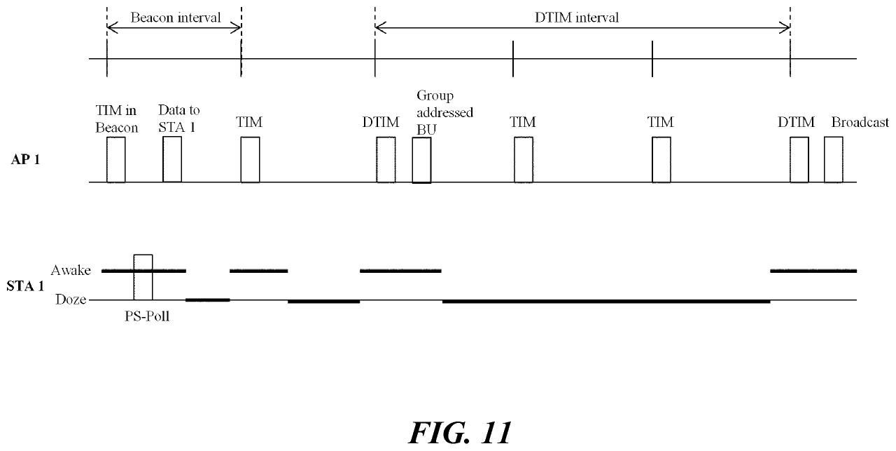

FIG. 11 illustrates a power management operation performed by a station according to an embodiment of the present disclosure.

In accordance with an embodiment of the present disclosure, a station may operate in a power save (PS) mode. The station operating in the power save mode may switch between an awake state and a doze state. In the awake state, the station operates at full power. Furthermore, in the awake state, the station may perform transmission and reception. In the doze state, transmission and reception by the station may be restricted. When a frame to be transmitted is buffered to the station in the doze mode, the station may switch to the awake state, and otherwise, may operate in the doze state. In doze mode, the station may frequently switch between the awake sate and the doze state. In an active mode, the station always remains in a state in which the station can perform transmission and reception. That is, in the active mode, the station may always operate in the awake state.

As such, when the station operates in the power save mode, the station in the doze state may not perform reception. Therefore, an AP may signal to the station that traffic to be transmitted is buffered, may receive a response to the signaling from the station, and may then perform the transmission. For ease of description, signaling by the AP to the station that the traffic to be transmitted is buffered is referred to as traffic indication. Also, signaling for traffic indication is referred to as traffic indication signaling. Traffic indication between the AP and the station may be performed as follows. In the present specification, traffic may include one among a frame, a BU, an MSDU, and an MPDU.

When traffic to be transmitted to the station has been buffered to the AP, the AP may transmit traffic indication signaling indicating that the traffic to be transmitted to the station has been buffered. In the present specification, the traffic indication signaling may be an indication that traffic has been buffered without being limited to traffic for a specific station, depending on the context. The traffic indication signaling may include at least one of a traffic indication map (TIM) element and a multi-link traffic element. The traffic indication signaling may be in a bitmap format. Specifically, the traffic indication signaling may indicate whether traffic corresponding to each bit of a bitmap has been buffered to the AP transmitting the bitmap. Furthermore, the traffic indication signaling may indicate a recipient of the buffered traffic. For example, the traffic indication signaling may indicate that the buffered traffic corresponds to at least one of group addressed traffic, group cast traffic, broadcast traffic, and individually addressed traffic. The bitmap may be used to signal a group to which traffic corresponds and a station to which traffic corresponds, based on the position of bits in the bitmap. The station may determine, based on the position of the bits in the bitmap, whether traffic corresponding to a group including the station is buffered to the AP or whether traffic for the station is buffered to the AP.

The traffic indication signaling may be transmitted based on a predesignated time point. Accordingly, the station in the doze state may switch from the doze state to the awake state, based on at the time point when the traffic indication signaling is transmitted. The traffic indication signaling may be included in a beacon frame. In addition, the traffic indication signaling may be included in a TIM frame. Furthermore, the AP may periodically transmit the traffic indication signaling. Specifically, the AP may transmit the traffic indication signaling, based on a target beacon transmission time (TBTT). However, when a channel is busy at the TBTT, the AP may transmit the traffic indication signaling at a time later than the TBTT. The station may maintain the awake state at the TBTT to receive the traffic indication signaling. The beacon frame including the traffic indication signaling may not be transmitted exactly at the TBTT. Therefore, the station may maintain the awake state for a predetermined time that includes the TBTT.

In the above-described embodiments, traffic indication signaling has been described as being transmitted by the AP and received by the station. The station may be a non-AP station. Furthermore, the AP may be included in an AP multi-link device and the non-AP station may be included in a non-AP multi-link device. Furthermore, the above-described traffic may refer to a bufferable unit (BU) or a buffered BU.

The AP may transmit a delivery TIM (DTIM) before transmitting group addressed traffic or broadcast traffic. The DTIM is a type of TIM, and indicates that the group addressed traffic and the broadcast traffic have been buffered to the AP. A beacon frame including the DTIM may be referred to as a DTIM beacon frame. When a DTIM received by the station indicates that group traffic for a group including the station will be transmitted, the station may transmit, to the AP, signaling which indicates that the station will receive the group traffic.

The station having received the traffic indication signaling may transmit signaling that retrieves transmission to the station. The signaling that retrieves the transmission to the station may be at least one of a PS-Poll frame or a U-APSD trigger frame. The AP, having received the signaling that retrieves the transmission to the station AP, transmits the buffered traffic to the station.

In FIG. 11, a first AP (AP1) includes a TIM in a beacon frame and transmits the beacon frame every TBTT. The TIM transmitted by the first AP (AP1) indicates that traffic for a first station (STA1) is buffered. The first station (STA1) maintains an awake state so as to transmit a PS-Poll frame and receive traffic. The first AP (AP1) transmits buffered traffic (Data to STA1) to the first station (STA1). The first station STA1 may receive the buffered traffic and may enter a doze state. In addition, the first station (STA1) may maintain the awake state during the next TIM transmission.

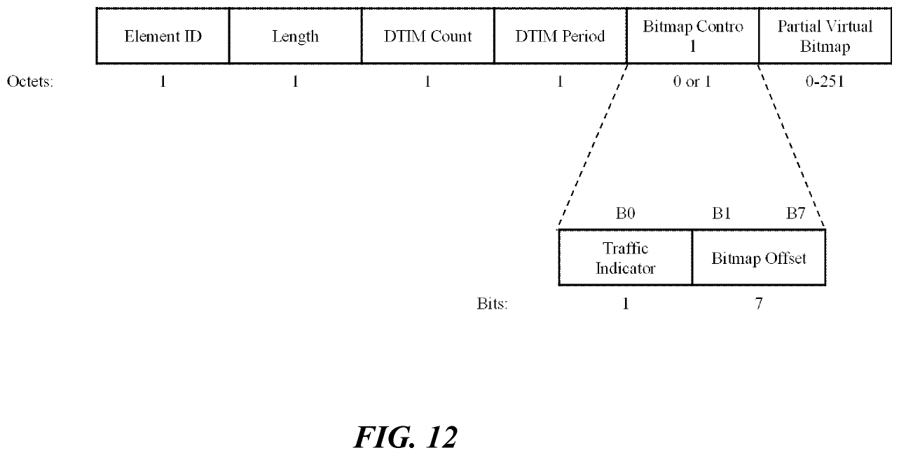

Furthermore, in FIG. 11, the first AP (AP1) transmits a DTIM every three beacon frames. Therefore, the DTIM interval is three beacon frames. The first station (STA1) operating in a power save mode maintains the awake state whenever a TIM is transmitted. The first AP (AP1) transmits broadcast traffic or group addressed traffic after transmitting the DTIM beacon. When the DTIM indicates that the broadcast traffic or the group addressed traffic to be received by the first station (STA1) is buffered, the first station (STA1) maintains the awake state so as to receive the broadcast traffic or the group addressed traffic. Thus, the first station STA1 may reliably receive the broadcast traffic or the group addressed traffic even in the power save mode. The format of a TIM element that may be included in the traffic indication signaling will be described with reference to FIG. 12.

FIG. 12 illustrates the format of a TIM element according to an embodiment of the present disclosure.

The TIM element includes the above-described TIM. The TIM element may include at least one among an Element ID subfield, a Length subfield, a DTIM Count subfield, a DTIM Period subfield, a Bitmap Control subfield, and a Partial Virtual Bitmap subfield. The Element ID subfield, the Length subfield, the DTIM Count subfield, the DTIM Period subfield, and the Bitmap Control subfield each have a length of one octet, i.e., 8 bits. The Partial Virtual Bitmap subfield may have a variable length within a maximum of 251 octets. The length of the Partial Virtual Bitmap subfield may be determined based on a Bitmap Control field or a Bitmap Offset subfield of the Bitmap Control field.

The Element ID subfield indicates the ID of an element including the Element ID subfield.

The Length subfield indicates the length of an element including the Length subfield. Specifically, the Length subfield may indicate the length of an element from which the Element ID subfield and the Length subfield is excluded.

The DTIM Count subfield indicates how many beacon frames will be transmitted until the next DTIM. Specifically, the value of the DTIM Count subfield may indicate how many beacon frames are transmitted until the next DTIM, including a beacon frame including the DTIM Count subfield. For example, when the value of the DTIM Count subfield is 0, the value may indicate that the DTIM Count subfield is included in a DTIM beacon.

The DTIM Period subfield indicates the number of beacon frames transmitted between DTIMs. When all TIMs are DTIMs, the value of the DTIM Period subfield is set to 1.

The Bitmap Control subfield may include a Traffic Indicator subfield and a Bitmap Offset subfield. The Traffic Indicator subfield may be a 1-bit field and the Bitmap Offset subfield may be a 7-bit field. The Traffic Indicator subfield may indicate whether group addressed traffic is buffered. Specifically, when the group addressed traffic has been buffered, an AP may set the value of the Traffic Indicator subfield to 1. The group addressed traffic may be traffic having a recipient's AID of 0. The Bitmap Offset subfield indicates the starting point of a bit corresponding to a Partial Virtual Bitmap in a traffic indication virtual bitmap. An association ID (AID) corresponding to the Partial Virtual Bitmap is determined based on the Bitmap Offset subfield.

Each bit in the Partial Virtual Bitmap field indicates whether traffic to be transmitted to a station having an AID corresponding to each bit is buffered to an AP transmitting a TIM. When a bit in the Partial Virtual Bitmap field has a value of 1, the value may indicate that traffic to be transmitted to a station having an AID corresponding to the bit in the Partial Virtual Bitmap field is buffered to an AP transmitting a TIM. When a bit in the Partial Virtual Bitmap field has a value of 0, the value indicates that traffic to be transmitted to a station having an AID corresponding to the bit in the Partial Virtual Bitmap field is not buffered to the AP transmitting a TIM. Therefore, when a bit in the Partial Virtual Bitmap field has a value of 1, a station having received a TIM may determine that the traffic to be transmitted to the station having an AID corresponding to the bit in the Partial Virtual Bitmap field is buffered to an AP transmitting the TIM. When a bit in the Partial Virtual Bitmap field has a value of 0, a station having received a TIM may determine that traffic to be transmitted to a station having an AID corresponding to the bit in the Partial Virtual Bitmap field is not buffered to an AP transmitting the TIM. In addition, the station having received a TIM may determine that traffic to be transmitted to a station having an AIDs that is not indicated by the Partial Virtual Bitmap is not buffered to an AP transmitting the TIM.

The TIM element may include a traffic indication virtual bitmap subfield. The number of a bit in the traffic indication virtual bitmap subfield may indicate the AID of a station corresponding to the bit. Specifically, a bit with bit number n in the traffic indication virtual bitmap subfield indicates that a frame to be transmitted to a station having an AID of n is buffered to an AP transmitting a TIM element. Specifically, when a bit in the traffic indication virtual bitmap subfield has a number N, the bit may indicate that traffic to be transmitted to a station with an AID of N or a group with a Group ID of N is buffered to an AP that has transmitted a TIM. The TIM may include the Partial Virtual Bitmap subfield instead of the traffic indication virtual bitmap subfield. The Partial Virtual Bitmap subfield may be obtained by omitting consecutive bits with a value of 0 from the traffic indication virtual bitmap subfield. The Partial Virtual Bitmap subfield may be obtained by omitting the first consecutive bit or the last consecutive bit among a set of bits having a value of 0 from the traffic indication virtual bitmap subfield. Specifically, the Partial Virtual Bitmap subfield may have bits of octet numbers N1 to N2 in the traffic indication virtual bitmap subfield. N1 may be the largest even number wherein all of bits corresponding to bit numbers 1 to (N1*8-1) in the traffic indication virtual bitmap subfield have a value of 0. N2 may be the smallest number wherein all of bits corresponding to bit numbers (N2+1)*8 to 2007 in the traffic indication virtual bitmap subfield have a value of 0. This may be a method for configuring the Partial Virtual Bitmap subfield when a multiple BSSID set is not supported, that is, when dot11MultiBSSIDImplemented is false. In the present specification, a bit number n in a bitmap or a subfield indicates an (n+1)th bit among bits in the bitmap or the subfield.

When all bits in the traffic indication virtual bitmap subfield have a value of 0 except for a bit with a bit number of 0, the Partial Virtual Bitmap subfield has a 1-octet length, and the value of all bits in the Partial Virtual Bitmap subfield may be set to 0. In this case, the value of the Bitmap Offset field is 0 and the value of the Length field may be set to 4.

In addition, when all bits in the traffic indication virtual bitmap subfield have a value of 0 and when all bits in the Bitmap Control subfield have a value of 0, the TIM element may not include the Partial Virtual Bitmap field and the Bitmap Control field. In this case, the value of the Length field may be set to 2. Thus, in the TIM, the Bitmap Control field may be present when the Partial Virtual Bitmap field is present.

When the multiple BSSID set is supported, i.e., when dot11MultiBSSIDImplemented is True, the method for configuring the Partial Virtual Bitmap subfield may be performed according to the following embodiments. When the multiple BSSID set is used, a management frame transmitted from an AP corresponding to a transmitted BSSID may include information for a BSS corresponding to a nontransmitted BSSID. The management frame may include at least one of a beacon frame and a probe response frame. A TIM element of the beacon frame transmitted from the transmitted BSSID may indicate whether an AP corresponding to the nontransmitted BSSID included in the multiple BSSID set including the transmitted BSSID buffers the frame. In view thereof, the method for configuring the Partial Virtual Bitmap subfield will be described.

When the maximum number of BSSIDs that a multiple BSSID set can have is n, bits from bitmap number 1 to bitmap number (2\hat{ }n−1) in the traffic indication virtual bitmap subfield may indicate whether a group addressed frame has been buffered to an AP which transmits a TIM element. The group addressed frame may be a frame buffered to an AP corresponding to a nontransmitted BSSID. Therefore, the group addressed frame is a group addressed frame of the AP or BSS corresponding to the nontransmitted BSSID. Each of the bits from bitmap number 1 to bitmap number (2\hat{ }n−1) in the traffic indication virtual bitmap subfield may indicate whether a frame has been buffered to an AP corresponding to each bit. A bit having a bit number greater than (2\hat{ }n−1) in the traffic indication virtual bitmap subfield indicates that a frame to be transmitted to a station with an AID of n is buffered to an AP transmitting the TIM element. Therefore, the AP may not assign 1 to (2\hat{ }n−1) as AIDs. In the embodiment, a bit corresponding to an inactive nontransmitted BSSID may be configured as a reserved bit. The value of the reserved bit may be set to 0. In addition, the AP may assign, as a station's AID, a number equal to or greater than 2\hat{ }n. In this case, the AP may assign the station's AID from values from 2\hat{ }n to 2007. The EHT AP may not assign 2007 as the AID. The range to which the AID may be assigned in this manner is referred to as an AID space. A transmitted BSSID and a nontransmitted BSSID may share one AID space. In a specific embodiment, the EHT AP may not assign 2007 as the station's AID.

The maximum number of BSSIDs that the multiple BSSID set can have, n, may be signaled through a multiple BSSID element. n may be the value indicated by a MaxBSSID Indicator of the multiple BSSID element.

The method for configuring the Partial Virtual Bitmap subfield will be described. The method for configuring the Partial Virtual Bitmap subfield may vary depending on a multiple BSSID set-related function of an AP transmitting a TIM element. A non-S1G AP may configure the Partial Virtual Bitmap subfield by using either method A or method B. In addition, an S1G AP may configure the Partial Virtual Bitmap subfield by using method C. A non-HT AP, an HT AP, a VHT AP, an HE AP, and an EHT AP may all be non-S1G APs. The S1G AP is an AP that operates in a frequency band of 1 GHz or lower, and the non-S1G AP is an AP that operates in a frequency band greater than 1 GHz.

Method A is described first. The Partial Virtual Bitmap subfield may include bits from octet number 0 to octet number N2 in the traffic indication virtual bitmap. N2 is the smallest number among numbers which satisfy the condition that bits of bit numbers (N2+1)*8 to 2007 in the traffic indication virtual bitmap all have a value of 0. When there is no N2 that satisfies the condition, N2 is 250. In method A, the value of the Bitmap Offset field is 0. In addition, the value of the Length field is N2+4.

Method B will be described. The Partial Virtual Bitmap subfield may include bits of octet numbers 0 to (N0−1) in the traffic indication virtual bitmap and bits of octet numbers N1 to N2 in the traffic indication virtual bitmap. NO may be the largest positive integer satisfying (N0*8−2\hat{ }n<8). When NO is an odd number, N1 may be the largest even number satisfying a condition wherein: N0<N1; and a condition that bits of bit numbers NO*8 to (N1*8−1) all have a value of 0. When there is no value satisfying N1>NO, N1 may be NO. In addition, N2 is the smallest positive integer satisfying a condition that bits of bit numbers (N2+1)*8 to 2007 in the traffic indication virtual bitmap all have a value of 0. When there is no N2 satisfying the condition, N2 may be 250. In method B, the value of the Bitmap Offset field is (N1−N0)/2. In addition, the value of the Length field is (N0+N2−N1+4). When there is no buffered frame in any BSS corresponding to a transmitted BSSID and a nontransmitted BSSID, the length of the Partial Virtual Bitmap subfield is 1 octet, and the value of the bits in the Partial Virtual Bitmap subfield may be set to 0. In this case, the value of the Bitmap Offset field is 0. In addition, the value of the Length field is 4.

When no individually addressed frame is buffered to any BSS corresponding to the transmitted BSSID and the nontransmitted BSSID, and when a group addressed frame is buffered to one or more BSSs, the Partial Virtual Bitmap subfield may include bits of octet numbers 0 to (N0−1). N0 is the largest positive integer satisfying (N0*8−2\hat{ }n)<8.

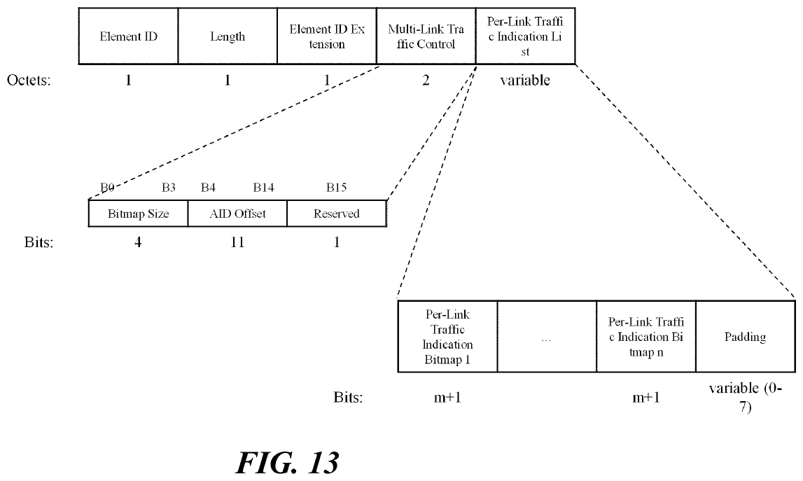

It may be necessary to indicate traffic buffered in each of multiple links in which a multi-link device operates. This will be described with reference to FIGS. 13 to 18.

FIG. 13 illustrates the format of a Multi-Link Traffic element according to an embodiment of the present disclosure.

APs operating in one multi-link device may share an AID space. Specifically, one multi-link device may have one AID space. In this case, when a frame buffered to an AP is indicated via the TIM element described with reference to FIG. 12, it may be difficult for a station to determine a link in which the frame has been buffered. A traffic indication signaling method is needed to address the above problem. Specifically, a multi-link device may perform traffic indication signaling on a per-link basis. In a specific embodiment, a multi-link device may perform traffic indication signaling for each of stations belonging to the multi-link device. A TIM element transmitted by the multi-link device may indicate, for each of multiple links in which the multi-link device operates, whether there is a buffered frame in each of the multiple links. The TIM element transmitted by the multi-link device is referred to as a Multi-Link Traffic element.

The multi-link device may transmit the Multi-Link Traffic element through a beacon frame or a TIM frame. In addition, the Multi-Link Traffic element may be included in a frame that includes a TIM element.

In FIG. 13, the Multi-Link Traffic element may include an Element ID subfield, a Length subfield, an Element ID Extension subfield, a Multi-Link Traffic Control subfield, and a Per-Link Traffic Indication List subfield.

The Element ID subfield is a 1-octet field and indicates the ID of an element that including the Element ID subfield.

The Length subfield is a 1-octet field and indicates the length of an element that includes the Length subfield. Specifically, the Length subfield may specify the length of an element, excluding the Element ID subfield and the Length subfield.

The Element ID Extension subfield is a 1-octet field, and is combined with the value of the Element ID subfield including the Element ID Extension subfield to indicate a value for identifying the element.

The Multi-Link Traffic Control subfield is a 1-octet field and includes a Bitmap Size subfield and an AID Offset subfield. The Bitmap Size subfield is a 4-bit subfield and indicates the size of a Per-Link Traffic Indication Bitmap subfield. When the value of Bitmap Size is M, the size of the Per-Link Traffic Indication Bitmap subfield may be M+1. The value of Bitmap Size, 0, is a reserved value.

The AID Offset subfield is an 11-bit subfield and indicates the starting position of bits of a traffic indication virtual bitmap indicated by the Per-Link Traffic Indication List or the Per-Link Traffic Indication Bitmap subfield. Therefore, in relation to the AID Offset subfield, an association ID (AID) corresponding to the Per-Link Traffic Indication List or the Per-Link Traffic Indication Bitmap subfield is determined based on AID Offset subfield. When the value of AID Offset is K, the Per-Link Traffic Indication List or the Per-Link Traffic Indication Bitmap subfield indicates bits in the traffic indication virtual bitmap starting from bit number K. In addition, when the value of AID Offset subfield is K, the smallest value among AIDs corresponding to the Per-Link Traffic Indication List or the Per-Link Traffic Indication Bitmap subfield is K. The Per-Link Traffic Indication List subfield is a field having a variable length and may include one or more Per-Link Traffic Indication Bitmap subfields. When the value of the AID Offset subfield is K, each Per-Link Traffic Indication Bitmap subfield indicates bits in the traffic indication virtual bitmap, starting from bit number K. The number of Per-Link Traffic Indication Bitmap subfields included in the Per-Link Traffic Indication List subfield may be the number of bits which are set to 1, among bits in a Partial Virtual Bitmap that correspond to the AID of a non-AP multi-link device. Multiple Per-Link Traffic Indication Bitmap subfields may be sorted based on AIDs corresponding to the Per-Link Traffic Indication Bitmap subfields in the Per-Link Traffic Indication List subfield. Specifically, the multiple Per-Link Traffic Indication Bitmap subfields may be sorted in ascending order of AIDs corresponding to the Per-Link Traffic Indication Bitmap subfields in the Per-Link Traffic Indication List subfield.

When the value of the Bitmap Size field is m, the size of the Per-Link Traffic Indication Bitmap subfields is m+1 bits. When a TID-to-link mapping negotiation is successful, each of bits in the Per-Link Traffic Indication Bitmap subfields indicates whether traffic to be transmitted to a non-AP station operating in a link corresponding to the bit is buffered. Specifically, when the value of each of bits in the Per-Link Traffic Indication Bitmap subfields is 1, the bit in the Per-Link Traffic Indication Bitmap subfield may indicate that traffic to be transmitted to a non-AP station operating in a link corresponding to the bit is buffered. When the value of each of bits in the Per-Link Traffic Indication Bitmap subfields is 0, the bit in the Per-Link Traffic Indication Bitmap subfields may indicate that traffic to be transmitted to a non-AP station operating in a link corresponding to the bit is not buffered. When TID-to-link mapping is default mapping, each of bits in the Per-Link Traffic Indication Bitmap subfields may indicate whether it is recommended to retrieve transmission of traffic buffered in a link corresponding to the bit. Specifically, when the value of a bit in the Per-Link Traffic Indication Bitmap subfields is 1, the bit in the Per-Link Traffic Indication Bitmap subfields may indicate that it is recommended to retrieve transmission of traffic buffered in a link corresponding to the bit. When the TID-to-link mapping of a link corresponds to default mapping, uplink transmission and downlink transmission in the link may be performed without TID restrictions. In addition, default mapping is applied to a link for which TID-to-link mapping negotiation was not successful. Therefore, the case of successfully performed TID-to-link mapping negotiation may indicate a case in which the TID-to-link mapping negotiation is successful and not all TIDs are mapped to all links.

The bits in the Per-Link Traffic Indication Bitmap subfields are mapped to links, based on the bit numbers of the bits. Specifically, a bit with a bit number of n in the Per-Link Traffic Indication Bitmap subfields may be mapped to a link with a link ID of n. In addition, the Per-Link Traffic Indication List subfield may include a padding field. Thus, the Per-Link Traffic Indication List subfield may have a length in octets. The padding field may have a length ranging from 0 bits to 7 bits.

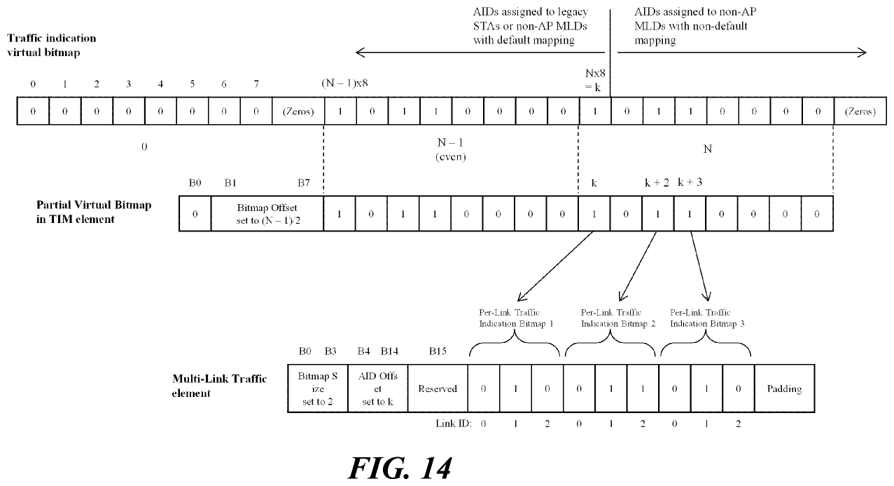

An AP multi-link device may transmit a frame that includes both a Multi-Link Traffic element and a TIM element. The frame may be a beacon frame. With reference to FIG. 14, a description will be made of a method by which the AP multi-link device uses the Multi-Link Traffic element and the TIM element to signal traffic buffered to the AP multi-link device.

FIG. 14 illustrates a method by which a Multi-Link Traffic element and a Partial Virtual Bitmap subfield in a TIM element according to an embodiment of the present disclosure is used to signal traffic buffered to an AP multi-link device.

A bit, which corresponds to a non-AP multi-link device, in a Partial Virtual Bitmap subfield in a TIM element transmitted by the AP multi-link device or a traffic indication virtual bitmap may be set to 1. The non-AP multi-link device may parse a Multi-Link Traffic element. Based on a Per-Link Traffic Indication Bitmap subfield corresponding to the non-AP multi-link device in the Multi-Link Traffic element, the non-AP multi-link device may determine which link is a link in which the non-AP multi-link device is recommended to retrieve transmission of buffered traffic, or the non-AP multi-link device may determine which link is a link in which buffered traffic has been buffered. When a TID-to-link mapping negotiation has been successfully performed as described with reference to FIG. 13, the non-AP multi-link device may determine, based on the value of a bit in the Per-Link Traffic Indication Bitmap subfield corresponding to the non-AP multi-link device, whether traffic to be transmitted to a station of the non-AP multi-link device operating in a link corresponding to the bit has been buffered. In addition, when the TID-to-link mapping is default mapping, the non-AP multi-link device may indicate, based on the value of a bit in the Per-Link Traffic Indication Bitmap subfield corresponding to the non-AP multi-link device, whether the AP multi-link device recommends the non-AP multi-link device to retrieve transmission of traffic buffered in a link corresponding to the bit.

The non-AP multi-link device may request the AP multi-link device to transmit traffic buffered in a link corresponding to a bit, which is set to 1, among bits in the Per-Link Traffic Indication Bitmap subfield corresponding to the non-AP multi-link device. Specifically, when the TID-to-link mapping negotiation has been successfully performed, the non-AP multi-link device may request the AP multi-link device to transmit traffic buffered in a link corresponding to a bit, which is set to 1, among bits in the Per-Link Traffic Indication Bitmap subfield corresponding to the non-AP multi-link device. When the TID-to-link mapping is default mapping, the non-AP multi-link device may request the AP multi-link device to transmit traffic buffered in one or more links that include a link corresponding to a bit, which is set to 1, among bits in the Per-Link Traffic Indication Bitmap subfield corresponding to the non-AP multi-link device. In the above embodiments, the non-AP multi-link device may transmit a U-APSD trigger frame or a PS-Poll frame to request the AP multi-link device to transmit the buffered traffic. When the request for transmission of the buffered traffic is received, the AP multi-link device may transmit the buffered traffic to the non-AP multi-link device. In addition, when the request for transmission of the buffered traffic, the AP multi-link device may transmit a QoS null frame instead of the buffered traffic.

In the embodiment of FIG. 14, a station which is a legacy station prior to EHT or in which TID-to-link mapping is set as the default mapping has been assigned a value less than K as an AID value. A non-AP station, in which a negotiation regarding TID-to-link mapping was successfully performed, has been assigned a value equal to or greater than K as an AID value. In the traffic indication virtual bitmap of FIG. 14, all bits having bit numbers less than bit number (N−1)*8 are set to 0. Therefore, the AP multi-link device does not buffer traffic for a station having an AID less than (N−1)*8. At least one of bits corresponding to bit numbers greater than or equal to (N−1)*8 is set to 1. N−1 is an even number, and the value of N*8 is the value of k. Therefore, the Partial Virtual Bitmap subfield includes bits, starting from bit number (N−1)*8, in the traffic indication virtual bitmap. The value of a Bitmap Offset subfield in the Partial Virtual Bitmap subfield is set to (N−1)/2. In addition, the values of bits in the Partial Virtual Bitmap subfield, which have AIDs corresponding to (N−1)*8, (N−1)*8+2, (N−1)*8+3, k, k+2, and k+3, are set to 1.

As described above, the AID Offset subfield in the Multi-Link Traffic element may indicate the AID of a multi-link device that corresponds to the foremost Per-Link Traffic Indication Bitmap subfield among Per-Link Traffic Indication Bitmap subfields in the Multi-Link Traffic element. In FIG. 14, the value of the AID Offset subfield is set to K. The Multi-Link Traffic element includes Per-Link Traffic Indication Bitmap subfields that correspond to multi-link devices indicated as 1 by the Partial Virtual Bitmap subfield. In FIG. 14, the Multi-Link Traffic element includes a Per-Link Traffic Indication Bitmap subfield for each of non-AP multi-link devices or stations having AIDs of k, k+2, and k+3. The Per-Link Traffic Indication Bitmap subfields are sorted in ascending order of AIDs.

The value of a Bitmap Size field in the Multi-Link Traffic element is 2. Therefore, each Per-Link Traffic Indication Bitmap subfield of the Multi-Link Traffic element includes three bits. The first bit (B0) of the Per-Link Traffic Indication Bitmap subfield is mapped to a link having a link ID of 0, the second bit (B1) is mapped to a link having a link ID of 1, and the third bit (B2) is mapped to a link having a link ID of 2.

As described above, default mapping is applied to a multi-link device corresponding to an AID value of K, and in the case of multi-link devices corresponding to AID values of K+2 and K+3, TID-to-link mapping has been successfully performed. Therefore, the Per-Link Traffic Indication Bitmap subfield corresponding to AID K indicates that a request to transmit traffic buffered in a link having a link ID of 1 is recommended. In addition, the Per-Link Traffic Indication Bitmap subfield corresponding to AID K+2 indicates that the AP multi-link device is buffering traffic in two links having a link ID of 1 and a link ID of 2. Traffic buffered in the link having a link ID of 1 may be the same as or different from traffic buffered in the link having a link ID of 2. In addition, the Per-Link Traffic Indication Bitmap subfield corresponding to AID K+3 indicates that the AP multi-link device is buffering traffic in a link having a link ID of 1.

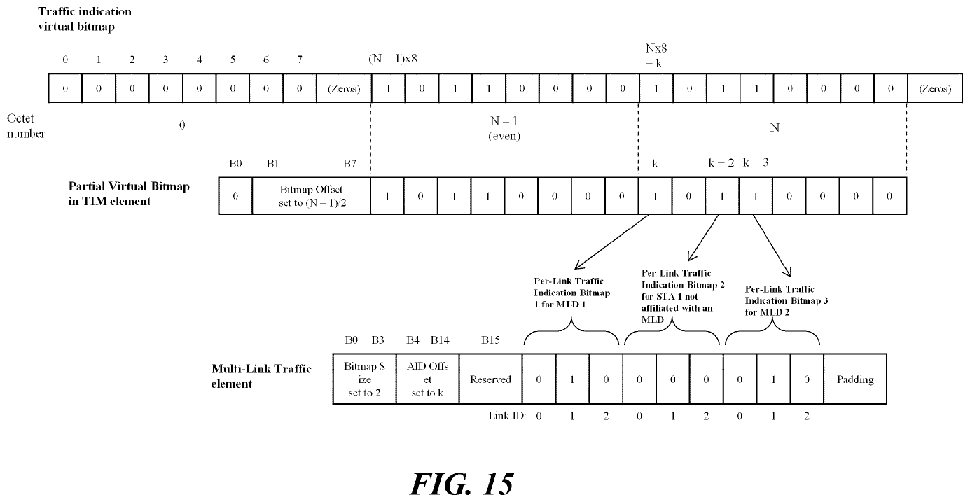

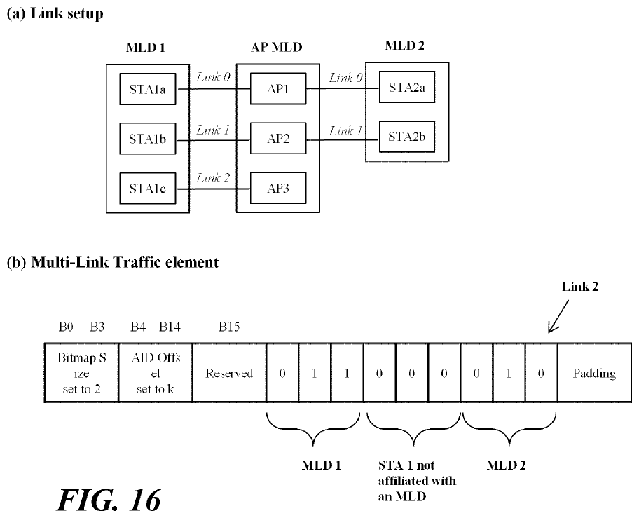

However, it is not ensured that AIDs of non-AP multi-link devices that are connected to AP multi-link devices will be assigned consecutively. In addition, an AID between the AIDs of the non-AP multi-link devices may be assigned an AID of a non-AP station that is not included in the multi-link devices. In this case, it may be difficult for the non-AP multi-link device to determine which AIDs belong to the station which is not included in the non-AP multi-link devices. Therefore, when the Multi-Link Traffic element does not include a Per-Link Traffic Bitmap subfield for the station which is not included in the non-AP multi-link devices, the non-AP multi-link devices may have difficulty in parsing the Per-Link Traffic Bitmap subfield. For example, in the embodiment of FIG. 14, AID K+1 is assigned to a non-AP multi-link device, and a bit corresponding to AID K+1 in the Partial Virtual Bitmap subfields of the TIM element may have a value of 1. At this time, a non-AP multi-link device having an AID of K+2 or K+3 may not determine which of three Per-Link Traffic Bitmap subfields is the Per-Link Traffic Bitmap subfield for the non-AP multi-link device. Therefore, to solve the above problem, a method for configuring a Multi-Link Traffic element is needed. The method will be described with reference to FIG. 15.

FIG. 15 illustrates a method for configuring a Multi-Link Traffic element according to an embodiment of the present disclosure.

In an embodiment of the present disclosure, an AP multi-link device may include, in a Multi-Link Traffic element, a Per-Link Traffic Bitmap subfield for a non-AP station that is not included in the multi-link device. Specifically, even in the case of a non-AP station that is not included in the multi-link device, the AP multi-link device may include a Per-Link Traffic Bitmap subfield for the non-AP station in the Multi-Link Traffic element when the value of a bit in a Traffic Indication Bitmap subfield or a Partial Virtual Bitmap subfield corresponding to the non-AP station is 1. Therefore, the AP multi-link device may include, in the Multi-Link Traffic element, Per-Link Traffic Bitmap subfields for all stations that correspond to bits in the Traffic Indication Bitmap subfield or bits in the Partial Virtual Bitmap subfield, which are set to 1. For ease of description, a station corresponding to a bit in the Traffic Indication Bitmap subfield or a bit in the Partial Virtual Bitmap subfield, which is set to 1, is referred to as a station for which buffered traffic is indicated.

The AP multi-link device may include, in the Multi-Link Traffic element, Per-Link Traffic Bitmap subfields for all stations for which buffered traffic is indicated, regardless of whether the stations for which buffered traffic is indicated are stations belonging to the multi-link device, whether the stations correspond to non-AP multi-link devices, and which AP or BSS is an AP or BSS to which the stations belong. Which AP or BSS is an AP or BSS to which the stations for which traffic is indicated belong may indicate whether the station for which buffered traffic is indicated belongs to a multiple BSSID set.

The AP multi-link device may include, in the Multi-Link Traffic element, as many Per-Link Traffic Bitmap subfields as the number of stations for which buffered traffic is indicated. The following describes a method by which the AP multi-link device configures a Per-Link Traffic Bitmap subfield for a station that does not belong to the multi-link device.

The AP multi-link device may set, to 0, the values of all bits in a Per-Link Traffic Bitmap subfield corresponding to a station that does not belong to the multi-link device. That is, the AP multi-link device may set the values of the bits in the Per-Link Traffic Bitmap subfield corresponding to a station that does not belong to the multi-link device as reserved fields. In another specific embodiment, the AP multi-link device may set the values of bits in a Per-Link Traffic Bitmap subfield corresponding to a station that does not belong to the multi-link device to an arbitrary value. In another specific embodiment, the AP multi-link device may set the values of bits in a Per-Link Traffic Bitmap subfield corresponding to a station that does not belong to the multi-link device to 1. In this case, the non-AP multi-link device may disregard the values of the bits in the Per-Link Traffic Bitmap subfield corresponding to the station that does not belong to the multi-link device. In another specific embodiment, the AP multi-link device may set the values of bits in a Per-Link Traffic Bitmap subfield corresponding to a station that does not belong to the multi-link device to 1. In another specific embodiment, the AP multi-link device may set the value of a bit, among bits in a Per-Link Traffic Bitmap subfield, which corresponds to a link in which a station that does not belong to the multi-link device operates, to 1 and set the values of the remaining bits to 0.

In the embodiment of FIG. 15, the configuration of the traffic indication virtual bitmap and the configuration of the Partial Virtual Bitmap subfield may be the same as the configuration of the traffic indication virtual bitmap and the configuration of the Partial Virtual Bitmap subfield in FIG. 14. However, in the embodiment of FIG. 15, AID k and AID k+3 correspond to non-AP multi-link devices. AID K+2 corresponds to a station that is not included in a multi-link device. Per-Link Traffic Bitmap subfields, corresponding to AID k and AID k+3, in the Multi-Link Traffic element are configured as shown in the embodiment of FIG. 14. Since AID K+2 is a station that is not included in the multi-link device, bits in a Per-Link Traffic Bitmap subfield corresponding to AID k+2 in the Multi-Link Traffic element are all set to 0.

An AID Offset subfield in the Multi-Link Traffic element may indicate bits after all bits corresponding to a Group ID and a group addressed frame among bits in the traffic indication virtual bitmap and bits in the Partial Virtual Bitmap subfield. The Group Id may include an AID value of 0. In addition, the Group ID may include bit numbers in the traffic indication virtual bitmap, corresponding to the multiple BSSID set, that is, AIDs corresponding to bit numbers. Furthermore, the Group ID may include bit numbers in the traffic indication virtual bitmap, corresponding to a transmitted BSSID and a nontransmitted BSSID, that is, AIDs corresponding to bit numbers. The Group ID may include values corresponding to AIDs 0 to (2\hat{ }n−1), when the maximum number of possible BSSIDs in the multiple BSSID set is 2\hat{ }n. The AID Offset subfield may indicate a value after values corresponding to AIDs 0 to (2\hat{ }n−1) when a multiple BSSID set is used and when the maximum number of possible BSSIDs in the multiple BSSID set is 2\hat{ }n. This configuration of the AID Offset field is because the group addressed frame is not limited to one transmitted through a specific link, and thus it may make less sense to signal the frame in each link.

According to another embodiment of the present disclosure, even when the AID Offset subfield indicates bits before bits indicating a Group ID among bits in the traffic indication virtual bitmap and bits in the Partial Virtual Bitmap subfield, a Per-Link Traffic Indication Bitmap subfield corresponding to the Group ID may not be included in the Multi-Link Traffic element. Even when the AID Offset subfield indicate bits before bits indicating the Group ID among bits in the traffic indication virtual bitmap and bits in the Partial Virtual Bitmap subfield, the Multi-Link Traffic element may include only a Per-Link Traffic Indication Bitmap subfield that corresponds to an individual station among stations for which buffered traffic is indicated. Specifically, when the maximum number of BSSIDs which can be configured as BSSIDs in the multiple BSSID set is 2\hat{ }n, the AID Offset subfield may indicate bits corresponding to AIDs equal to or less than (2\hat{ }n−1) among the bits in the traffic indication virtual bitmap and the bits in the Partial Virtual Bitmap subfield. In this case, the Multi-Link Traffic element may include only a Per-Link Traffic Indication Bitmap that corresponds to a bit, which is set to 1 and corresponds to AID 2\hat{ }n, among the bits in the traffic indication virtual bitmap and the bits in the Partial Virtual Bitmap subfield. A station receiving the Multi-Link Traffic element may determine that the Multi-Link Traffic element includes only a Per-Link Traffic Indication Bitmap corresponding to a bit, which is set to 1 and corresponds to AID 2\hat{ }n, among the bits in the traffic indication virtual bitmap and the bits in the Partial Virtual Bitmap subfield.

According to another embodiment of the present disclosure, regardless of whether the AID Offset subfield indicates bits before a bit indicating a Group ID, among the bits in the traffic indication virtual bitmap and bits in the Partial Virtual Bitmap subfield, the Multi-Link Traffic element may include a Per-Link Traffic Indication Bitmap corresponding to each of all bits, which are set to 1, after a bit indicated by the AID Offset subfield in the traffic indication virtual bitmap and in the Partial Virtual Bitmap subfield. At this time, the AP multi-link device may set, to a predetermined value, all of the values of Per-Link Traffic Indication Bitmap fields corresponding to bits in the traffic indication virtual bitmap and the Partial Virtual Bitmap subfield corresponding to group addresses. The predetermined values may be 0. In another specific embodiment, the AP multi-link device may set, to predetermined values, the values of the Per-Link Traffic Indication Bitmap fields corresponding to the bits in the traffic indication virtual bitmap and Partial Virtual Bitmap subfield corresponding to the group addresses. Among the bits in Per-Link Traffic Indication Bitmap fields corresponding to bits in the traffic indication virtual bitmap and the Partial Virtual Bitmap subfield corresponding to group addresses, the AP multi-link device may set, to 1, a bit corresponding to a link in which a group addressed frame is transmitted, and may set the remaining bits to 0.

FIG. 16 illustrates a method for configuring a Per-Link Traffic Bitmap subfield in a Multi-Link Traffic element when a link set in which an AP multi-link device according to an embodiment of the present disclosure operates is different from a link set in which a non-AP multi-link device communicating with the AP multi-link device operates.

A link set in which an AP multi-link device operates may differ from a link set in which a non-AP multi-link device communicating with the AP multi-link device operates. For example, an AP multi-link device may communicate with a first non-AP multi-link device in links 1 to 3, and the AP multi-link device may communicate with a second non-AP multi-link device in links 1 and 2. In this case, an issue may be a method for configuring a Per-Link Traffic Bitmap subfield of a Multi-Link Traffic element.

Even when the link set in which the AP multi-link device operates is different from the link set on which non-AP multi-link device communicating with the AP multi-link device operates, the AP may configure all Per-Link Traffic Indication Bitmap subfields, included in the Multi-Link Traffic element, to have the same size, and may configure links, to which bits in all Per-Link Traffic Indication Bitmap subfields is mapped to, respectively, be the same. Specifically, the AP multi-link device may configure the number of bits in all Per-Link Traffic Indication Bitmap subfields included in the Multi-Link Traffic element to be greater than the number of links set up by the AP multi-link device. This is because IDs of multiple links set up by the AP multi-link device may not start from 0, or the IDs of the multiple links may not be consecutive. For example, the AP multi-link device may set the number of bits in each of all Per-Link Traffic Indication Bitmap subfields that include in the Multi-Link Traffic element to the maximum number of links that the AP multi-link device can set up. In another specific embodiment, the AP multi-link device may set the number of bits in each of all Per-Link Traffic Indication Bitmap subfields included in the Multi-Link Traffic element to a number obtained by adding 1 to the largest link ID value that can be set by the AP multi-link device.

An issue may be a method for setting the values of bits in Per-Link Traffic Indication Bitmap subfields corresponding to a link which is not set up by the AP multi-link device and a link which is not setup by the non-AP multi-link device corresponding to a Per-Link Traffic Indication Bitmap subfield. For ease of description, the bits in Per-Link Traffic Indication Bitmap subfields corresponding to a link which is not set up by the AP multi-link device and a link which is not setup by the non-AP multi-link device corresponding to a Per-Link Traffic Indication Bitmap subfield are referred to as no-link bits. The AP multi-link device may set the value of a no-link bit to a predetermined value. Therefore, the AP multi-link device may set, to a predetermined value, bits in a Per-Link Traffic Indication Bitmap subfield corresponding to a link that is not set up by the AP multi-link device or the non-AP multi-link device. In this case, the predetermined value may be 0. In another specific embodiment, the AP multi-link device may set the value of a no-Link bit to a predetermined value. In this case, a non-AP station may disregard the value of the no-link bit.

Further, the value of a bit in a Per-Link Traffic Indication Bitmap subfield corresponding to a disabled link may be configured to be reserved. Specifically, the value of the bit in the Per-Link Traffic Indication Bitmap subfield corresponding to the disabled link may be set to 0. In this case, the disabled link may be a link in which uplink transmission and downlink transmission have been stopped. Specifically, the disabled link may be a link in which uplink transmission and downlink transmission of individual address frames have stopped. In this case, a non-AP station may disregard the value of a no-disabled bit.

In the embodiment of FIG. 16, as shown in FIG. 16A, an AP multi-link device (AP MLD) operates in a first link (Link 0) to a third link (Link 2). A first multi-link device (MLD 1) and the AP multi-link device (AP MLD) set up the first link (Link 0) to the third link (Link 2). A second multi-link device (MLD 2) and the AP multi-link device (AP MLD) set up the first link (Link 0) and a second link (Link 1). The AP multi-link device (AP MLD) sets the number of bits in a Per-Link Bitmap subfield of a Multi-Link Traffic element to 3 bits. The Multi-Link Traffic element to be sent by the AP multi-link device (AP MLD) includes a Per-Link Bitmap subfield corresponding to each of the first multi-link device (MLD 1), a first station (STA 1), and the second multi-link device (MLD 2). The AP multi-link device (AP MLD) sets the value of the Per-Link Bitmap subfield corresponding to the first multi-link device (MLD 1), based on the embodiments described with reference to FIGS. 14 and 15. In addition, the AP multi-link device (AP MLD) sets the value of the Per-Link Bitmap subfield corresponding to the first station (STA 1), based on the embodiments described with reference to FIG. 15. The AP multi-link device (AP MLD) sets the value of a first bit (B0) and a second bit (B1) in the Per-Link Bitmap subfield corresponding to the second multi-link device (MLD 2), based on the embodiments described with reference to FIGS. 14 and 15. In addition, the AP multi-link device (AP MLD) sets the value of a third bit (B2) in the Per-Link Bitmap subfield corresponding to the second multi-link device (MLD 2) to 0 which is a predetermined value as described above.

In the above-described embodiments, the bit number of a bit in a Per-Link Traffic Indication Bitmap subfield and the ID of a link corresponding to the bit have been described as being the same. Depending on a specific embodiment, the bit number of a bit in the Per-Link Traffic Indication Bitmap subfield and the ID of a link corresponding to the bit may not be the same. Link IDs of links set up by the AP multi-link device that transmitted the Per-Link Traffic Indication Bitmap subfield may be mapped, in ascending order, to the bit numbers of bits in the Per-Link Traffic Indication Bitmap subfield. The AP multi-link device may set up a link having an ID of 1 and a link having an ID of 3, and the Per-Link Traffic Indication Bitmap subfield may be a 2-bit field. In this case, the first bit (B0) in the Per-Link Traffic Indication Bitmap subfield is mapped to the link having an ID of 1, and the second bit (B1) is mapped to the link having an ID of 3.

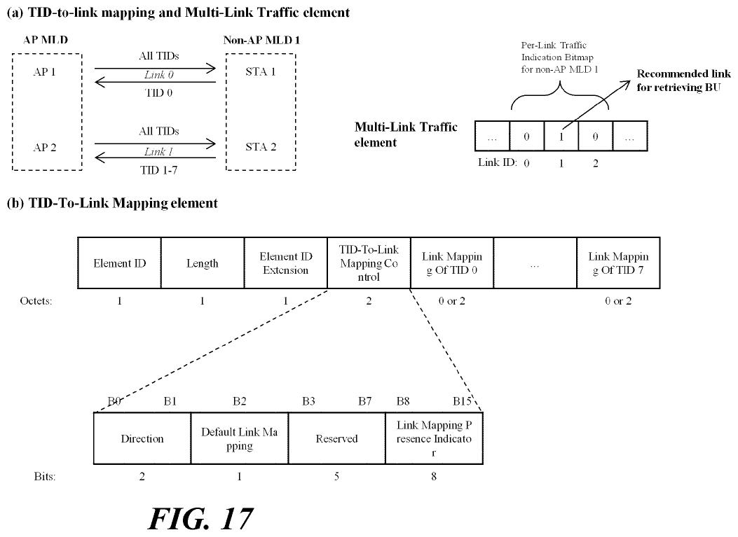

FIG. 17 illustrates a method by which a link indicated by a Per-Link Traffic Bitmap subfield is determined based on TID-to-link mapping according to an embodiment of the present disclosure.

As described earlier, when a TID-to-link mapping negotiation has been successfully performed, a bit in the Per-Link Traffic Indication Bitmap subfield indicates whether traffic to be transmitted to a non-AP station operating in a link corresponding to the bit has been buffered. Specifically, when the value of a bit in the Per-Link Traffic Indication Bitmap subfield is 1, the bit in the Per-Link Traffic Indication Bitmap subfield may indicate that traffic to be transmitted to a non-AP station operating in a link corresponding to the bit is buffered. When the value of a bit in the Per-Link Traffic Indication Bitmap subfield is 0, the bit in the Per-Link Traffic Indication Bitmap subfield may indicate that traffic to be transmitted to a non-AP station operating in a link corresponding to the bit is not buffered. When TID-to-link mapping is default mapping, a bit in a Per-Link Traffic Indication Bitmap subfield may indicate whether it is recommended to request (retrieve) traffic buffered in a link corresponding to the bit. Specifically, when the value of a bit in a Per-Link Traffic Indication Bitmap subfield is 1, the bit in the Per-Link Traffic Indication Bitmap subfield may indicate that it is recommended to request transmission of traffic buffered in a link corresponding to the bit. When the TID-to-link mapping of a link corresponds to default mapping, then uplink transmission and the downlink transmissions in the link may be performed TID restriction. In addition, the default mapping is applied to a link for which TID-to-link mapping negotiation has not been successfully performed, or a link for which a TID-to-link mapping negotiation has been torn down.

The above-described case in which the TID-to-link mapping has been successfully performed may indicate the case in which the TID-to-link mapping, rather than the default mapping is applied. Furthermore, as described above, the TID-to-link mapping may be applied separately for each transmission direction. Thus, in the above-described embodiments, a successful TID-to-link mapping negotiation may indicate a successful TID-to-link mapping negotiation for downlink transmission. Furthermore, the case in which default mapping is applied may indicate that TID-to-link mapping for downlink transmission is default mapping.

In the embodiment of FIG. 17, an AP multi-link device (AP MLD) and a non-AP multi-link device (non-AP MLD 1) successfully perform a TID-to-link mapping negotiation. The AP multi-link device (AP MLD) and the non-AP multi-link device (non-AP MLD 1) map a TID value of 0 to uplink transmission in a first link (link 0). Furthermore, the AP multi-link device (AP MLD) and the non-AP multi-link device (non-AP MLD 1) map TID values 1 to 7 to uplink transmissions in a second link (link 1). At this time, the AP multi-link device (AP MLD) and the non-AP multi-link device (non-AP MLD 1) apply default mapping to the downlink transmissions in the first link (link 0) and the downlink transmissions in the second link (link 1). Therefore, when a bit in a Per-Link Traffic Indication Bitmap subfield transmitted by the AP multi-link device (AP MLD) has a value of 1, the non-AP multi-link device (non-AP MLD 1) determines that the AP multi-link device (AP MLD) recommends the non-AP multi-link device (non-AP MLD 1) to request the transmission of traffic in a link corresponding to the bit set to 1. In the Per-Link Traffic Indication Bitmap subfield of (a) of FIG. 17, the value of a bit corresponding to the second link (link 1) is 1. Therefore, the non-AP MLD 1 determines that it is recommended to request the transmission of traffic in link 1.

(b) of FIG. 17 shows a TID-to-Link Mapping element used for a TID-to-link mapping negotiation. A multi-link device may include a TID-to-Link Mapping element in a (re)association request frame, a (re)association response frame, a TID-to-Link mapping request frame, and a TID-to-Link mapping response frame. When the multi-link device requests TID-to-link mapping, the multi-link device may include the TID-to-Link Mapping element in a (re)association request frame or a TID-To-Link mapping request frame. When a multi-link device responds to the TID-to-link mapping request, the multi-link device may include the TID-to-Link Mapping element in a (re)association response frame or a TID-to-Link mapping response frame.

The TID-to-Link Mapping element may include an Element ID subfield, a Length subfield, an Element ID Extension subfield, a TID-To-Link Mapping Control subfield, and seven Link Mapping subfields corresponding to TIDs 0 to 7. The TID-To-Link Mapping Control subfield may include a Direction subfield, a Default Link Mapping subfield, a Reserved subfield, and a Link Mapping Presence Indicator subfield. The Direction subfield may show whether the TID-To-Link Mapping element including the Direction subfield indicates mapping applied to a certain transmission direction. The Direction subfield may indicate at least one among downlink, uplink, and bidirectional link. The Default Link Mapping subfield may indicate whether the TID-To-Link Mapping element including the Default Link Mapping subfield is for a TID-to-link mapping negotiation to apply default mapping. Specifically, the Default Link Mapping subfield may indicate whether the TID-To-Link Mapping element including the Default Link Mapping subfield is for a TID-to-link mapping negotiation to apply default mapping to the transmission direction indicated by the Direction subfield.

Each bit in the Link Mapping Presence Indicator subfield may indicate whether a Link Mapping subfield corresponding to each bit is included in the TID-To-Link Mapping element. Each bit in the Link Mapping Presence Indicator subfield may be mapped to a Link Mapping subfield for a TID having a value equal to the bit index. That is, an n-th bit (Bn−1) in the Link Mapping Presence Indicator subfield may be mapped to a Link Mapping subfield corresponding to TID n−1. The Link Mapping subfield indicates that a TID corresponding to the Link Mapping subfield is the subject of negotiation for TID-to-link mapping performed by the TID-to-Link Mapping element.

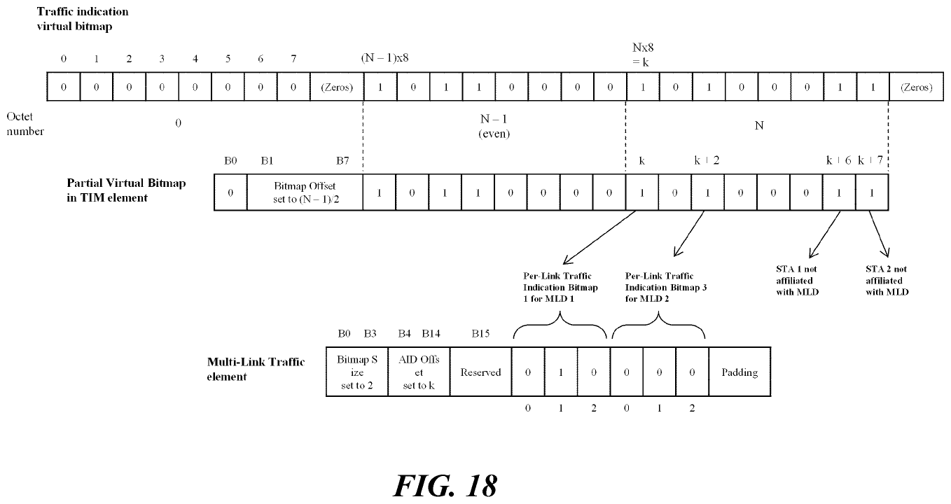

FIG. 18 illustrates a method by which an AP multi-link device according to another embodiment of the present disclosure configures a Per-Link Traffic Indication Bitmap subfield in a Multi-Link Traffic element.

In the embodiment described with reference to FIG. 16, a Multi-Link Traffic element includes Per-Link Traffic Indication Bitmap subfields for stations for which buffered traffic is indicated, regardless of whether the stations for which the buffered traffic is indicated are included in a multi-link device. In another embodiment of the present disclosure, the Multi-Link Traffic element may include Per-Link Traffic Indication Bitmap subfields for some of the stations for which buffered traffic is indicated, and not include a Per-Link Traffic Indication Bitmap subfields for the remaining stations for which buffered traffic is indicated. In this case, the stations for which buffered traffic is indicated may be limited to stations for which buffered traffic is indicated after a bit corresponding to an AID indicated by an AID Offset subfield. Specifically, an AP multi-link device may not include the Per-Link Traffic Indication Bitmap subfields for the stations for which buffered traffic is indicated in the Multi-Link Traffic element when the stations for which buffered traffic is indicated are not included in the multi-link device. This prevents the length of the Multi-Link Traffic element from becoming excessively long.

In another specific embodiment, the AP multi-link device may not include, in the Multi-Link Traffic element, a Per-Link Traffic Indication Bitmap subfield for a station corresponding to a bit after a specific bit among the stations for which buffered traffic is indicated. A station that receives the Multi-Link Traffic element may determine the last Per-Link Traffic Indication Bitmap subfield included in the Multi-Link Traffic element, based on the Length subfield of the Multi-Link Traffic element. Therefore, even if the Multi-Link Traffic element does not include the Per-Link Traffic Indication Bitmap subfield for the station corresponding to a bit after a specific bit among the stations for which buffered traffic is indicated, the station having received the Multi-Link Traffic element may parse the Multi-Link Traffic element normally. In the embodiment, the AP multi-link device may assign an AID for a station that is included in the multi-link device, wherein the AID has a smaller value than the AID for the stations that are not included in the multi-link device.

In the embodiment of FIG. 18, the AID Offset of the Multi-Link Traffic element indicates an AID value of K. Stations for which buffered traffic is indicated and which has an AID greater than K are the stations that are not included in two multi-link devices having AIDs of K and K+2 and multi-link devices having AIDs of K+6 and K+7. The Multi-Link Traffic element includes Per-Link Traffic Indication Bitmap subfields for the two multi-link devices having AIDs of K and K+2.

In another specific embodiment, the Multi-Link Traffic element may include an AID Offset2 subfield. A station having received the Multi-Link Traffic element may parse, based on the AID Offset2 subfield, Per-Link Traffic Indication Bitmap subfields in the Multi-Link Traffic element. The AID Offset2 subfield may indicate an AID to which the last Per-Link Traffic Indication Bitmap subfield of the Multi-Link Traffic element corresponds. In this case, the AID Offset2 subfield may represent all AID values. In another specific embodiment, the AID Offset2 subfield may indicate the maximum value of an AID that may correspond to the last Per-Link Traffic Indication Bitmap subfield.

In another specific embodiment, the AID Offset2 subfield may indicate the AID corresponding to the last Per-Link Traffic Indication Bitmap subfield in a predetermined number of units. For example, when the value of the AID Offset2 subfield is n, the AID Offset2 subfield may indicate that the AID corresponding to the last Per-Link Traffic Indication Bitmap subfield is 2\hat{ }N. Here, N is an integer. In the embodiment, the AID Offset2 subfield may have a length of (11-N) bits.

When the value of the AID Offset2 subfield is n, the AID Offset2 subfield may indicate that the value of AID is 2\hat{ }N*n. Here, n is an integer. For example, the AID may be indicated in 8 units. In this case, the AID Offset2 subfield may have a length of 8 bits. In the embodiment, the AID Offset2 subfield may indicate AIDs of 8, 16, 24, 32, etc. Thus, the length of the AID Offset2 subfield may be defined as being less than 11 bits.

In another specific embodiment, the AID Offset2 subfield may indicate the AID in the same units as those of the AID Offset subfield. Thus, it is possible to reduce the number of bits occupied by the AID Offset2 subfield and the AID Offset subfield.

In the above-described embodiments, one frame may include multiple Multi-Link Traffic elements. Specifically, from an AID list in which AID values of stations, for which buffered traffic is indicated and which have AIDs greater than or equal to the AID indicated by the AID Offset subfield, are sorted in ascending order, the AP multi-link device may generate a Multi-Link Traffic element including Per-Link Traffic Indication Bitmaps for one or more multi-link devices corresponding to AID values from the first AID in the list up to an exclusion AID before or after an AID corresponding to a station which is not included in the multi-link devices. In this case, AIDs up to the exclusion AID in the AID list are excluded from the AID list, and the AP multi-link device may generate a Multi-Link Traffic element including Per-Link Traffic Indication Bitmaps for one or more multi-link devices corresponding to AID values up to a new exclusion AID in the AID list. The AP multi-link devices may repeat the above operation to the end of the AID list to generate an additional Multi-Link Traffic element that includes Per-Link Traffic Indication Bitmaps for one or more multi-link devices. Through this, even when an AID not included in the multi-link devices is assigned between AIDs of the multi-link device, the Multi-Link Traffic element may include Per-Link Traffic Indication Bitmap subfields for the multi-link devices and may not include Per-Link Traffic Indication Bitmap subfields that are not included in the multi-link devices.

In the embodiment, a non-AP multi-link device may disregard a Multi-Link Traffic element that does not include a Per-Link Traffic Indication Bitmap subfield corresponding to the AID of the non-AP multi-link device. The non-AP multi-link device may determine, based on at least one of the value of an AID Offset subfield and the value of a Length subfield in a Multi-Link Traffic element, whether the Multi-Link Traffic element includes a Per-Link Traffic Indication Bitmap subfield that corresponds to the AID of the non-AP multi-link device. The non-AP multi-link device may determine, based on at least one of the value of an AID Offset subfield and the value of an AID Offset2 subfield in a Multi-Link Traffic element, whether the Multi-Link Traffic element includes a Per-Link Traffic Indication Bitmap subfield corresponding to the AID of the non-AP multi-link device.

Furthermore, in the above-described embodiments, when the non-AP multi-link device is not the station for which buffered traffic is indicated, the non-AP multi-link device may disregard the Multi-Link Traffic element.

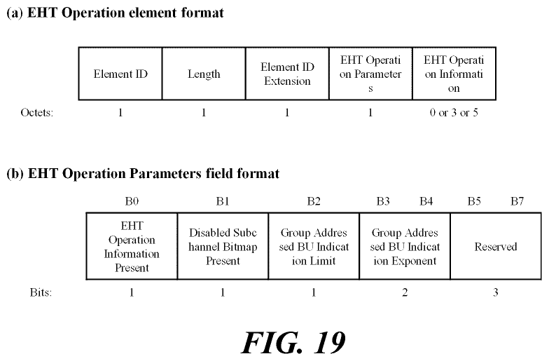

A method for determining an AID space will be described with reference to FIGS. 19 to 21. First, an EHT Operation element will be described with reference to FIG. 19.

FIG. 19 illustrates an EHT Operation element according to an embodiment of the present disclosure.

(a) of FIG. 19 shows the format of an EHT Operation element, and (b) of FIG. 19 shows an EHT Operation Parameters field. The EHT Operation element may include an Operation Parameters field. The Operation Parameters field may be a 1-octet field. The EHT Operation element may include an EHT Operation Information field. The EHT Operation Information field may have a size of 0, 3, or 5 octets. The EHT Operation Information field may include either the EHT Operation Information field or a Disabled Subchannel Bitmap field.

The EHT Operation Parameters field may include an EHT Operation Information Present subfield, a Disabled Subchannel Bitmap Present subfield, a Group Addressed BU Indication Limit subfield, and a Group Addressed BU Indication Exponent subfield. The EHT Operation Information Present subfield may be a 1-bit field, the Disabled Subchannel Bitmap Present subfield may be a 1-bit field, the Group Addressed BU Indication Limit subfield may be a 1-bit field, and the Group Addressed BU Indication Exponent subfield may be a 1-bit field.

The EHT Operation Information Present subfield may indicate whether the EHT Operation element includes the EHT Operation Information subfield. When the value of the EHT Operation Information Present subfield is 0, the EHT Operation element may not include the EHT Operation Information subfield. That is, when the EHT Operation Information Present subfield is set to 0, the length of the EHT Operation Information subfield may be 0 octets. When the value of the EHT Operation Information Present subfield is 1, the EHT Operation element may include the EHT Operation Information field. In this case, the length of the EHT Operation Information subfield may be 3 or 5 octets.

The Disabled Subchannel Bitmap Present subfield may indicate whether the EHT Operation Information field includes the Disabled Subchannel Bitmap subfield. When the value of the Disabled Subchannel Bitmap Present subfield is 0, the EHT Operation Information subfield may not include the Disabled Subchannel Bitmap subfield. In this case, the size of the EHT Operation Information subfield may be 3 octets. When the value of the Disabled Subchannel Bitmap Present subfield is 1, the EHT Operation Information subfield may include the Disabled Subchannel Bitmap subfield. In this case, the size of the EHT Operation Information subfield may be 5 octets.

The Group Addressed BU Indication Limit subfield may indicate whether there is a limit to indicating in a TIM element whether there are buffered group addressed frames for other APs which correspond to all nontransmitted BSSIDs in a multiple BSSID set and belong to the same AP multi-link device. A method for specifically configuring the Group Addressed BU Indication Limit subfield may be as follows.

When at least one of the following conditions is satisfied, the Group Addressed BU Indication Limit subfield may be set to 0. Otherwise, the Group Addressed BU Indication Limit subfield may be set to 1.

Condition 1. An AP (an AP transmitting the EHT Operation element) does not belong to a multiple BSSID set.

Condition 2. An AP (an AP transmitting the EHT Operation element, an AP transmitting a beacon frame, or an AP corresponding to a transmitted BSSID) belongs to a multiple BSSID set, and the number of bits required to indicate whether there are buffered group addressed frames corresponding to all other APs, which correspond to all nontransmitted BSSIDs and belong to the same AP multi-link device, is not greater than 48 bits.

In addition, the Group Addressed BU Indication Exponent subfield may indicate the number N of bits to be used to indicate buffered group addressed frames corresponding to other APs of the multi-link device corresponding to the respective nontransmitted BSSIDs. The value of N will be described later.

In addition, the aforementioned 48 bits may be replaced by other numbers of bits. As a result, in a traffic indication virtual bitmap, the number of bits required to indicate group addressed traffic regarding APs with nontransmitted BSSIDs and other APs in the same multi-link device may vary. In the present disclosure, 48 bits or any other number of bits may be referred to as a “bitmap limit”.

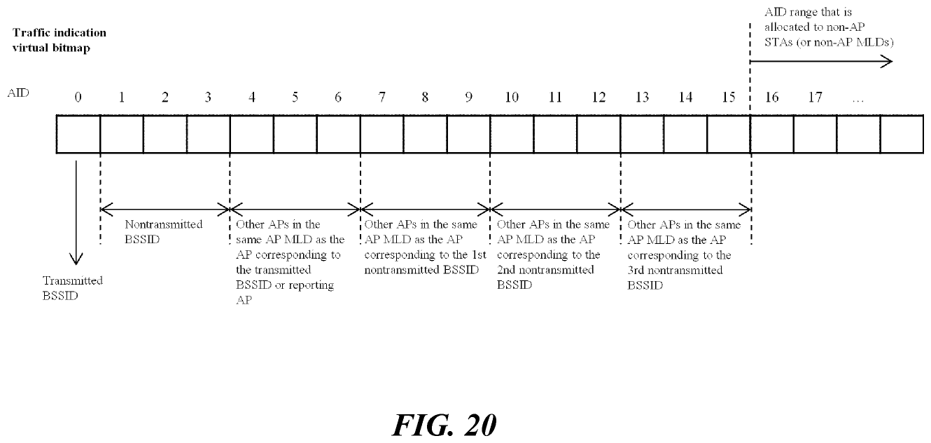

FIG. 20 illustrates a traffic indication virtual bitmap according to an embodiment of the present disclosure.

The traffic indication virtual bitmap may indicate group addressed traffic corresponding to APs of the same multi-link device corresponding to transmitted BSSIDs or AP of the multi-link device corresponding to nontransmitted BSSIDs. A station that receives the traffic indication virtual bitmap may determine whether group addressed traffic is buffered to an AP (or BSS) with which the station is associated. In addition, the station may receive the buffered group addressed traffic based on the determination.

In an embodiment of the present disclosure, in the traffic indication virtual bitmap, bits for group addressed traffic may be located first, and bits for traffic individually addressed to a station or a multi-link device may be located after the bits for group addressed traffic.

An AP transmitting a TIM element may indicate buffered group addressed frames corresponding to other APs belonging to a multi-link device to which the AP belongs. To indicate the buffered group addressed frames corresponding to other APs in the multi-link device to which the AP belongs, N bits following the last bit used to indicate a nontransmitted BSSID in a TIM element, a Partial Virtual Bitmap subfield, or a traffic indication virtual bitmap may be used. When the AP does not belong to a multiple BSSID set, N bits following the first bit (B0) of the TIM element, the Partial Virtual Bitmap subfield, or the traffic indication virtual bitmap may be used to indicate buffered group addressed frames corresponding to other APs included in the multi-link device to which the AP belongs. Each of the N bits is mapped in link ID order, and each of the N bits may indicate whether a group addressed frame is buffered to the link mapped to the bit.

Bits X to X+N−1 of the Partial Virtual Bitmap subfield or the traffic indication virtual bitmap may indicate group addressed frames corresponding to a reporting AP (or an AP corresponding to a transmitted BSSID when the AP belongs to a multiple BSSID set) and other APs in a multi-link device to which the reporting AP belongs. The reporting AP refers to an AP that transmits a TIM element. Additionally, X−1 may be the last bit used to indicate a nontransmitted BSSID in the TIM element, the Partial Virtual Bitmap subfield, or the traffic indication virtual bitmap. When a multiple BSSID set is not used, X-1 may be 0. Also, N may be the N mentioned in the description of the EHT Operation element. Specifically, when an AP transmitting a TIM element does not belong to a multiple BSSID set, X−1 may be 0. In addition, N may be the N mentioned in the description of the EHT Operation element. The value of N may be determined based on a Group Addressed BU Indication Exponent subfield. The value of N may be 2\hat{ }(the value of the Group Addressed BU Indication Exponent subfield+1)−1. That is, when the Group Addressed BU Indication Exponent subfield has a value of 1, the value of N may be 2\hat{ }(1+1)−1. That is, the value of N may be 3. In addition, N bits from bit X to bit X+N−1 may indicate whether group addressed traffic is buffered for each link in ascending order of link ID. The first n bits among the N bits indicate group addressed frames corresponding to other APs in an AP multi-link device to which the AP belongs, and the remaining bits may be set to 0.

The last bit indicating a nontransmitted BSSID in the TIM element, the Partial Virtual Bitmap subfield, or the traffic indication virtual bitmap may be determined based on the theoretical maximum number of BSSIDs in the multiple BSSID set. When the theoretical maximum number of BSSIDs in the multiple BSSID set is 2\hat{ }n, AIDs 1 to (2\hat{ }n−1) may be reserved for AIDs of a nontransmitted BSSID, and the last bit indicating the nontransmitted BSSID in the TIM element, the Partial Virtual Bitmap subfield, or the traffic indication virtual bitmap may correspond to AID (2\hat{ }n−1). Therefore, bits, starting from bits 2\hat{ }n, in the TIM element, the Partial Virtual Bitmap subfield, or the traffic indication virtual bitmap may indicate group addressed frames buffered to other APs in the multi-link device to which an AP (the reporting AP) of the transmitted BSSID belongs.

In another specific embodiment of the present disclosure, the last bit indicating a nontransmitted BSSID in the TIM element, the Partial Virtual Bitmap subfield, or the traffic indication virtual bitmap may be determined based on an actual bit used as the nontransmitted BSSID. When as many nontransmitted BSSIDs as the possible maximum number of BSSIDs in a multiple BSSID set are not actually used, the last bit may be the last bit among bits corresponding nontransmitted BSSIDs actually used in the TIM element, the Partial Virtual Bitmap subfield, or the traffic indication virtual bitmap that corresponds to the nontransmitted BSSID actually used.

In FIG. 20, a part of the traffic indication virtual bitmap is used to configure the Partial Virtual Bitmap subfield. Each bit in the traffic indication virtual bitmap and the Partial Virtual Bitmap subfield indicates whether there is buffered traffic to be transmitted to a station having an AID corresponding to each bit. The bit numbers of bits in the traffic indication virtual bitmap and the Partial Virtual Bitmap subfield may be mapped to AID values. In FIG. 20, the first bit (B0) of the traffic indication virtual bitmap is mapped to a transmitted BSSID. In another specific embodiment, the first bit (B0) of the traffic indication virtual bitmap may be mapped to the reporting AP (the AP that transmits the TIM element). That is, when the reporting AP belongs to the multiple BSSID set, the first bit (B0) of the traffic indication virtual bitmap may be mapped to the reporting AP or the transmitted BSSID. When the reporting AP does not belong to the multiple BSSID set, the first bit (B0) of the traffic indication virtual bitmap is mapped to the reporting AP. The buffered traffic corresponding to the AP may be group addressed traffic.

In the embodiment of FIG. 20, the second bit (B1) to the fourth bit (B3) of the traffic indication virtual bitmap are mapped to the nontransmitted BSSID. In this case, the above-described (X−1) is 3. In addition, the fifth bit (B4) to the seventh bit (B6) of the traffic indication virtual bitmap may correspond to other APs in the AP multi-link device to which the reporting AP or the transmitted BSSID belongs. That is, in this case, the Group Addressed BU Indication Exponent subfield has a value of 1. Therefore, N is 3.

To indicate whether group addressed frames corresponding to other APs in the AP multi-link device to which an AP corresponding to each nontransmitted BSSID belongs have been buffered, the reporting AP may use N bits present after the last bit (i.e., B X+N−1) in the TIM element, the Partial Virtual Bitmap subfield, or the traffic indication virtual bitmap indicating whether group addressed traffic corresponding to other APs in the same AP MLD as an AP corresponding to a transmitted BSSID has been buffered. Specifically, to indicate group addressed frames corresponding to other APs in an AP multi-link device to which an AP corresponding to a k-th nontransmitted BSSID belongs, the reporting AP may use kth N bits following the last bit (i.e., B X+N−1) in the TIM element, the Partial Virtual Bitmap subfield, or the traffic indication virtual bitmap indicating group addressed traffic corresponding to other APs in the AP multi-link device to which an AP corresponding to a transmitted BSSID belongs. The N bits corresponding to each nontransmitted BSSID are mapped to N links in link ID order, and each of the N bits indicates whether a group addressed frame has been buffered to a link corresponding to each bit.

Bits from bit number Y+(k−1)*N to bit number Y+k*N−1 in the reporting Partial Virtual Bitmap subfield or traffic indication virtual bitmap may indicate whether group addressed traffic, corresponding to other APs in the AP multi-link device to which the AP corresponding to the k-th nontransmitted BSSID belongs, has been buffered. The embodiment may be applied only when the bit number is less than a predesignated bit number. The predetermined value may be determined based on a bitmap limit. The predetermined value may be Y+(bitmap limit). Here, k in the k-th nontransmitted BSSID may start from 1. Y−1 may be the last bit that indicates whether a group addressed frame corresponding to the AP multi-link device to which the AP corresponding to the transmitted BSSID belongs has been buffered. That is, Y−1 may be the same value as X+N−1. Additionally, N may be N as described in the embodiment related to the EHT Operation element. N may be determined based on the Group Addressed BU Indication Exponent subfield. N may be 2\hat{ }(the value of the Group Addressed BU Indication Exponent subfield+1)−1. In addition, in the TIM element, the Partial Virtual Bitmap subfield, or the traffic indication virtual bitmap, N bits from bit number Y+(k−1)*N to bit number Y+k*N−1 are mapped to N links in link ID order, and each of the N bits indicates whether a group addressed frame is buffered to a link corresponding to each bit. The first n bits among the N bits may indicate whether group addressed frames, corresponding to other APs in the AP multi-link device to which the AP corresponding to the k-th nontransmitted BSSID belongs, has been buffered, and the remaining bits may be set to 0.

In FIG. 20, Y is 7 and N is 3. Therefore, bits from bit number 7+(k−1)*3 to bit number 7+k*3−1 in the TIM element, the Partial Virtual Bitmap subfield, or the traffic indication virtual bitmap may indicate group addressed frames corresponding to other APs in the AP multi-link device to which the AP corresponding to the k-th nontransmitted BSSID belongs. That is, bits from bit number 7 to bit number 9 in the TIM element, the Partial Virtual Bitmap subfield, or the traffic indication virtual bitmap indicate group addressed frames corresponding to other APs in the AP multi-link device to which an AP corresponding to the first nontransmitted BSSID belongs. In addition, the k-th nontransmitted BSSID may be a nontransmitted BSSID corresponding to AID k.

The traffic indication virtual bitmap and the Partial Virtual Bitmap subfield may include, as parts corresponding to the group addressed frames, a part corresponding to a reporting AP (or a transmitted BSSID when the reporting AP belongs to a multiple BSSID set), a part corresponding to a nontransmitted BSSID (when the reporting AP belongs to the multiple BSSID set), parts corresponding to other APs in an AP multi-link device to which the reporting AP belongs, and (when the reporting AP belongs to the multiple BSSID set) parts corresponding to other APs in the AP multi-link device to which the AP corresponding to the nontransmitted BSSID belongs. In addition, the order in which each part is included in the traffic indication virtual bitmap and the Partial Virtual Bitmap subfield may be the same as the order mentioned.

According to the embodiment illustrated in FIG. 14, the value of the AID Offset subfield may not indicate parts corresponding to a group ID and a group addressed frame in the traffic indication virtual bitmap and the Partial Virtual Bitmap subfield. That is, the value of the AID Offset subfield may indicate a value greater than the maximum values corresponding to the group ID and the group addressed frame in the traffic indication virtual bitmap and Partial Virtual Bitmap subfield. Alternatively, the value of the AID Offset subfield may indicate an individually addressed frame in the traffic indication virtual bitmap and the Partial Virtual Bitmap subfield. Alternatively, the value of the AID Offset subfield may indicate a value that corresponds to a non-AP station or a non-AP multi-link device in the traffic indication virtual bitmap and the Partial Virtual Bitmap subfield.

More specifically, in the embodiment described with reference to FIG. 14, the value of the AID Offset subfield may be determined based on the maximum number of BSSIDs in a multiple BSSID set in order to prevent the value of the AID Offset subfield from indicating parts of the traffic indication virtual bitmap and the Partial Virtual Bitmap subfield, which correspond to group addressed frames. According to the embodiments in FIGS. 19 and 20, the value of the AID Offset subfield may be determined by further considering other factors. This is because more bits in the traffic indication virtual bitmap and the Partial Virtual Bitmap subfield may indicate group addressed frames than the maximum number of BSSIDs that the multiple BSSID set can include.

According to an embodiment of the present disclosure, the range of values that the AID Offset subfield can indicate may be determined based on the number of bits necessary for indicating group addressed frames corresponding to other APs in an AP multi-link device to which an AP corresponding to a transmitted BSSID or a nontransmitted BSSID belongs. For example, the range of values that the AID Offset subfield can indicate may be determined based on the maximum number of BSSIDs that the multiple BSSID set described above can include and the number of bits necessary for indicating group addressed frames corresponding to other APs in the AP multi-link device to which an AP corresponding to a transmitted BSSID or a nontransmitted BSSID belongs. In addition, the range of values that the AID Offset subfield can indicate may be determined based on the maximum number of BSSIDs that a multiplexed BSSID set can include, the number of bits necessary for indicating group addressed frames corresponding to other APs in the AP multi-link device to which an AP corresponding to a transmitted BSSID or a nontransmitted BSSID belongs, and a bitmap limit.

According to an embodiment of the present disclosure, the AID Offset subfield may not be allowed to indicate parts of the traffic indication virtual bitmap and the Partial Virtual Bitmap subfield, which correspond to group addressed frames. Alternatively, the AID Offset subfield may indicate parts of the traffic indication virtual bitmap and the Partial Virtual Bitmap subfield, which do not correspond to group addressed frames.

The parts of the traffic indication virtual bitmap and the Partial Virtual Bitmap subfield, which correspond to group addressed frames, may include a part corresponding to a reporting AP (or a transmitted BSSID when the reporting AP belongs to a multiple BSSID set), a part corresponding to a nontransmitted BSSID (when the reporting AP belongs to the multiple BSSID set), parts corresponding to other APs in the same AP MLD to which the reporting AP belongs, and (when the reporting AP belongs to the multiple BSSID set) parts corresponding to other APs in the AP multi-link device to which an AP corresponding to a nontransmitted BSSID belongs.

That is, the value of the AID Offset subfield may not be allowed to be set to a value that is equal to or less than the smaller of a value obtained by adding N*((the number of nontransmitted BSSIDs or the maximum number of nontransmitted BSSIDs)+1) to (X−1) and a value obtained by adding a bitmap limit to (X−1) (or either of the two values when the two are equal). The value of the AID Offset subfield may be set to a value that is greater than the smaller of a value obtained by adding N*((the number of nontransmitted BSSIDs or the maximum number of nontransmitted BSSIDs)+1) to (X−1) and a value obtained by adding the bitmap limit to (X−1) (either of the two values when the two values are equal). As described above, (X−1) may be the last bit that indicates a group addressed frame for an AP belonging to an AP multi-link device to which the reporting AP or the AP corresponding to the transmitted BSSID belongs. That is, the AID Offset subfield may not be allowed to indicate a value equal to or less than min((X−1)+N*X, X−1+bitmap limit). The value of the AID Offset subfield may be set to a value greater than min((X−1)+N*X, X−1+bitmap limit). Here, the above description of N and the bitmap limit is omitted.

In alternative description of the same content, (the maximum number of BSSIDs that a multiple BSSID set can include) or (the number of BSSIDs in the multiple BSSID set) may be referred to as M. The value of the AID Offset subfield may not be allowed to be set to a value that is equal to or less than the smaller of 1) a value obtained by adding M*N to M−1) and 2) a value obtained by adding N+bitmap limit to M−1. The value of the AID Offset subfield may be set to a value that is greater than the smaller of 1) the value obtained by adding M*N to M−1 and 2) the value obtained by adding N+bitmap limit to M−1. M may be 1 when the reporting AP does not belong to the multiple BSSID set.

In addition, the same content may be explained by distinguishing between the case in which the reporting AP belongs to a multiple BSSID set and the case in which the reporting AP does not. When the reporting AP belongs to the multiple BSSID set, the value of the AID Offset subfield may not be set to a value that is less than or equal to N. In addition, the value of the AID Offset subfield may be set to a value greater than N. When the reporting AP belongs to the multiple BSSID set, the AID Offset may not be allowed to be set to the smaller of a value obtained by adding N*(the number of nontransmitted BSSIDs or the maximum number of nontransmitted BSSIDs) to (X−1) and a value obtained by adding the bitmap limit to (X−1) (either of the two values when the two values are equal). The value of the AID Offset subfield may be set to a value that is greater than the smaller of the value obtained by adding N*(the number of nontransmitted BSSIDs or the maximum number of nontransmitted BSSIDs) to (X−1) and a value obtained by adding the bitmap limit to (X−1) (either of the two values when the two values are equal). Min (A, B) may be the smaller of A and B when A and B have different values, or A=B when A and B are equal.

In the above embodiment, the number of nontransmitted BSSIDs or the number of BSSIDs in the multiple BSSID set may be the number of BSSIDs actually used in the multiple BSSID set. In addition, the maximum number of nontransmitted BSSIDs or the maximum number of BSSIDs that the multiple BSSID set can include may be the maximum number of BSSIDs that the multiple BSSID set can include based on the value of MaxBSSID Indicator.

In the embodiments of FIGS. 19 and 20, an association ID (AID) space may be limited (for a non-AP station or a non-AP MLD). This is because the range of AIDs assigned to group addressed frames has changed in the embodiments of FIGS. 19 and 20. An AID is assigned by an AP to a non-AP station (or a non-AP multi-link device). Additionally, the AID may be transmitted to the non-AP station (or the non-AP multi-link device) in an association response frame or a reassociation response frame.

In the original IEEE 802.11 standard, an AP could assign an AID value of 1 to 2007 to a non-AP station. If the AP belongs to a multiple BSSID set, the AP could not assign an AID value corresponding to a nontransmitted BSSID as an AID to the non-AP station. That is, when the AP belongs to a multiple BSSID set, the AP may not assign a value equal to or less than the maximum number, 1, of BSSIDs in the multiple BSSID set as the AID of the non-AP station. The AP may assign a value from (the maximum number of BSSIDs in the multiple BSSID set) to 2007 as the AID of the non-AP station.

In addition, the EHT standard may not allow an AP to assign an AID of 2007 to a non-AP station. This is because the AID value 2007 is used to direct a Special User Info field included in a trigger frame. That is, when the AP is not part of a multiple BSSID set, the AP may assign an AID to a non-AP station in the range of 1 to 2006. Also, when the multiple BSSID set is used, the AP may assign an AID to the non-AP station in the range from (the maximum number of BSSIDs that the multiple BSSID set can include) to 2006.

Furthermore, according to an embodiment of the present disclosure, the AID space may be limited based on a Group Addressed BU Indication Exponent field value or a bitmap limit.

In a specific embodiment, when an AP does not belong to a multiple BSSID set, the AP may assign an AID to a non-AP station in the range of N+1 to 2006. When the AP belongs to the multiple BSSID set, the AP may not assign numbers up to the lesser of a value obtained by adding N*((the number of nontransmitted BSSIDs or the maximum number of nontransmitted BSSIDs)+1) to (X−1) and a value obtained by adding the bitmap limit to (X−1) (or either of the two values when the two values are equal) as an AID to the non-AP station. That is, the AP may assign an AID to the non-AP station in the range from a value, obtained by adding 1 to the smaller of the value obtained by adding N*((the number of nontransmitted BSSIDs or the maximum number of nontransmitted BSSIDs)+1) to (X−1) and the value obtained by adding the bitmap limit to (X−1) (or either of the two values when the two values are equal), to 2006. Therefore, when the AP belongs to the multiple BSSID set, the AP may assign an AID to the non-AP station in the range of 2\hat{ }(MaxBSSID Indicator)+(2\hat{ }(MaxBSSID Indicator))*(2\hat{ }(the value of the Group Addressed BU Indication Exponent subfield+1)−1) to 2006.

When the AP does not belong to the multiple BSSID set, the AID space may be determined based on the value of the Group Addressed BU Indication Exponent subfield. Also, when the AP belongs to the multiple BSSID set, the AID space may be determined based on the value of the MaxBSSID Indicator subfield and the value of the Group Addressed BU Indication Exponent subfield.

The MaxBSSID Indicator subfield may be included in a Multiple BSSID element or a Reduced Neighbor Report element. The Multiple BSSID element or the Reduced Neighbor Report element may be included in a beacon frame, a probe response frame, an association response frame, and a reassociation response frame.

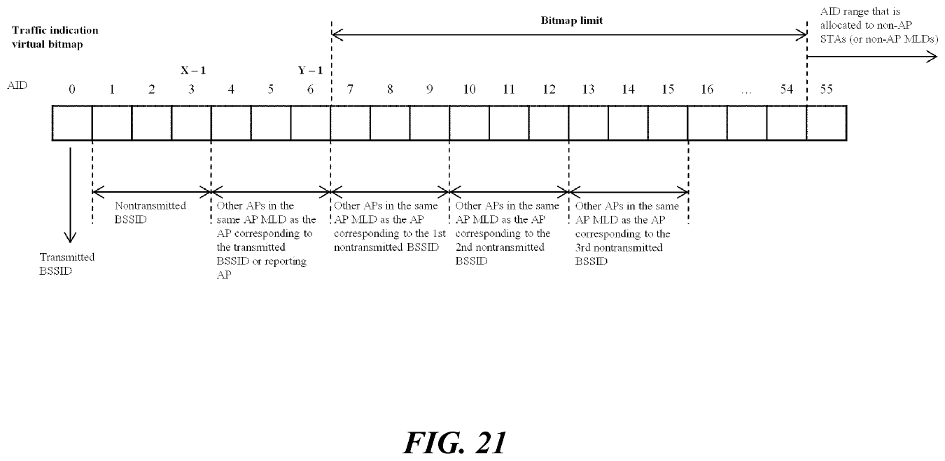

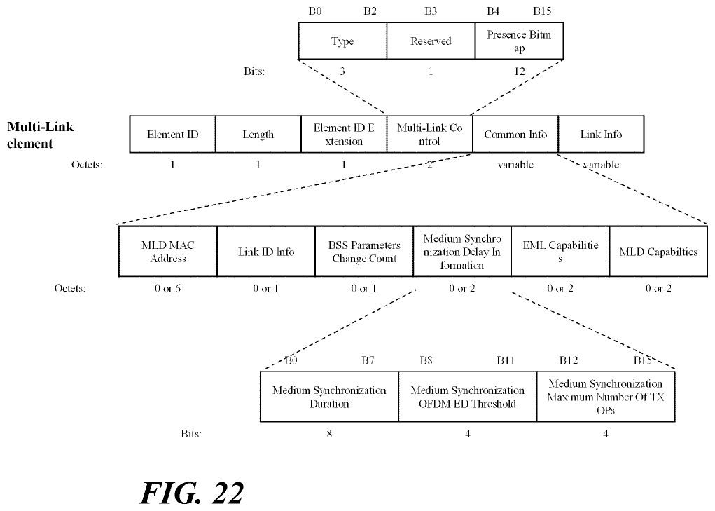

FIG. 21 illustrates a traffic indication virtual bitmap according to an embodiment of the present disclosure.

In another embodiment of the present disclosure, (X−1) in the embodiments described with reference to FIGS. 19 and 20 may be replaced by (Y−1). Specifically, when adding a bitmap limit to (X−1), (X−1) may be replaced by (Y−1). The bitmap limit may be the bit number of the last bit, which can indicate a group addressed frame, among bits in the traffic indication virtual bitmap corresponding to other APs in an AP multi-link device to which an AP corresponding to a transmitted BSSID belongs. Also, (Y−1) in the embodiments described hereinafter may be replaced by (X−1).

As described above, the AP may extract a part of the traffic indication virtual bitmap to generate a Partial Virtual Bitmap subfield. Furthermore, each bit in the traffic indication virtual bitmap or the Partial Virtual Bitmap subfield may indicate whether traffic for a station with an AID is buffered in each bit. The bit numbers of bits in the traffic indication virtual bitmap or the Partial Virtual Bitmap subfield may be mapped to AIDs. The first bit (B0) in the traffic indication virtual bitmap or the Partial Virtual Bitmap subfield may be mapped to a transmitted BSSID. In another specific embodiment, the first bit (B0) in the traffic indication virtual bitmap or the Partial Virtual Bitmap subfield may be mapped to a reporting AP. When the reporting AP belongs to a multiple BSSID set, the first bit (B0) in the traffic indication virtual bitmap is mapped to the reporting AP or the transmitted BSSID. When the reporting AP does not belong to the multiple BSSID set, the first bit (B0) in the traffic indication virtual bitmap is mapped to the reporting AP.

In the embodiment of FIG. 21, the second bit (B1) to the fourth bit B3 in the traffic indication virtual bitmap may be mapped to a nontransmitted BSSID. In this case, the value of (X−1) is 3. In addition, the fifth bit (B4) to the seventh bit (B6) in the traffic indication virtual bitmap may be mapped to other APs in the AP multi-link device to which the reporting AP or the transmitted BSSID belongs. In this case, the value of a Group Addressed BU Indication Exponent subfield may be set to 1. Here, N is 3.

In the embodiment of FIG. 21, Y is 7. In addition, N is 3. Therefore, bits from bit number 7+(k−1)*3 to bit number 7+k*3−1 in the traffic indication virtual bitmap indicate whether a group addressed frame corresponding to other APs in an AP multi-link device to which an AP corresponding to a k-th nontransmitted BSSID belongs is buffered. That is, the eighth bit (B7) to the tenth bit (B9) in the traffic indication virtual bitmap may indicate whether a group addressed frame corresponding to other APs in an AP multi-link device to which an AP corresponding to the first nontransmitted BSSID belongs is buffered. In addition, the k-th nontransmitted BSSID may be a nontransmitted BSSID corresponding to AID k.

The traffic indication virtual bitmap or the Partial Virtual Bitmap subfield may include, parts corresponding to a group addressed frame, a part corresponding to a reporting AP (or a transmitted BSSID when a multiple BSSID set is used), a part corresponding to a nontransmitted BSSID (when the multiple BSSID set is used), parts corresponding to other APs in an AP multi-link device to which the reporting AP belongs, and (when the multiple BSSID set is used) parts corresponding to other APs in an AP multi-link device to which an AP corresponding to the nontransmitted BSSID belongs. In addition, the order in which each part is included in the traffic indication virtual bitmap may be the same as the order mentioned above.

In a specific embodiment, an AID space may be the same as the range of AIDs that an AID Offset subfield can indicate. Also, the range of values that the AP cannot assign as an AID may be the same as the range of AIDs that the AID Offset subfield cannot indicate. In addition, the AID space may be a set of bit numbers of bits in the traffic indication virtual bitmap which may not indicate that a group addressed frame has been buffered. That is, the AID space may not include bit numbers of bits in the traffic indication virtual bitmap which indicate that a group addressed frame has been buffered. AIDs that the AP cannot assign may be a set of bit numbers of bits in the traffic indication virtual bitmap which indicate that a group addressed frame has been buffered.

In the first embodiment of the present disclosure with respect to the AID space, the AID space may be determined based on X or X−1. The AID space may be determined based on the maximum number of nontransmitted BSSIDs. Thus, the AID space may be determined based on the Group Addressed BU Indication Exponent subfield. Specifically, the AID space may be determined based on a value obtained by adding N*((the number of nontransmitted BSSIDs or the maximum number of nontransmitted BSSIDs)+1) to (X−1). For example, the minimum value of the AID space may be 1+the value obtained by adding N*((the number of nontransmitted BSSIDs or the maximum number of nontransmitted BSSIDs)+1) to (X−1). Also, the maximum value of the AID space may be 2006. (X−1) may be the bit number of the last bit used to indicate a nontransmitted BSSID in the TIM element, the Partial Virtual Bitmap subfield, or the traffic indication virtual bitmap. When a reporting AP does not belong to a multiple BSSID set, X−1 is 0. When the reporting AP belongs to the multiple BSSID set, (X−1) is (2\hat{ }(the value of MaxBSSID Indicator)−1). The MaxBSSID Indicator value may indicate the maximum number of BSSIDs in the multiple BSSID set. The maximum number of BSSIDs in the multiple BSSID set is 2\hat{ }(the value of the MaxBSSID Indicator).

In another specific embodiment, the minimum value of the AID space may be a value obtained by adding N*X+1 to (X−1). When a reporting AP does not belong to a multiple BSSID set, the minimum value of the AID space may be N+1. When the reporting AP belongs to the multiple BSSID set, the minimum value of the AID space may be 1+the value obtained by adding N*((the number of nontransmitted BSSIDs or the maximum number of nontransmitted BSSIDs)+1) to (X−1). That is, when the AP belongs to the multiple BSSID set, the minimum value of the AID space may be (2\hat{ }(MaxBSSID Indicator value)−1)+(2\hat{ }(MaxBSSID Indicator value))*(2\hat{ }(Group Addressed BU Indication Exponent subfield value+1)−1)+1. When the AP belongs to the multiple BSSID set, the minimum value of the AID space may be 2\hat{ }((MaxBSSID Indicator value)+(Group Addressed BU Indication Exponent subfield value+1)).

In the second embodiment of the present disclosure regarding an AID space, the AID space may be determined based on a bitmap limit. The bitmap limit may be 48 bits. The AID space may be determined based on Y and the bitmap limit. Specifically, the AID space may be determined based on Y−1 and the bitmap limit. Specifically, the AID space may be determined based on a value obtained by summing Y−1 and the bitmap limit. In a specific embodiment, the minimum value of the AID space may be a value obtained by adding 1+the value obtained by adding a bitmap limit value to (Y−1).

As described above, Y may be replaced by X. Therefore, the AID space may be determined based on X and a bitmap limit. Specifically, the AID space may be determined based on X−1 and the bitmap limit. Specifically, the AID space can be determined based on a value obtained by summing X−1 and the bitmap limit. In a specific embodiment, the minimum value of the AID space may be a value obtained by adding 1 to the sum of (X−1) and the bitmap limit.

(Y−1) may be the last bit in the traffic indication virtual bitmap, which indicates a group addressed frame of an AP multi-link device to which an AP corresponding to a transmitted BSSID belongs. That is, Y−1 may be the same value as X+N−1. Also, N is N as described in the above embodiment related to the EHT Operation element. N may be determined based on the value of the Group Addressed BU Indication Exponent subfield. N may be 2\hat{ }(the value of a Group Addressed BU Indication Exponent subfield+1)−1. N may be a value obtained by subtracting 1 from the number of bits in the traffic indication virtual bitmap that indicate a group addressed frame for one multi-link device. Alternatively, N may be the number of bits indicating a group addressed frame for other APs in a multi-link device to which a reporting AP or an AP corresponding to a transmitted BSSID or a nontransmitted BSSID belongs. When the reporting AP does not belong to a multiple BSSID set, Y−1 may be N. When the reporting AP belongs to the multiple BSSID set, Y−1 may be X−1+N. That is, when the reporting AP belongs to the multiple BSSID set, Y−1 may be ((the maximum number of BSSIDs in the multiple BSSID set)−1)+N.

An AP may not be allowed to assign, to a non-AP station or a non-AP multi-link device, AIDs that correspond to as many bits as the bit limit after bit number (Y−1) in traffic indication virtual bitmap. That is, the AP may assign a value greater than (Y−1)+(bitmap limit) to the non-AP station or the non-AP multi-link device. That is, in the embodiment of FIG. 20, the AP may assign an AID of the non-AP station or the non-AP multi-link device a value greater than 6+48, i.e., a value of 55 or greater.

When the bit limit is 48, and when a reporting AP does not belong to a multiple BSSID set, an AID value that the reporting AP can assign may be equal to or greater than (N+1). Also, when the AP belongs to the multiple BSSID set, an AID value that the AP can assign may be equal to or greater than (Y+48).

In the third embodiment of the present disclosure regarding an AID space, the AID space may be determined based on the first and second embodiments. The AID space may be determined based on X, N, Y, the number of nontransmitted BSSIDs (or the maximum number of nontransmitted BSSIDs), and a bitmap limit. The minimum value of the AID space may be a value obtained by adding 1 to the smaller of a value obtained by adding N*((the number of nontransmitted BSSIDs or the maximum number of nontransmitted BSSIDs)+1) to (X−1) and a value obtained by adding a bitmap limit to (Y−1). The minimum value of the AID space may be min((X−1)+N*X, Y−1+bitmap limit)+1. In other words, the minimum value of the AID space may be min(X+N*X, Y+bitmap limit).

When a reporting AP does not belong to a multiple BSSID set, the minimum value of the AID space may be N+1. When the reporting AP belongs to the multiple BSSID set, the minimum value of the AID space may be the smaller of N+1 and Y+bitmap limit. When the reporting AP belongs to the multiple BSSID set, the minimum value of the AID space may be a value obtained by adding 1 to the smaller of the value obtained by adding N*((the number of nontransmitted BSSIDs or the maximum number of nontransmitted BSSIDs)+1) to (X−1) and the value obtained by adding the bitmap limit to (Y−1). That is, when the reporting AP belongs to the multiple BSSID set, the minimum value of the AID space may be min(X+N*X, Y+bitmap limit). This may be expressed as follows. When the reporting AP belongs to the multiple BSSID set, the minimum value of the AID space may be min((a), (b)).

(a) (2\hat{ }(MaxBSSID Indicator value) 1)+(2\hat{ }(MaxBSSID Indicator value))*(2\hat{ }(Group Addressed BU Indication Exponent subfield value+1)−1)+1

(b) (Y−1)+(bitmap limit)+1=2\hat{ }(MaxBSSID Indicator value)−1+2\hat{ }(Group Addressed BU Indication Exponent subfield value+1)−1+(bitmap limit)+1=2\hat{ }(MaxBSSID Indicator value)+2\hat{ }(Group Addressed BU Indication Exponent subfield value+1)−1+(bitmap limit)

When the bitmap limit is 48 and when the reporting AP does not belong to the multiple BSSID set, the minimum value of the AID space is N+1. When the bitmap limit is 48 and when the reporting AP belongs to the multiple BSSID set, the minimum value of the AID space may be min(Y+48, Y+N*(the number of nontransmitted BSSIDs or the maximum number of nontransmitted BSSIDs)).

When the reporting AP does not belong to the multiple BSSID set, it is possible to apply 0 to the value of the MaxBSSID Indicator and 0 to the number of nontransmitted BSSIDs or the maximum number of nontransmitted BSSIDs in the formula that is applied when the reporting AP belongs to the multiple BSSID set. In the above-described embodiment, the number of nontransmitted BSSIDs or the number of BSSIDs in the multiple BSSID set may represent the number of BSSIDs actually used in the multiple BSSID set. Furthermore, the maximum number of nontransmitted BSSIDs or the maximum number of BSSIDs that the multiple BSSID set can have may be determined based on the value of the MaxBSSID Indicator. The non-AP station may obtain the number of nontransmitted BSSIDs from a Multiple BSSID element. In another specific embodiment, the non-AP station may obtain the number of nontransmitted BSSIDs from an element or a frame that indicates the maximum number of BSSIDs in the multiple BSSID set.

In addition, the bitmap limit may be a predetermined value. For example, the bitmap limit may be 48.

In the above-described embodiments, the multiple BSSID or multiple BSSID set may be replaced by a co-located BSSID or co-located BSSID set (co-located BSSID list). In addition, the co-located BSSID may be the BSSID of a reporting BSS or the BSSID of a BSS that is physically co-located with a reporting AP. The co-located BSSID may be a BSSID that corresponds to the same physical device as the reporting BSS or the reporting AP.

In the first embodiment of the AID space of the present disclosure, there is an advantage that when the number of BSSIDs in the multiple BSSID set is small or when N is small, the number of bits indicating group addressed frames in the traffic indication virtual bitmap is small and the AID space is wide. However, there is a disadvantage that when the number of BSSIDs in the multiple BSSID set is large or when N is large, the number of bits in the traffic indication virtual bitmap, which indicate group addressed frames, becomes large and the AID space is narrow. The feature wherein the AID space is wide or narrow may imply that the number of stations or multi-link devices that can be associated may be large or small. Furthermore, the first embodiment of the present disclosure regarding the AID space may have the advantage of being simpler in calculation or implementation than the third embodiment of the present disclosure regarding the AID space.

In the second embodiment of the present disclosure regarding the AID space, there is an advantage that even when the number of BSSIDs in the multiple BSSID set is large or N is large, the number of bits used to indicate group addressed frames in the traffic indication virtual bitmap is limited, and the AID space is wide. However, there is a disadvantage that even when the number of BSSIDs in the multiple BSSID set is small or N is small, the AID space may be somewhat limited. Thus, there may be AID values that are neither used as AIDs nor used to indicated group addressed frames. Furthermore, the second embodiment of the present disclosure regarding the AID space may have the advantage of being simpler in calculation or implementation than the third embodiment of the present disclosure the AID space.

The third embodiment of the present disclosure regarding the AID space may have the advantage of combining the advantages of the first and second embodiments and reducing the disadvantages. However, the third embodiment of the present disclosure regarding the AID space may have the disadvantage of being complex in calculation or implementation compared to the first or second embodiment.

A method for a multi-link setup will be described with reference to FIGS. 22 to 26. First, a Multi-Link element will be with reference to FIG. 22.

FIG. 22 illustrates signaling related to MediumSyncDelay and a Multi-Link element according to an embodiment of the present disclosure.

A multi-link device may use a multi-link element to perform multi-link discovery and multi-link setup. In this case, the multi-link element may be included in a management frame. Specifically, the multi-link element may be included in at least one among a beacon frame, a probe request frame, a probe response frame, an authentication frame, an association request frame, an association response frame, a reassociation request frame, and a reassociation response frame.

The Multi-Link element may include an Element ID subfield, a Length subfield, an Element ID Extension subfield, a Multi-Link Control subfield, a Common Info subfield, and a Link Info subfield. The Element ID subfield or Element ID Extension subfield may indicate the ID of the element including the Element ID subfield or the Element ID Extension subfield above. The Length subfield may indicate the length of the element including the Length subfield. The Multi-Link Control subfield may include a Type subfield and a Presence Bitmap subfield. The Type subfield may indicate what type the Multi-Link element is. In addition, the format of the Multi-Link element may be determined based on what type the Multi-Link element is. The Presence Bitmap subfield may indicate whether subfields that can be included in the Multi-Link element have been included. For example, the Presence Bitmap subfield may indicate whether subfields that can be included in the Common Info subfield included in the Multi-Link element have been included. The subfields of which the inclusion and non-inclusion is indicated by the Presence Bitmap may include a multi-link device MAC address subfield, a Link ID Info subfield, a BSS Parameters Change Count subfield, a Medium Synchronization Delay Information subfield, an EML Capabilities subfield, and an MLD Capabilities subfield. In addition, the Medium Synchronization Delay Information subfield may include information related to MediumSyncDelay.

The Common Info subfield may include information about multiple links or all links. The Common Info subfield may include information that is commonly required for or commonly applicable to multiple links or all link. The Link Info subfield may include information about a link that corresponds to the Link Info subfield.

The information related to MediumSyncDelay may indicate a value to be set as the duration of the MediumSyncDelay and may have a default value. Under certain circumstances, a multi-link device may reset the duration of MediumSyncDelay to the default value. In addition, when a multi-link device (a non-AP multi-link device) does not receive information related to MediumSyncDelay from a peer multi-link device (an AP multi-link device), the multi-link device may set the duration of MediumSyncDelay to the default value. When the multi-link device (the non-AP multi-link device) receives information related to MediumSyncDelay from the peer multi-link device (the AP multi-link device), the multi-link device may set the duration of the MediumSyncDelay to a value indicated by the received information related to MediumSyncDelay.

In FIG. 22, the Medium Synchronization Delay Information subfield may include a Medium Synchronization Duration subfield, a Medium Synchronization OFDM ED Threshold subfield, and a Medium Synchronization Maximum Number Of TXOPs subfield.

The Medium Synchronization Duration subfield may indicate MediumSyncDelay. That is, the Medium Synchronization Duration subfield may indicate a value for setting a MediumSyncDelay timer. For example, the Medium Synchronization Duration subfield may be an 8-bit field. In addition, the Medium Synchronization Duration subfield may indicate a duration in units of 32 us. That is, when the Medium Synchronization Duration subfield is set to A, the time indicated by the Medium Synchronization Duration subfield may be A*32 us.

The Medium Synchronization OFDM ED Threshold subfield may indicate a CCA threshold value when MediumSyncDelay is applied. The CCA threshold value indicated by the Medium Synchronization OFDM ED Threshold subfield may be a CCA ED threshold value. That is, the Medium Synchronization OFDM ED Threshold subfield may indicate dot11MSDOFDMEDthreshold. The Medium Synchronization OFDM ED Threshold subfield may be a 4-bit field. The CCA threshold value indicated by the Medium Synchronization OFDM ED Threshold subfield may be a value obtained by adding −72 to the value of the Medium Synchronization OFDM ED Threshold subfield. The unit of the CCA threshold value may be dBm. Therefore, when the value of the Medium Synchronization OFDM ED Threshold subfield is 0 or greater, the CCA threshold value indicated by the Medium Synchronization OFDM ED Threshold subfield may be a value of −72 dBm or greater. In addition, the maximum value of the CCA threshold value indicated by the Medium Synchronization OFDM ED Threshold subfield may be −62 dBm. In this case, the value of the Medium Synchronization OFDM ED Threshold subfield may be set within the range of 0 to 10. In this case, values 11 to 15 may be reserved for the Medium Synchronization OFDM ED Threshold subfield. In other words, when the value of the Medium Synchronization OFDM ED Threshold subfield is set to 0 to 10, the Medium Synchronization OFDM ED Threshold subfield may indicate that the CCA threshold value is between−72 dBm and −62 dBm. In other words, when the value of the Medium Synchronization OFDM ED Threshold subfield is x, the Medium Synchronization OFDM ED Threshold subfield may indicate that the CCA threshold value is (x−72 dBM).

The Medium Synchronization Maximum Number Of TXOPs subfield may indicate MSD TXOP MAX. That is, the Medium Synchronization Maximum Number Of TXOPs subfield may indicate the maximum number of transmission attempts a station can make while MediumSyncDelay is applied. The Medium Synchronization Maximum Number Of TXOPs subfield can be a 4-bit field. In a specific embodiment, the value of the Medium Synchronization Maximum Number Of TXOPs subfield may be MSD TXOP MAX. In another specific embodiment, the value of the Medium Synchronization Maximum Number Of TXOPs subfield may be (MSD TXOP MAX+1). In another specific embodiment, the value of the Medium Synchronization Maximum Number Of TXOPs subfield may be (MSD TXOP MAX−1). These embodiments may be applied when the value of the Medium Synchronization Maximum Number Of TXOPs subfield is not set to the maximum value. When the value of the Medium Synchronization Maximum Number Of TXOPs subfield is set to the maximum value, for example, 15 if the Medium Synchronization Maximum Number Of TXOPs subfield is a 4-bit field, the Medium Synchronization Maximum Number Of TXOPs subfield may indicate that the station is allowed to attempt transmission without any limitation on the number of transmission attempts while the MediumSyncDelay is in effect.

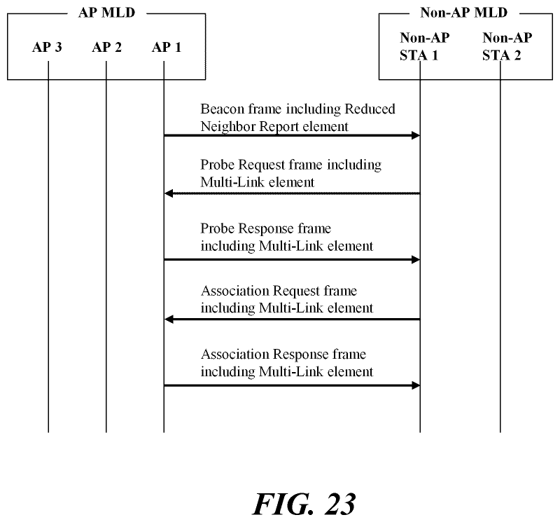

FIG. 23 illustrates a multi-link setup process according to an embodiment of the present disclosure.

In FIG. 23, an AP multi-link device includes a first AP (AP 1), a second AP (AP 2), and a third AP (AP 3). A non-AP multi-link device (non-AP MLD) includes a first non-AP station (STA 1), a second non-AP station (STA 2), and a third non-AP station (STA 3). The first AP (AP 1) and the first non-AP station (STA 1) operate in a first link (link 1). In addition, the second AP (AP 2) and the second non-AP station (STA 2) operate in a second link (link 2). Additionally, the third AP (AP 3) operates in a third link (link 3).

The first AP (AP 1) may transmit a Reduced Neighbor Report element to signal the presence of the AP Multi-Link Device (AP MLD) and parameters related to the AP MLD. The Reduced Neighbor Report element transmitted by the first AP (AP 1) may include information about the second AP (AP 2) or the third AP (AP 3). The Reduced Neighbor Report element may be included in a beacon frame or a probe response frame.

Furthermore, the first non-AP station (STA 1) having received a frame including the Reduced Neighbor Report element may recognize an AP or AP multi-link device indicated by the Reduced Neighbor Report element. The first non-AP station (STA 1) may transmit a probe request frame including a Multi-Link element to the first AP (AP 1) to make a request to the first AP (AP 1) for information regarding the AP multi-link device (AP MLD) or multiple links in which the AP MLD is operating. The Multi-Link element may include information about the non-AP multi-link device or information about APs that the non-AP multi-link device includes.

The first AP (AP 1) may transmit a probe response frame to the non-AP station (STA 1) in response to the probe request frame. The probe response frame may include a Multi-Link element. The Multi-Link element may include information about the AP multi-link device or information about APs that the AP multi-link device (AP MLD) includes. Specifically, the Multi-Link element may include information requested by the first non-AP station (STA 1).

The first non-AP station (STA 1) may transmit an association request frame or a reassociation request frame to the first AP (AP 1). The association request frame and the reassociation request frame may include a Multi-Link element. The Multi-Link element may include information about links in which the non-AP multi-link device wants to perform a multi-link setup. For example, in FIG. 22, the Multi-Link element may include information about the first link (link 1) and the second link (link 2).

The first AP (AP 1) may transmit an association response frame or a reassociation response frame to the first non-AP station (STA 1). The association response frame and the reassociation response frame may include a Multi-Link element. The Multi-Link element may include information about links in which a multi-link setup is performed. The links in which the multi-link setup is performed may be determined based on the links in which the non-AP multi-link device wants to perform the multi-link setup. In FIG. 22, the Multi-Link element may include information regarding the first link (link 1) and the second link (link 2) in which the first non-AP station (STA 1) wants to perform the multi-link setup.

When the association response frame or the reassociation response frame is successfully transmitted, multi-link setup for the links indicated by the Multi-Link element included in the association response frame or reassociation response frame may be considered to have been successfully performed.

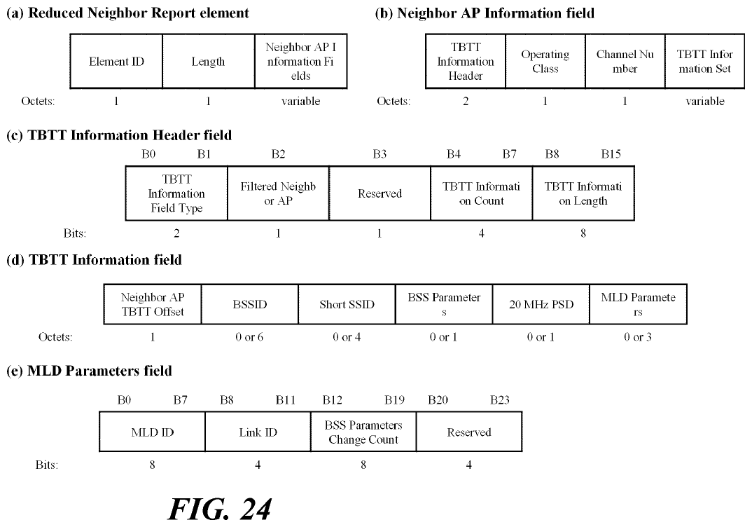

FIG. 24 illustrates the format of a Reduced Neighbor Report element according to an embodiment of the present disclosure.

An additional description will be made of the Reduced Neighbor Report element described in FIG. 23.

A station or an AP that transmits an element is referred to as a reporting station and a reporting AP. In addition, a station or an AP indicated by the element is referred to as a reported station or a reported AP. A station or an AP that transmits a Reduced Neighbor Report element or a Multi-Link element is referred to as a reporting station and a reporting AP. A station or an AP indicated by the Reduced Neighbor Report element or the Multi-Link element is referred to as a reported station and a reported AP.

Referring to (a) of FIG. 24, a Reduced Neighbor Report element may include an Element ID subfield, a Length subfield, and one or more Neighbor AP Information subfields. The Element ID subfield may indicate the ID of the element. The Element ID subfield of the Reduced Neighbor Report element may indicate the ID of the Reduced Neighbor Report element. The Length subfield may indicate the size of the Reduced Neighbor Report element. For example, the Length subfield may indicate the length of the Reduced Neighbor Report element excluding the Element ID subfield and the Length subfield. That is, in the embodiment of (a) of FIG. 24, the Length subfield may indicate the length of the Neighbor AP Information subfield.

Each of the one or more Neighbor AP Information fields included in the Reduced Neighbor Report element may be the same as the Neighbor AP Information subfield shown in (b) of FIG. 24. The Neighbor AP Information subfield may include a TBTT Information Header subfield, an Operating Class subfield, a Channel Number subfield, and a TBTT Information Set subfield.

The TBTT Information Header subfield may be a 2-octet field. Furthermore, the format of the TBTT Information Header subfield may be as shown in (c) of FIG. 24. The TBTT Information Header subfield may include a TBTT Information Field Type subfield, a Filtered Neighbor AP subfield, a Reserved subfield, a TBTT Information Count subfield, and a TBTT Information Length subfield. The TBTT Information Field Type subfield may be a 2-bit field, the Filtered Neighbor AP subfield may be a 1-bit field, the Reserved subfield may be a 1-bit field, the TBTT Information Count subfield may be a 4-bit field, and the TBTT Information Length subfield may be an 8-bit field.

The TBTT Information Field Type subfield identifies a TBTT Information subfield together with the TBTT Information Length subfield. The value of the TBTT Information Field Type subfield is set to 0, and 1, 2, and 3 among TBTT Information Field Type subfield values may be reserved values.

When the Filtered Neighbor AP subfield is not included in a probe response frame transmitted by a TVHT AP, the Filtered Neighbor AP subfield is configured as a reserved field. is reserved except when the Reduced Neighbor Report element is carried in a Probe Response frame transmitted by a TVHT AP. When the Filtered Neighbor AP subfield is included in the probe response frame transmitted by the TVHT AP and when all BSSs of an AP in the Filtered Neighbor AP subfield correspond to a specific SSID, the value of the Filtered Neighbor AP subfield may be set to 1. Otherwise, the value of the Filtered Neighbor AP subfield may be set to 0.

The TBTT Information Count subfield may indicate the number of TBTT Information subfields included in the Neighbor AP Information subfield that includes the TBTT Information Count subfield. For example, the TBTT Information Count subfield may be set to a value obtained by subtracting 1 from the number of TBTT Information subfields included in the Neighbor AP Information subfield that includes the TBTT Information Count subfield.

The TBTT Information Length subfield may indicate the length of each TBTT Information subfield included in the Neighbor AP Information subfield that includes the TBTT Information Length subfield. In addition, the TBTT Information Length subfield may indicate the configuration of each TBTT Information subfield included in the Neighbor AP Information subfield that includes the TBTT Information Length subfield. In this case, the TBTT Information Length subfield may indicate the length and configuration of each TBTT Information subfield.

The TBTT Information Set subfield may include one or more TBTT Information subfields.

The TBTT Information subfields may be as shown in (d) of FIG. 24. The TBTT Information subfields may each include a Neighbor AP TBTT Offset subfield, a BSSID subfield, a Short SSID subfield, a BSS Parameters subfield, a 20 MHz PSD subfield, and an MLD Parameters subfield. The size of each subfield may be as shown in (d) of FIG. 24. The subfields included in the TBTT Information subfield may optionally be included.

The Neighbor AP TBTT Offset subfield may indicate an offset in which the interval between the immediately preceding TBTT and the next TBTT of an AP transmitting the Reduced Neighbor Report element has been rounded down. When the value of the Neighbor AP TBTT Offset subfield is 254, the Neighbor AP TBTT Offset subfield may indicate that the offset is 254 TUs or greater. When the value of the Neighbor AP TBTT Offset subfield is 255, the Neighbor AP TBTT Offset subfield may indicate that the offset value is unknown.

The BSSID subfield may indicate a BSSID.

The Short SSID subfield may indicate an SSID. Specifically, the Short SSID subfield may indicate abbreviated SSID information.

The BSS Parameters subfield may indicate information about a BSS. The information about the BSS may include information about BBS operating.

The 20 MHz PSD subfield may indicate the maximum transmission power for a default category on a 20 MHz main channel. The 20 MHz PSD subfield may indicate the maximum transmission power in dBm/MHz units. The value of the 20 MHz PSD subfield is a signed integer, and the value of −128 in the 20 MHz PSD subfield is a reserve value. A value of 127 in the 20 MHz PSD subfield may indicate that there is no limit to the maximum transmission power for the default category. Also, when the value Y of the 20 MHz PSD subfield is between−127 and 126, the 20 MHz PSD subfield may indicate that the maximum transmission power for the default category on the MHz main channel is Y/2 dBM/MHz.

The TBTT Information field configuration indicated by the value of the TBTT Information Length subfield may be as follows. When the value of the TBTT Information Length subfield is 1, the TBTT Information subfield may include a Neighbor AP TBTT Offset subfield. When the value of the TBTT Information Length subfield is 2, the TBTT Information subfield may include a Neighbor AP TBTT Offset subfield and a BSS Parameters subfield. When the value of the TBTT Information Length subfield is 4, the TBTT Information subfield may include a Neighbor AP TBTT Offset subfield and an MLD Parameters subfield. When the value of the TBTT Information Length subfield is 5, the TBTT Information subfield may include a Neighbor AP TBTT Offset subfield and a Short SSID subfield. When the value of the TBTT Information Length subfield is 6, the TBTT Information subfield may include a Neighbor AP TBTT Offset subfield, a Short SSID subfield, and a BSS Parameters subfield. When the value of the TBTT Information Length subfield is 7, the TBTT Information subfield may include a Neighbor AP TBTT Offset subfield and a BSSID subfield. When the value of the TBTT Information Length subfield is 8, the TBTT Information subfield may include a Neighbor AP TBTT Offset subfield, a BSSID subfield, and a BSS Parameters subfield. When the value of the TBTT Information Length subfield is 9, the TBTT Information subfield may include a Neighbor AP TBTT Offset subfield, a BSSID subfield, a BSS Parameters subfield, and a 20 MHz PSD subfield. When the value of the TBTT Information Length subfield is 10, the TBTT Information subfield may include a Neighbor AP TBTT Offset subfield, a BSSID subfield, and an MLD Parameter subfield. When the value of the TBTT Information Length subfield is 11, the TBTT Information subfield may include a Neighbor AP TBTT Offset subfield, a BSSID subfield, and a Short SSID subfield. When the value of the TBTT Information Length subfield is 12, the TBTT Information subfield may include a Neighbor AP TBTT Offset subfield, a BSSID subfield, a Short SSID subfield, and a BSS Parameters subfield. When the value of the TBTT Information Length subfield is 13, the TBTT Information subfield may include a Neighbor AP TBTT Offset subfield, a BSSID subfield, a Short SSID subfield, a BSS Parameters subfield, and a 20 MHz PSD subfield. When the value of the TBTT Information Length subfield is 16, the TBTT Information subfield may include a Neighbor AP TBTT Offset subfield, a BSSID subfield, a Short SSID subfield, a BSS Parameters subfield, a 20 MHz PSD subfield, and an MLD Parameters subfield. When the value of the TBTT Information Length subfield is 17 or greater, the TBTT Information subfield may include a Neighbor AP TBTT Offset subfield, a BSSID subfield, a Short SSID subfield, a BSS Parameters subfield, a 20 MHz PSD subfield, and an MLD Parameters subfield in the preceding 16-octets. The remaining subfields of the TBTT Information subfield that has not been described above may be designated as reserved fields. That is, the MLD Parameters subfield may be included when the TBTT Information Length subfield has a value of 4, 10, 16, or 17 or greater.

The MLD Parameters subfield may be as shown in FIG. 24E. The MLD Parameters subfield may include an MLD ID subfield, a Link ID subfield, a BSS Parameters Change Count subfield, and a Reserved subfield. The MLD ID subfield may be an 8-bit field. The Link ID subfield may be a 4-bit field. The BSS Parameters Change Count subfield may be 8 bits. In addition, the Reserved subfield may be a 4-bit field.

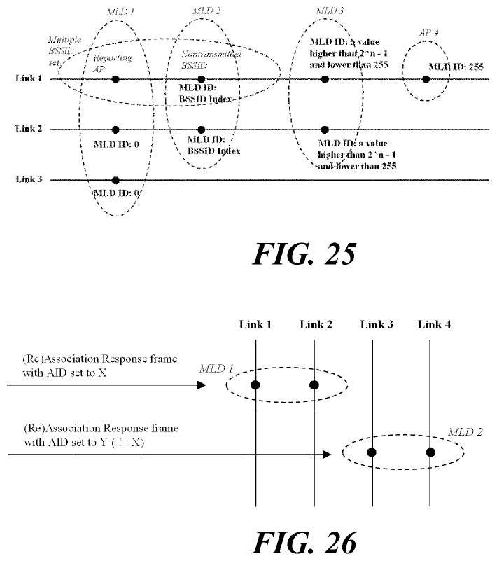

The MLD ID subfield may indicate the ID of a multi-link device, for example, an AP multi-link device. The MLD subfield may indicate the ID of a multi-link device corresponding to the TBTT Information subfield including the MLD ID subfield. A method for specific configuration of the MLD ID subfield may be as shown in FIG. 25.

The Link ID subfield may indicate the ID of a link corresponding to a reported AP. When the reported AP does not belong to a multi-link device or when the reported AP does not have relevant information, the ID of the link may be set to 15.

The BSS Parameters Change Count subfield may indicate a value that increases when a significant update has occurred to the reported AP's beacon frame. The value of the BSS Parameters Change Count subfield may be reset to 0. The value of the BSS Parameters Change Count subfield may be increased by 1 when a significant update occurs in an AP or a BSS corresponding to the BSS Parameters Change Count subfield. The significant update may include updating predesignated parameters. The predesignated parameters may include an operation parameter. When the reported AP does not belong to a multi-link device or when a reporting AP does not have information about the multi-link device to which the reported AP belongs, the value of the BSS Parameters Change Count subfield may be set to 255.

FIG. 25 illustrates a method for configuring an ID of a multi-link device according to an embodiment of the present disclosure.

The ID of a multi-link device may be a value indicated by the MLD ID subfield illustrated in FIG. 24. Furthermore, the MLD ID subfield may be 8 bits. The MLD ID subfield may represent a value ranging from 0 to 255. In an embodiment of the present disclosure, a reporting AP may represent an AP that configures and transmits the MLD ID subfield. In addition, a reported AP may represent an AP indicated by the MLD ID subfield or a TBTT Information subfield including the MLD ID subfield.

According to an embodiment of the present disclosure, the MLD ID subfield may be set as follows. The MLD ID subfield may indicate the ID of an AP multi-link device to which the reported AP belongs. When the reported AP belongs to an AP multi-link device to which the reporting AP belongs, the MLD ID subfield may be set to 0. When the reported AP belongs to a multi-link device set with a nontransmitted BSSID that belongs to a multiple BSSID set to which the reported AP belongs, the value of the MLD ID subfield may be set to the same value as the value of a BSSID Index field of a Multiple BSSID-Index element of a nontransmitted BSSID profile corresponding to the nontransmitted BSSID. When the reported AP is part of another AP multi-link device, and when a frame including the MLD ID subfield does not include a Multiple BSSID element, the value of the MLD ID subfield may be set to a value greater than 0 and less than 255. In addition, when the reported AP is part of another AP multi-link device and when the frame including the MLD ID subfield includes a Multiple BSSID element, the value of the MLD ID subfield may be set to a value greater than 2\hat{ }n−1 and less than 255. Here, n is the value of a MaxBSSID Indicator subfield of the Multiple BSSID element. When the reported AP is not part of a multi-link device or when the reporting AP does not have information about the multi-link device to which the reported AP belongs, the value of the MLD ID subfield may be set to 255. That is, when the reported AP belongs to a multi-link device to which the reporting AP belongs, the value of the MLD ID subfield may be set to 0. Specifically, when the reported AP is not part of a multi-link device or when the reporting AP has no information about whether the reported AP belongs to the multi-link device, the value of the MLD ID subfield may be set to 255. That is, when the reported AP belongs to a multi-link device to which the reporting AP belongs, the value of the MLD ID subfield may be set to 0.

In the embodiment of FIG. 25, the reporting AP operates in a first link (link 1). The reporting AP belongs to a first multi-link device, and the reporting AP transmits a Reduced Neighbor Report element and an MLD ID subfield. Furthermore, the first multi-link device (MLD 1) operates in the first link (link 1), a second link (link 2), and a third link (link 3). At this time, the reporting AP sets the value of an MLD ID subfield corresponding to an AP operating in each of the second link (link 2) and the third link (link 3) to 0.

In addition, the Reporting AP may transmit a multiple BSSID element together with a Reduced Neighbor Report element. In another specific embodiment, the reporting AP may not transmit a multiple BSSID element. In this case, the reporting AP may transmit the multiple BSSID element when the reporting AP belongs to a multiple BSSID set. Also, the reporting AP may not transmit the multiple BSSID element when the reporting AP does not belong to the multiple BSSID set.

According to an embodiment of the present disclosure, when the reported AP is included in a multiple BSSID set to which the reporting AP belongs, the value of the MLD ID subfield may be set to a BSSID index of the multiple BSSID set. Also, when the reported AP belongs to a multi-link device that includes an AP belonging to a multiple BSSID set to which the reporting AP belongs, the value of the MLD ID subfield may be set to the BSSID index of the AP belonging to the multiple BSSID set. When the reported AP belongs to a multi-link device that includes an AP with a nontransmitted BSSID that belongs to the multiple BSSID set to which the reporting AP belongs, the value of the MLD ID subfield may be set to the BSSID index of the reported AP.

The multiple BSSID set to which the reporting AP belongs may include APs operating in the first link (link 1) and belonging to a second multi-link device (MLD 2). The second multi-link device (MLD 2) may include an AP operating in the first link (link 1) and an AP operating on the second link (link 2). The reporting AP may set, to the BSSID index of the reported AP, the value of the MLD ID subfield corresponding to the AP of the second multi-link device (MLD 2) operating in the first link (link 1) and the AP of the second multi-link device (MLD 2) operating in the second link (link 2). This is because the AP of the second multi-link device (MLD 2) operating in the first link (link 1) and the AP of the second multi-link device (MLD 2) operating in the second link (link 2) belong to the same multiple BSSID set as the reporting AP or belong to a multi-link device included in the multiple BSSID set to which the reporting AP belongs.

In the case in which the reporting AP transmits a multiple BSSID element, the value of the MLD ID subfield may be set to a value greater than (2\hat{ }n−1) and less than a predetermined value, provided that the reported AP does not belong to the multi-link device to which the reporting AP belongs, that the reported AP does not belong to a multiple BSSIDs to which the reporting AP belongs, and that the reported AP does not belong to a multi-link device that includes an AP in the multiple BSSID set to which the reporting AP belongs.

In addition, in the case in which the reporting AP transmits a multiple BSSID element, the value of the MLD ID subfield may be set to a value greater than (2\hat{ }n−1) and less than a predetermined value, provided that the reported AP does not belong to the multi-link device to which the reporting AP belongs, that the reported AP does not belong to a multiple BSSIDs to which the reporting AP belongs, and that the reported AP does not belong to a multi-link device that includes an AP in the multiple BSSID set to which the reporting AP belongs. Also, this may be limited to the case where the reported AP belongs to an MLD. The predetermined value may be the largest value that the MLD ID subfield can represent. The predetermined value is may be 255. Additionally, n may be a MaxBSSID Indicator value that corresponds to the multiple BSSID set that includes the reporting AP.

In FIG. 25, a third multi-link device (MLD 3) may include an AP operating in the first link (link 1) and an AP operating in the second link (ink 2). In addition, the AP belonging to the third multi-link device (MLD 3) and operating in the first link (link 1) may not belong to the multiple BSSID set to which the reporting AP belongs. In this case, the value of an MLD ID subfield for the AP belonging to the third multi-link device (MLD 3) and operating in the first link (link 1) and the AP belonging to the third multi-link device (MLD 3) and operating in the second link (link 2) may be set to a value greater than 2\hat{ }n−1 and less than 255. This is because the AP belonging to the third multi-link device (MLD 3) and operating in the first link (link 1), and the AP belonging to the third multi-link device (MLD 3) and operating in the second link (link 2) do not belong to the multi-link device to which the reporting AP belongs, and the two APs are not included in the multi-link device including an AP in the multiple BSSID set to which the reporting AP belongs.

When the reporting AP does not transmit the multiple BSSID element and when the reported AP does not belong to the multi-link device to which the reporting AP belongs, the value of the MLD ID subfield may be set to a value greater than 0 and less than a predetermined value. Furthermore, this may be limited to the case where the reported AP belongs to the multi-link device. Furthermore, the predetermined value may be the largest value that the MLD ID subfield can represent. The predetermined value may be 255.

Additionally, the reporting AP may set the value of the MLD ID subfield to a predetermined value when 1) the reported AP does not belong a multi-link device, 2) the reporting AP does not have information about whether the reported AP belongs to the multi-link device, or 3) the reporting AP does not have information for setting the value of the MLD ID subfield as described above. In another specific embodiment, when 1) the reported AP does not belong to a multi-link device, 2) the reporting AP does not have information about whether the reported AP belongs to the multi-link device, or 3) the reporting AP does not have information for setting the value of the MLD ID subfield as described above, the reporting AP may set the value of the MLD ID subfield to a predetermined value or greater. The predetermined value may be the largest value that the MLD ID subfield can represent. The predetermined value may be 255.

In FIG. 25, a fourth AP (AP 4) operates in the first link (link 1). The fourth AP (AP 4) does not belong to any multi-link device. Therefore, the reporting AP may set the value of an MLD ID subfield corresponding to the fourth AP (AP 4) to 255.

A station may determine, based on an MAC address field in an MAC header of a received frame, a BSS from which the frame has been transmitted. Specifically, the station may determine, based on an MAC address field in an MAC header of a received frame, whether the received frame has been transmitted from an AP with which the station is associated or from an AP that belongs to a multiple BSSIDs including the AP with which the station is associated. In a specific embodiment, the station may determine, based on a TA field in the MAC header of a received frame, whether the received frame has been transmitted from an AP with which the station is associated or from an AP belonging to a multiple BSSID including the AP with which the station is associated. When the TA field of the frame received by the station indicates an MAC address of the AP to which the station is associated or an MAC address of the AP belonging to the multiple BSSID set including the AP with which the station is associated, the station may determine that the received frame has been transmitted from the AP with which the station is associated or the AP belonging to the multiple BSSID set including the AP with which the station is associated. When the TA field of the frame received by the station does not indicate the MAC address of the AP to which the station is associated or the MAC address of the AP belonging to the multiple BSSID set including the AP with which the station is associated, the station may determine that the received frame has been transmitted from the AP with which the station is associated or the AP belonging to the multiple BSSID set including the AP with which the station is associated.

The station may determine, based on the MAC address field in the MAC header of a received frame, an AP to which the frame is transmitted. In a specific embodiment, the station may determine, based on an RA field in the MAC header of a received frame, whether the frame has been transmitted to an AP with which the station is associated or to an AP belonging to a multiple BSSID including the AP with which the station is associated. When the RA field of the received frame indicates the MAC address of the AP with which the station is associated or the MAC address of the AP in the multiple BSSID set including the AP with which the station is associated, the station may determine that the received frame has been transmitted to the AP to which the station is associated or the AP in the multiple BSSID set including the AP with which the station is associated. When the RA field of the frame received by the station does not indicate the MAC address of the AP with which the station is associated and the MAC address of the AP belonging to the multiple BSSID set including the AP with which the station is associated, the station may determine that the received frame has been transmitted to the AP with which the station is associated and the AP belonging to the multiple BSSID set including the AP with which the station is associated.

The station may determine, based on an MAC address field in the MAC header of the received frame, whether the frame is an Inter-BSS frame. The MAC address field may include at least one of an RA field, a TA field, and a BSSID field. When none of the RA field, TA field, and the BSSID field of a frame received by the station indicate the MAC address of the AP with which the station is associated and the MAC address of the AP belonging to the multiple BSSID set including the AP with which the station is associated, the station may determine that the received frame is an Inter-BSS frame. When at least one of the RA field, TA field, and the BSSID field of a frame received by the station indicates the MAC address of the AP with which the station is associated and the MAC address of the AP belonging to the multiple BSSID set including the AP with which the station is associated, the station may determine that the received frame is an Intra-BSS frame.

In the above embodiments, a BSSID may be used instead of the MAC address of an AP.

When a BSS color that the preamble of a PPDU received by a station includes is the same as the BSS color of a BSS to which the station belongs, and when the preamble of the PPDU received by the station indicates that the preamble of the PPDU is intended for downlink transmission, the station may determine that the received PPDU has been transmitted by an AP with which the station is associated or by an AP belonging to a multiple BSSID set including the AP with which the station is associated. When a BSS color that the preamble of a PPDU received by the station includes is different from the BSS color of a BSS to which the station belongs, and when the preamble of the PPDU received by the station does not indicate that the preamble of the PPDU is intended for downlink transmission, the station may determine that the received PPDU has not been transmitted by the AP with which the station is associated or by the AP belonging to a multiple BSSID set including the AP with which the station is associated.

A multiple BSSID set may be a set of multiple BSSs where BSS-related information may be signaled in a single beacon frame or a single probe response frame. Specifically, the set of BSSIDs indicated by a single multiple BSSID element may be referred to as a multiple BSSID set. Further, a single TIM element in a single beacon frame or a single TIM frame may indicate a frame buffered to multiple BSSIDs included in a multiple BSSID set. Also, a single beacon frame or a single probe response frame may include a multiple BSSID element. The multiple BSSID element may signal information about multiple BSSs. The BSSID of a BSS in which the single beacon frame or the probe response frame described above was transmitted is referred to as a transmitted BSSID. In a multiple BSSID set, the remaining BSSIDs other than the transmitted BSSID may be referred to as nontransmitted BSSIDs. Also, in a BSS corresponding to each of the nontransmitted BSSID, a beacon frame or a probe response frame may not be transmitted.

As described above, the maximum number of BSSIDs that a multiple BSSID set can include is 2\hat{ }n. Here, n may be a value signaled in a multiple BSSID element. For example, n may be a value indicated by a MaxBSSID Indicator included in the multiple BSSID element. A station that receives a multiple BSSID element may determine, based on the received multiple BSSID element, the MAC address or BSSID of an AP included in a multiple BSSID set. Furthermore, multiple BSSID indexes may be mapped to BSSIDs in multiple BSSID set, respectively. Thus, the BSSIDs included in the multiple BSSID set may be identified by the BSSID indexes. The maximum value of the MaxBSSID Indicator may be 8.

However, there may be instances where it is not possible to set a value for an MLD ID subfield by using the above-described embodiment regarding a method for configuring an MLD ID subfield.

In the above-described embodiments, the reporting AP may set the value of the MLD ID subfield to a predetermined value when at least one of predesignated conditions is satisfied. In another specific embodiment, the reporting AP may set the value of the MLD ID subfield to a predetermined value or greater when a predetermined condition is satisfied. The predetermined value may be the largest value that the MLD ID subfield can represent. In this case, the predetermined value may be 255. The predesignated condition may include at least one of the following: 1) the reported AP does not belong to a multi-link device, 2) the reporting AP does not have information about whether the reported AP belongs to the multi-link device, and 3) the reporting AP does not have information for setting the value of an MLD ID subfield described earlier. In addition, the predetermined condition may include a condition that when the value of a MaxBSSID Indicator field corresponding to the reporting AP is the maximum value, the reported AP is not included in a multi-link device including an AP of a multiple BSSID set to which the reporting AP belongs. This condition may be that the reporting AP transmits a multiple BSSID element. The maximum of the MaxBSSID Indicator field may be 8. When the reporting AP transmits the multiple BSSID element, the MLD ID subfield may be set to the BSSID index of an AP in the multiple BSSID set that includes the reporting AP, provided that the reported AP is an AP in a multiple BSSID set that includes the reporting AP, or that the reported AP belongs to a multi-link device that includes an AP of the multiple BSSID set that includes the reporting AP. When the MaxBSSID Indicator subfield has a value of 8, the maximum number of BSSIDs that a multiple BSSID set can include is 2\hat{ }8=256. Therefore, under the above-described conditions, there may be no value greater than 2\hat{ }n−1 and less than 255.

In addition, when the value of the MaxBSSID Indicator subfield corresponding to the reporting AP is the maximum value, the reporting AP may not set the value of the MLD ID subfield, even if the reported AP belongs to a multi-link device that has an AP in a multiple BSSID set to which the reporting AP belongs. For example, the reporting AP may not indicate a multi-link device with a BSSID index of 255. This is because the value of the MLD ID subfield may be set to 255, based on the above-described embodiment. Therefore, when the value of the MLD ID subfield is 255, it is difficult to distinguish whether the value of the MLD ID subfield is set to 255 based on a BSSID index or is set to 255 based on a predetermined value.

Thus, the condition for setting the value of the MLD ID subfield to the predetermined value may further include the condition that when the value of the MaxBSSID Indicator subfield corresponding to the reporting AP is the maximum value, the reported AP belongs to a multi-link device that includes an AP in a multiple BSSID set to which the reporting AP belongs. In another specific embodiment, the use of 255 as a BSSID index in a multiple BSSID set may not be allowed.

Furthermore, according to the above-described embodiments, it may be difficult for the reporting AP to set the value of the MLD ID subfield, regardless of whether the reporting AP transmits a multiple BSSID element. For example, when the reporting AP indicates information about a large number of APs, it may be difficult for the reporting AP to set the value of the MLD ID subfield. The number of reported APs may be greater than the number of multi-link device IDs that can be set, making it difficult to identify the reported APs by using the multi-link device IDs. For example, when a reporting AP transmits a multiple BSSID element, and transmits information about more than (254−2\hat{ }n+1) APs, it may not be possible to identify the reported AP by using a limited range of multi-link device IDs. When the reporting AP does not transmit a multiple BSSID element and transmits information about more than (254−1+1) APs, it may not be possible to identify the reported AP by using a limited range of IDs. The condition that the value of the MLD ID subfield is set to a predetermined value may further include the case where the reported AP cannot be identified using a limited range of IDs.

To address the above-described problem, the size of the MLD ID subfield may be set to bits greater than 8 bits. In this case, the predetermined value may be the maximum value that can be indicated by the MLD ID subfield. That is, when the MLD ID subfield is N bits in size, the predetermined value may be 2\hat{ }N−1. For example, the MLD ID subfield is 9 bits in size, and the predefined value may be 511. In another example, the MLD ID subfield is 16 bits in size, and the predetermined value may be 65535.

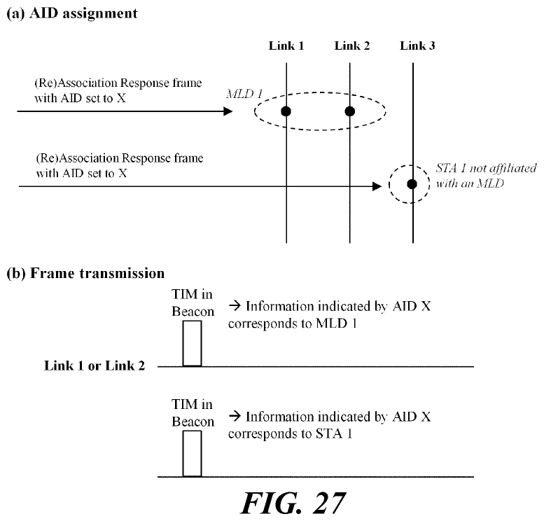

FIGS. 26 to 27 illustrate a method for assigning AIDs to non-AP stations belonging to a multi-link device according to embodiments of the present disclosure.

According to an embodiment of the present disclosure, a multi-link device may be assigned a single association ID (AID). That is, stations included in a single multi-link device may have the same AID.

AID assignment may be performed by an AP. For example, an AID assigned by the AP may be transmitted to a non-AP STA. The non-AP STA may recognize that the AID received from the AP is the AID that corresponds to the non-AP STA. The non-AP station that has received a subfield including an AID value assigned to the non-AP station may recognize that the subfield including the AID value assigned to the non-AP station indicates the non-AP station.

The AID assigned to the non-AP station may be included in an association response frame or a reassociation response frame. When a multi-link setup is performed after the AP assigns the AID to the non-AP station, the AID assigned to the non-AP station may be the AID assigned to a multi-link device to which the non-AP station belongs.

An AID or information related to the AID may be included in the preamble of a PPDU. The PPDU preamble may use the AID to indicate that an intended recipient of the PPDU is a non-AP station corresponding to the AID. The PPDU preamble may use the AID to indicate that a sender of the PPDU is a non-AP station that corresponds to the AID. In addition, as described above, an AID may be used for traffic indication. A frame may use an AID to indicate that a station corresponding to the AID is a recipient of the frame. For example, a trigger frame may use an AID to indicate a station triggered by the trigger frame.

An AID assigned to a multi-link device may not be allowed to be assigned to other stations or other multi-link devices. In a specific embodiment, an AID assigned to a multi-link device may not be allowed to be assigned to stations or multi-link devices that do not operate in a link used by the multi-link device.

In FIG. 26, a first multi-link device (MLD 1) operates in a first link (Link 1) and a second link (Link 2). Further, a second multi-link device (MLD 2) operates in a third link (Link 3) and a fourth link (Link 4). In this case, X is assigned as the AID of the first multi-link device (MLD 1). Therefore, the AID of the second multi-link device (MLD 2) is not allowed to be assigned X, but is assigned Y.

In a specific embodiment of the present disclosure, an AP multi-link device may reassign an AID assigned to one multi-link device to another station or another multi-link device. When predetermined conditions are satisfied, the AP multi-link device may reassign an AID assigned to one multi-link device to another station or another multi-link device. The predetermined conditions may include a condition that multi-link devices or stations with a single AID assigned in common operate in different links. That is, the predetermined conditions may include a condition that the multi-link devices or the stations with a single AID assigned in common operate in non-overlapping links. In this case, stations operating on a single link, and multiple multi-link devices may not be allowed to be assigned a single AID. In another specific embodiment, the predetermined conditions may include a condition that multi-link devices or stations, assigned a single AID in common, may include operating on non-overlapping channels.

In (a) of FIG. 27, a first multi-link device (MLD 1) operates in a first link (Link 1) and a second link (Link 2). An AP multi-link device assigns X as the AID of a station in the first multi-link device (MLD 1). In this time, the AP multi-link device may assign X as the AID of a first station (STA 1) that does not belong to the first multi-link device (MLD 1) device and operates in a third link (Link 3) other than the first link (Link 1) and the second link (Link 2).

In the above embodiment, when a frame includes information about multiple links, a single AID assigned to multiple multi-link devices or stations may cause confusion. To avoid the confusion, information transmitted on any one link may be applied to a station or a multi-link device operating in that link. For example, information transmitted in the first link may be applied to a station or a multi-link having an AID of X and operating in the first link, and may not be applied to a station or a multi-link having the AID of X and operating in the second link.

In (b) of FIG. 27, a beacon frame including a TIM is transmitted in each of the first link (Link 1) and the second link (Link 2). All of the TIMs transmitted in the first link (Link 1) and the second link (Link 2) indicate that traffic corresponding to an AID of X has been buffered. The TIM transmitted in the first link (Link 1) indicates that traffic is buffered for a multi-link device (MLD 1) operating in the first link (Link 1), and the TIM transmitted in the second link (Link 2) indicates that traffic is buffered for a station (STA 1) operating in the second link (Link 2).

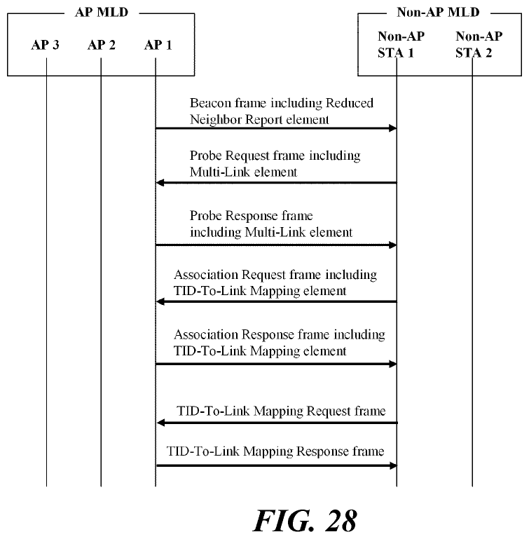

A TID-to-link mapping negotiation will be described with reference to FIGS. 28 to 30.

FIG. 28 illustrates a TID-to-link mapping negotiation according to an embodiment of the present disclosure.

As described above, default mapping may be applied to a link for which no TID-to-link mapping has been performed. In addition, when TID-to-link mapping is torn down in a link for which a TID-to-link mapping negotiation has been completed, default mapping may be applied to the link again.

TID-to-link mapping negotiation may be performed via a TID-to-link mapping request and a TID-to-link mapping response. Specifically, a multi-link device may perform a TID-to-link mapping request by transmitting a frame including a TID-to-link mapping element. The frame may include an association request frame, a reassociation request frame, and a TID-to-link mapping request frame. Therefore, a non-AP station or a non-AP multi-link device may request TID-to-link mapping by transmitting an association request frame, a reassociation request frame, or a TID-to-link mapping request frame. An AP or an AP multi-link device may request TID-to-link mapping by transmitting a TID-to-link mapping request frame. A multi-link device that receives a TID-to-link mapping request may perform a TID-to-link mapping response by transmitting a frame including a TID-To-Link Mapping element. The frame may include an association response frame, a reassociation response frame, and a TID-to-link mapping response frame. Therefore, an AP or an AP multi-link device may respond to a TID-to-link mapping request by transmitting an association response frame, a reassociation response frame, or a TID-to-link mapping request frame. A non-AP station or a non-AP station multi-link device may respond to a TID-to-link mapping request by transmitting a TID-to-link mapping response frame.

A multi-link device may initiate TID-to-link mapping by transmitting a TID-to-link mapping request. The multi-link device may request default mapping by transmitting a frame containing a TID-to-link element. A multi-link device that has received the TID-to-link mapping request may accept the TID-to-link mapping by transmitting a TID-to-link mapping response to the TID-to-link mapping request. The multi-link device that has received the TID-to-link mapping request may accept the TID-to-link mapping by transmitting a frame that does not include a TID-to-link Mapping element. In another specific embodiment, a multi-link device that has received the TID-to-link mapping request may accept the TID-to-link mapping by transmitting a frame including a TID-to-link Mapping element having the same content as the content of a TID-to-link Mapping element received from a non-AP multi-link device.

In addition, the multi-link device that has received the TID-to-link mapping request may reject the TID-to-link mapping by transmitting a TID-to-link mapping response to the TID-to-link mapping request. In this case, the multi-link device that has received the TID-to-link mapping request may reject the TID-to-link mapping by transmitting a frame that does not include a TID-to-link Mapping element. In another specific embodiment, a multi-link device that has received a TID-to-link mapping request may reject TID-to-link mapping by transmitting a frame including a TID-to-link mapping element having content different from the content of a received TID-to-link mapping element. When the TID-to-link mapping is rejected, default mapping may be applied to a link.

In the above embodiments, the frames that the multi-link device transmits for the TID-to-link mapping request and response may each include at least one of an association request frame, an association response frame, a reassociation request frame, a reassociation response frame, a TID-to-link mapping request frame, and a TID-to-link mapping response frame, as described above. Specifically, a multi-link device that has received a TID-to-link mapping request may transmit a TID-to-link mapping response frame in response to the TID-to-link mapping request. The multi-link device that has received the TID-to-link mapping request may accept or reject the TID-to-link mapping request by inserting a state code into the TID-to-link mapping response frame. Specifically, a multi-link device that has received a TID-to-link mapping request may accept the TID-to-link mapping request by setting a state code in a TID-to-link mapping response frame to SUCCESS. In addition, the multi-link device that has received a TID-to-link mapping request may reject the TID-to-link mapping request by setting a status code in a TID-to-link mapping response frame to REJECT or DENIED_TID_TO_LINK_MAPPING. In addition, a multi-link device that has received a TID-to-link mapping request may reject the TID-to-link mapping request by setting a status code in a TID-to-link mapping response frame to PREFERRED_TID_TO_LINK_MAPPING_SUGGESTED. In this case, the multi-link device that has received the TID-to-link mapping request may reject the TID-to-link mapping request and propose preferred TID-to-link mapping. In addition, the multi-link device that has received the TID-to-link mapping request may reject the TID-to-link mapping request by transmitting a TID-to-link mapping rejection frame.

A TID-to-Link Mapping element included in a TID-to-link matching request indicates TID-to-link mapping that is the subject of the TID-to-link mapping request. A TID-to-Link Mapping element transmitted when accepting TID-to-link mapping may indicate the accepted TID-to-link mapping. In addition, a TID-To-Link Mapping element transmitted when rejecting TID-to-link mapping may indicate new proposed TID-to-link mapping.

When a TID-to-link mapping request is accepted, TID-to-link mapping included in the TID-to-link mapping request is set in a link targeted for the TID-to-link mapping. Also, when the TID-to-link mapping request is rejected, default mapping may be applied to the link targeted for the TID-to-link mapping.

Additionally, for a TID-to-link mapping negotiation, each of a TID-to-link mapping request frame and a TID-to-link mapping response frame may include dialog token. The dialog tokens map the TID-to-link mapping request frame and the TID-to-link mapping response frame. Specifically, when the value of the dialog token in the TID-to-link mapping request frame is equal to the value of the dialog token in the TID-to-link mapping response frame, the TID-to-link mapping response frame may have been transmitted in response to the TID-to-link mapping request frame. Therefore, when a multi-link device that has received a TID-to-link mapping request frame transmits a TID-to-link mapping response frame, the multi-link device may set the dialog of the TID-to-link mapping request frame to the value of a dialog token in the TID-to-link mapping request frame. When a multi-link device transmits a TID-to-link mapping response frame without receiving a TID-to-link mapping request frame, the multi-link device may set the value of a dialog token in the TID-to-link mapping response frame to a predetermined value. The predetermined value may be 0. That is, when the multi-link device transmits an unsolicited TID-To-Link Mapping Response frame, the multi-link device may set the value of the dialog token in the TID-to-link Mapping Response frame to the predetermined value. In a TID-to-link mapping request frame and a TID-to-link mapping response frame, fields that indicate dialog tokens may be 1-octet fields. The dialog tokens may each have one of values of 0 to 255.

When the capability of a multi-link device support TID-to-link mapping, the multi-link device may perform the TID-to-link mapping. In addition, the range within which the multi-link device can conduct TID-to-link mapping may vary depending on the capability of the multi-link device. For example, the number of TIDs that a multi-link device can map to a link, or the number of combinations of TIDs and link mapping that can be applied, may vary depending on the capability of the multi-link device. The capability of a multi-link device may indicate whether the multi-link device can map all TIDs to the same link set. In addition, the capability of a multi-link device may indicate how many link sets the multi-link device can map TIDs to.

In the embodiment of FIG. 28, an AP multi-link device (AP ML) includes a first AP (AP 1), a second AP (AP 2), and a third AP (AP 3). A non-AP multi-link device (Non-AP MLD) includes a first non-AP station (Non-AP STA 1) and a second non-AP station (Non-AP STA 2). The non-AP multi-link device (Non-AP MLD) transmits, to the AP multi-link device (AP ML), an association request frame including a TID-to-link Mapping element. The AP multi-link device (AP ML) may accept or reject TID-to-link mapping corresponding to the TID-to-link Mapping element by transmitting an association response frame including a TID-to-link Mapping element to the non-AP multi-link device (Non-AP MLD). In addition, the non-AP multi-link device (Non-AP MLD) may transmit a TID-to-link mapping request frame to the AP multi-link device (AP ML) to renegotiate TID-to-link mapping. In this case, the AP multi-link device (AP ML) may transmit a TID-to-link mapping response frame to the non-AP multi-link device (Non-AP MLD) to accept or reject the TID-to-link mapping corresponding to the TID-to-link Mapping element.

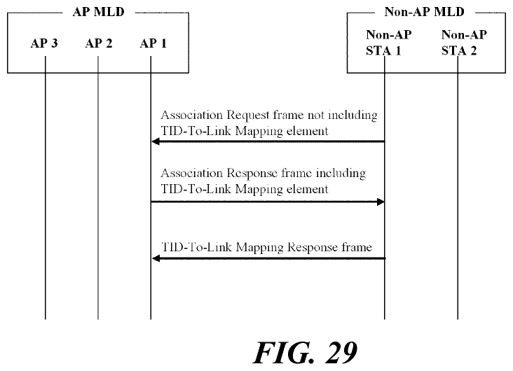

FIG. 29 illustrates a TID-to-link mapping negotiation through which an AP multi-link device transmits a TID-to-link mapping request according to an embodiment of the present disclosure.

The AP multi-link device may transmit a TID-to-link mapping request via an association response frame, a reassociation response frame, and a TID-to-link mapping request frame. Specifically, an AP multi-link device may initiate a TID-to-link mapping negotiation by using an association response frame, a reassociation response frame, and a TID-to-link mapping request frame. The AP multi-link device may include a TID-to-link Mapping element in the association response frame, the reassociation response frame, and the TID-to-link mapping request frame. Specifically, the AP multi-link device may include a TID-to-link Mapping element in the association response frame, reassociation response frame, and TID-to-link mapping request frame, and initiate a TID-to-link mapping negotiation. This is because a TID-to-link mapping request transmitted by a non-AP multi-link device may be in a form that the AP multi-link device does not want, and the non-AP multi-link device may not transmit the TID-to-link mapping request. In addition, the AP multi-link device may more easily comprehend the overall network situation compared to the non-AP multi-link device, enabling efficient determination of TID-to-link mapping. At this time, the AP multi-link device first transmit an association response frame or a reassociation response frame before completing the TID-to-link mapping negotiation, so that multi-link setup and reset can be completed. The TID-to-link mapping negotiation is completed successfully when the non-AP multi-link device that has received the TID-to-link mapping request transmits a TID-to-link mapping response.

The instances in which the AP multi-link device may transmit a TID-to-link mapping request via an association response frame and a reassociation response frame may be limited. Specifically, when an association request frame does not request TID-to-link mapping, the AP multi-link device may transmit a TID-to-link mapping request via an association response frame. When the association request frame does not include a TID-to-link Mapping element, the AP multi-link device may determine that the association request frame does not request TID-to-link mapping. Also, when a reassociation request frame does not request TID-to-link mapping, the AP multi-link device may transmit a TID-to-link mapping request via the reassociation response frame. When a reassociation request frame does not include a TID-to-link Mapping element, the AP multi-link device may determine that the reassociation request frame does not request TID-to-link mapping. When an association request frame transmitted by the non-AP multi-link device does not include a TID-to-link Mapping element, the non-AP multi-link device may determine that an association response frame, which is received in response to the association request frame and includes a TID-to-link Mapping element, requests TID-to-link mapping. When a reassociation request frame transmitted by the non-AP multi-link device does not include a TID-to-link Mapping element, the non-AP multi-link device may determine that a reassociation response frame, which is received in response to the reassociation request frame and includes a TID-to-link Mapping element, requests TID-to-link mapping. The above embodiments are provided because when the association request frame includes a TID-to-link element and the association request frame contains a TID-to-link element, the non-AP multi-link device may be confused about the intent of inclusion of the TID-to-link element in the association response frame. This is also true for the reassociation request frame.

Furthermore, in the above embodiments, the AP multi-link device may not determine that the TID-to-link mapping has been successfully completed until the AP multi-link device receives a TID-to-link mapping response from the non-AP multi-link device. Therefore, the AP multi-link device may operate based on default mapping until receiving a TID-to-link mapping response from the non-AP multi-link device. Also, even when the AP multi-link device receives ACK regarding an association response frame or a reassociation response frame, the AP multi-link device may not determine that the TID-to-link mapping was completed successfully.

The non-AP multi-link device may respond to a TID-to-link mapping request that has been transmitted by the AP multi-link device via an association frame or a reassociation frame in accordance with the above-described embodiments. However, the non-AP multi-link device needs to clearly indicate that the non-AP multi-link device responds to the TID-to-link mapping request transmitted by the AP multi-link device via the association frame or the reassociation frame. The non-AP multi-link device may transmit a TID-to-link mapping response in a response frame to an association response frame requesting TID-to-link mapping or to a reassociation response frame requesting TID-to-link mapping. In addition, the non-AP multi-link device may set the value of a dialog token in the TID TID-to-link mapping response to be the same as the value of a dialog token included in the association response frame requesting TID-to-link mapping or the reassociation response frame requesting TID-to-link mapping. However, the association response frame requesting TID-to-link mapping and the reassociation response frame dialog token requesting TID-to-link mapping may not include dialog tokens.

Therefore, the TID-to-link Mapping element may include a response indication field indicating that the same is a response to a TID-to-link mapping request. The response indication field may be included in the TID-to-Link Mapping Control field described above. Specifically, the response indication field may be included in a reserve field of the TID-to-Link Mapping Control field described above. For example, the response indication field may be any one of the fourth bit (B3) to the eighth bit (B8) of the TID-to-Link Mapping Control field. A multi-link device having received the TID-to-link element may determine, based on the response indication field, that the TID-to-link Mapping element is requesting TID-to-link mapping.

Since the non-AP multi-link device transmits a TID-to-link mapping response frame in response to an association request frame or a reassociation request frame, the AP multi-link device needs to distinguish which frame is a frame to the TID-to-link mapping response frame responses. Specifically, when the non-AP multi-link device transmits a TID-to-link mapping response frame in response to an association request frame or a reassociation request frame, the non-AP multi-link device may set the value of a dialog token in the TID-to-link mapping response frame to a random value. In addition, when the value of the dialog token in the TID-to-link mapping response frame is equal to the value of a dialog token in the TID-to-link mapping request frame transmitted by the AP multi-link device, the AP multi-link device may determine that the TID-to-link mapping response frame is a response to the TID-to-link mapping request frame. In addition, when the value of the dialog token in the TID-to-link mapping response frame is different from the value of the dialog token in the TID-to-link mapping request frame transmitted by the AP multi-link device, the AP multi-link device may determine that the TID-to-link mapping response frame is a response to an association request frame or a reassociation request frame.

In another specific embodiment, when the AP multi-link device transmits a TID-to-link mapping request via an association response frame or a reassociation response frame, the value of a dialog token in a TID-to-link mapping response frame transmitted in response to the TID-to-link mapping request may be set to a predetermined value. The predetermined value may be 0, 1, or 255. When the AP multi-link device transmits a TID-to-link mapping request via an association frame or a reassociation frame and receives a TID-to-link mapping response frame having the predetermined value as the value a dialog token, the AP multi-link device may determine that the received TID-to-link mapping response frame is a response to the transmitted TID-to-link mapping request.

In another specific embodiment, when the AP multi-link device transmits a TID-to-link mapping request via an association response frame or a reassociation response frame, the state code of a TID-to-link mapping response frame transmitted in response to the TID-to-link mapping request may be a predetermined value. In this case, the predetermined value of the state code may differ from the value of the state code of a TID-to-link mapping response frame transmitted in response to a TID-to-link mapping request that the multi-link device transmits in frames other than the association frame and the reassociation frame. Thus, the AP multi-link device may determine, based on the state code of the received TID-to-link mapping response frame, whether the received TID-to-link mapping response frame is a response to a TID-to-link mapping request transmitted by the AP multi-link device via an association response frame or a reassociation response frame. Specifically, when the state code of the received TID-to-link mapping response frame is the predetermined value, the AP multi-link device may determine that the received TID-to-link mapping response frame is a response to the TID-to-link mapping request that the AP multi-link device has transmitted via the association response frame or the reassociation response frame.

In another specific embodiment, the AP multi-link device may determine, based on the value of a Link Mapping field for a TID in a received TID-to-link mapping response frame, that the received TID-to-link mapping response frame is a response to a TID-to-link mapping request transmitted by the AP multi-link device via an association response frame or a reassociation response frame. Specifically, when the value of the Link Mapping field for the TID in the received TID-to-link mapping response frame is equal to the value of a Link Mapping field for a TID in a TID-to-link mapping request transmitted by the AP multi-link device via an association response frame or a reassociation response frame, the AP multi-link device may determine that the received TID-to-link mapping response frame is a response to the TID-to-link mapping request transmitted by the AP multi-link device via the association response frame or the reassociation response frame. Specifically, the received TID-to-link mapping response frame may include Link Mapping fields for multiple TIDs. When the values of all of the Link Mapping fields included in the TID-to-link mapping response frame are equal to the values of all of Link Mapping fields in the TID-to-link mapping request transmitted by the AP multi-link device via the association response frame or the reassociation response frame, the AP multi-link device may determine that the received TID-to-link mapping response frame is a response to the TID-to-link mapping request transmitted by the AP multi-link device via the association response frame or the reassociation response frame. When the value of a Link Mapping field for a TID in a TID-to-link mapping response frame received by the AP multi-link device is different from the value of a Link Mapping field for a TID in a TID-to-link mapping request transmitted by the AP multi-link device via an association response frame or a reassociation response frame, the AP multi-link device may not transmit ACK for the received TID-to-link mapping response frame. In addition, when a Link Mapping field for a TID in a TID-to-link mapping response frame received by the AP multi-link device includes at least one of the values of Link Mapping fields for TIDs in a TID-to-link mapping request transmitted by the AP multi-link device in an association response frame or a reassociation response frame, the AP multi-link device may not transmit ACK for the received TID-to-link mapping response frame. Also, when a TID-to-link mapping response frame received by the AP multi-link device does not include any Link Mapping field for the TID in a TID-to-link mapping request transmitted by the AP multi-link device in an association response frame or reassociation response frame, or when the value of the Link Mapping field in the TID-to-link mapping response frame received by the multi-link device is different from the value of the Link Mapping field for the TID in the TID-to-link mapping request transmitted via the association response frame or reassociation response frame, the AP multi-link device may not transmit ACK for the received TID-to-link mapping response frame. The above-described embodiments may also be applied when a TID-to-link mapping request is not transmitted via an association response frame or a reassociation response frame.

In the embodiment of FIG. 29, an AP multi-link device (AP ML) includes a first AP (AP 1), a second AP (AP 2), and a third AP (AP 3). A non-AP multi-link device (Non-AP MLD) includes a first non-AP station (Non-AP STA 1) and a second non-AP station (Non-AP STA 2). The non-AP multi-link device (Non-AP MLD) transmits, to the AP multi-link device (AP ML), an association request frame that does not include a TID-to-link Mapping element. The AP multi-link device (AP ML) transmits an association response frame including a TID-to-link Mapping element to a non-AP multi-link device (Non-AP MLD) to request TID-to-link mapping corresponding to the TID-to-link Mapping element. In this case, the non-AP multi-link device (Non-AP MLD) accepts the TID-to-link mapping request by transmitting a TID-to-link mapping response frame to the AP multi-link device (AP ML).

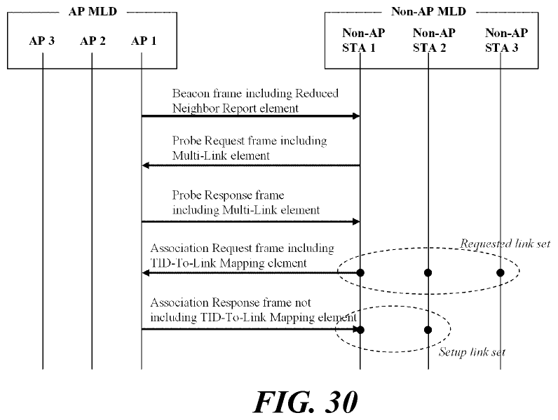

FIG. 30 illustrates a TID-to-link mapping negotiation when a link set for requesting TID-to-link mapping is different from a link set configured by a TID-to-link mapping response according to an embodiment of the present disclosure.

A link set for requesting TID-to-link mapping in an association request frame or a reassociation request frame may be different from a link set for configuring TID-to-link mapping in an association response frame or a reassociation response frame. For example, TID-to-link mapping may be requested for three links in an association request frame or a reassociation request frame, and TID-to-link mapping may be configured for two links in an association response frame or a reassociation response frame. In addition, the difference between link sets may include the difference between link set configurations. Specifically, the difference between the link sets may include the difference between operating channels of the link sets. Further, the difference between the link sets may include the difference between configurations of the link sets.

In some embodiments of FIG. 28, when an AP multi-link device receives an association request frame or a reassociation request frame that includes a TID-to-link mapping element, the AP multi-link device may transmit an association response frame or a reassociation response frame that does not include a TID-to-link mapping element, thereby setting multi links. However, as described above, the link set for requesting TID-to-link mapping in the association request frame or the reassociation request frame may be different from the link set for configuring TID-to-link mapping in the association response frame or the reassociation response frame.

Therefore, in another embodiment of the present disclosure, when an AP multi-link device receives an association request frame or reassociation request frame that includes a TID-to-link Mapping element, and when AP multi-link device wants to configure a link set different from a link set of multiple links that the association request frame or the reassociation request frame wants to set up, the AP multi-link device may transmit an association response frame or reassociation response frame that does not include the TID-to-link Mapping element. Thus, the AP multi-link device may reject the TID-to-link mapping. In this case, default mapping may be applied to the AP multi-link device and the non-AP multi-link device.

When the AP multi-link device receives an association request frame or a reassociation request frame that includes a TID-to-link Mapping element, and the AP multi-link device transmits an association response frame or a reassociation response frame that configures a link set different from a link set of multiple links that the association request frame or reassociation request frame wants to set up, the AP multi-link device may transmit an association response frame or a reassociation response frame that does not include a TID-to-link Mapping element. In addition, when the non-AP multi-link device transmits an association request frame or a reassociation request frame that includes a TID-to-link Mapping element and receives an association response frame or a reassociation response frame that configures a link set different from a link set of multiple links which the association request frame or the reassociation request frame wants to set up, the non-AP multi-link device may determine that the TID-to-link mapping request has been rejected even when the received association response frame or reassociation response frame does not include a TID-to-link Mapping element. In this case, default mapping may be applied to the AP multi-link device and the non-AP multi-link device.

In another specific embodiment, when the AP multi-link device receives an association request frame or a reassociation request frame including a TID-to-link Mapping element, and wants to configure a link set different from a link set of multiple links that the association request frame or the reassociation request frame wants to set up, the AP multi-link device may transmit an association response frame or a reassociation response frame that includes a TID-to-link Mapping element. In this case, the TID-to-link mapping element, which the association response frame or the reassociation response frame includes, may indicate TID-to-link mapping proposed by the AP multi-link device. In this case, the operation of the non-AP multi-link device may be the same as the embodiments described with reference to FIG. 28.

In the above-described embodiments, for ease of description, the operation of a multi-link device has been described. The operation of the multi-link device may also be performed by a station included in the multi-link device.

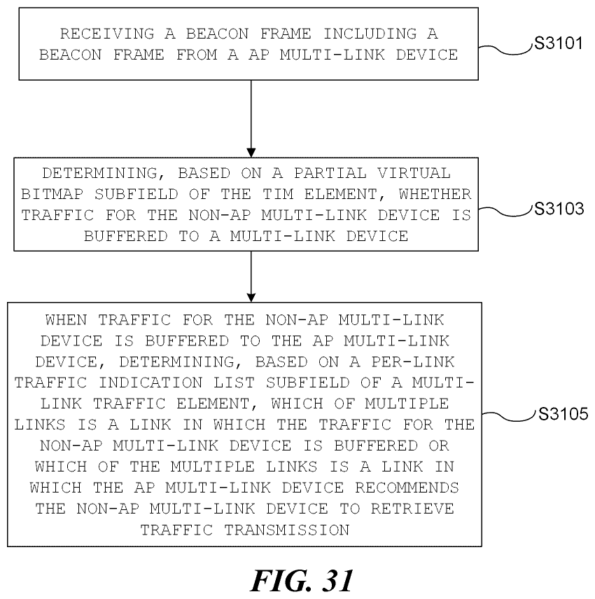

FIG. 31 illustrates a method by which a non-AP multi-link device according to an embodiment of the present disclosure determines traffic buffered to an AP multi-link device.

The non-AP multi-link device receives a beacon frame including a beacon frame from the AP multi-link device (S3101).

The non-AP multi-link device determines, based on a Partial Virtual Bitmap subfield of the TIM element, whether traffic for the non-AP multi-link device is buffered to a multi-link device (S3103). In this case, the Partial Virtual Bitmap subfield includes one or more first bits and one or more second bits, wherein a bit set to 1 among the one or more first bits may indicate that traffic for a non-AP multi-link device corresponding to the bit is buffered to the AP multi-link device. Furthermore, a bit set to 1 among the one or more second bits may indicate whether traffic for a non-AP station corresponding to the bit is buffered to the AP multi-link device. Specific Partial Virtual Bitmap subfield format and configuration may follow the embodiments described with reference to FIGS. 13 to 18.

When traffic for the non-AP multi-link device is buffered to the AP multi-link device, it may be determined, based on a Per-Link Traffic Indication List subfield of a Multi-Link Traffic element, which of multiple links is a link in which the traffic for the non-AP multi-link device is buffered or which of the multiple links is a link in which the AP multi-link device recommends the non-AP multi-link device to retrieve traffic transmission. The Per-Link Traffic Indication List subfield may include n Per-Link Traffic Indication Bitmap subfields. Here, n is a value obtained by summing the number of bits set to 1 among the one or more first bits and the number of bits set to 1 among the one or more second bits. Further, the n Per-Link Traffic Indication Bitmap subfields may be mapped to a non-AP multi-link device corresponding to the bit set to 1 among the one or more first bits and a non-AP station corresponding to the bit set to 1 among the one or more second bits, respectively. Furthermore, multiple link IDs may be mapped in ascending order to bits of a Per-Link Traffic Indication Bitmap subfield mapped to the non-AP multi-link device.

Further, a Per-Link Traffic Indication Bitmap subfield mapped to the non-AP station corresponding to the bit set to 1 among the one or more second bits may be configured as a reserved bit. In this case, the value of the reserved bit may be 0.

When the non-AP multi-link device successfully performs TID-to-link mapping with the AP multi-link device, and when not all TIDs are mapped to all links, a Per-Link Traffic Indication Bitmap subfield mapped to the non-AP multi-link device may indicate whether traffic for the non-AP multi-link device is buffered in each of the multiple links. Additionally, when the default mapping is applied to a link between the non-AP multi-link device and the AP multi-link device, the Per-Link Traffic Indication Bitmap subfield mapped to the non-AP multi-link device may indicate which of the multiple links is a link in which the non-AP multi-link device is recommended to retrieve traffic transmission. In this case, in the default mapping, all TIDs may be mapped to all links.

A bit, which is not set up by the AP multi-link device or the non-AP multi-link device, among bits in the Per-Link Traffic Indication Bitmap subfield mapped to the non-AP multi-link devices, may be configured as a reserved bit. Further, among the bits of the Per-Link Traffic Indication Bitmap subfield mapped to the non-AP multi-link device, a bit corresponding to a disabled link of the non-AP multi-link device may be configured as a reserved bit. In this case, the disabled link may be a link in which uplink and downlink transmission is stopped.

The Per-Link Traffic Indication List subfield of a specific Multi-Link Traffic element may follow the embodiments described with reference to FIGS. 13 to 18.

Although the present disclosure is described by using wireless LAN communication as an example, it is not limited thereto and may be also applied to the same to other communication systems such as cellular communication. In addition, the method, device, and system of the present disclosure are described in relation to a specific embodiment thereof, but some or all of the elements or operations of the present disclosure may be implemented using a computer system having general purpose hardware architecture.

The features, structures, effects, and the like described in the above embodiments are included in at least one embodiment of the present disclosure and are not necessarily limited to one embodiment. Furthermore, features, structures, effects, and the like shown in each embodiment may be combined or modified in other embodiments by those skilled in the art. Therefore, it should be interpreted that contents relating to such a combination and modification are to be included in the range of the present disclosure.

Although the present disclosure is described mainly based on the above embodiments but is not limited thereto, it will be understood by those skilled in the art that various changes and modifications are made without departing from the spirit and scope of the present disclosure. For example, each element specifically shown in the embodiments may be modified and implemented. In addition, it should be interpreted that differences relating to such modifications and applications are included in the scope of the present disclosure defined in the appended claims.

1. A non-access point (non-AP) multi-link device comprising multiple stations each operating in multiple links, the multi-link device comprising:
a transceiver; and
a processor,
wherein the processor is configured to:
receive a beacon frame comprising a TIM element and a Multi-Link Traffic element from an AP multi-link device;
determine, based on a Partial Virtual Bitmap subfield of the TIM element, whether traffic for the non-AP multi-link device has been buffered to the AP multi-link device, wherein the Partial Virtual Bitmap subfield comprises one or more first bits and one or more second bits, a bit set to 1 among the one or more first bits indicates that traffic for a non-AP multi-link device corresponding to the bit has been buffered to the AP multi-link device, and a bit set to 1 among the one or more second bits indicates whether traffic for a non-AP station corresponding to the bit has been buffered to the AP multi-link device; and
when the traffic for the non-AP multi-link device has been buffered to the AP multi-link device, determine, based on a Per-Link Traffic Indication List subfield of the Multi-Link Traffic element, which of the multiple links is a link in which the traffic for the non-AP multi-link device has been buffered or which of the multiple links is a link in which the AP multi-link device recommends the non-AP multi-link device to retrieve traffic transmission,
wherein the Per-Link Traffic Indication List subfield comprises n Per-Link Traffic Indication Bitmap subfields,
wherein n is a value obtained by summing the number of bits set to 1 among the one or more first bits and the number of bits set to 1 among the one or more second bits, and
wherein the n Per-Link Traffic Indication Bitmap subfields are mapped to a non-AP multi-link device corresponding to the bit set to 1 among the one or more first bits and a non-AP station corresponding to the bit set to 1 among the one or more second bits, respectively.

2. The multi-link device of claim 1, wherein the Per-Link Traffic Indication Bitmap subfield mapped to the non-AP station corresponding to the bit set to 1 among the one or more second bits is configured as a reserved bit.

3. The multi-link device of claim 1, wherein the reserved bit has a value of 0.

4. The multi-link device of claim 1, wherein when the non-AP multi-link device successfully performs TID-to-link mapping with the AP multi-link device and that not all TIDs are mapped to all links, the Per-Link Traffic Indication Bitmap subfield mapped to the non-AP multi-link device indicates whether the traffic for the non-AP multi-link device is buffered in each of the multiple links.

5. The multi-link device of claim 4, wherein among bits in the Per-Link Traffic Indication Bitmap subfield mapped to the non-AP multi-link device, a bit corresponding to a link that is not set up by the AP multi-link device or the non-AP multi-link device is configured as a reserved bit.

6. The multi-link device of claim 4, wherein among the bits in the Per-Link Traffic Indication Bitmap subfield mapped to the non-AP multi-link device, a bit corresponding to a disabled link of the non-AP multi-link device is configured as a reserved bit, and
wherein the disabled link is a link in which uplink transmission and downlink transmission have been stopped.

7. The multi-link device of claim 4, wherein the multiple link IDs are mapped, in ascending order, to the bits in the Per-Link Traffic Indication Bitmap subfield mapped to the non-AP multi-link device.

8. The multi-link device of claim 1, wherein when an AP having transmitted the beacon frame in the AP multi-link device does not belong to a multiple BSSID set, the range of values that the AP multi-link device is capable of assigning as an association ID (AID) is determined based on a value of a Group Addressed BU Indication Exponent subfield, and
wherein the value of the Group Addressed BU Indication Exponent subfield indicates the number of bits that is to be used to indicate a buffered group addressed frame corresponding to an AP different from the AP having transmitted the beacon frame in the AP multi-link device.

9. The multi-link device of claim 8, wherein when the AP having transmitted the beacon frame in the AP multi-link device belongs to the multiple BSSID set, the range of values that the AP multi-link device is capable of assigning as an AID is determined based on the value of the Group Addressed BU Indication Exponent subfield and a bitmap limit, and
wherein the bitmap limit is 48 bits.

10. An access point (AP) multi-link device comprising multiple stations each operating in multiple links, the multi-link device comprising:
a transceiver; and
a processor,
wherein the processor is configured to:
configure a TIM element and a Multi-Link Traffic element which is to be included in a beacon frame to be transmitted to a non-AP multi-link device, wherein the TIM element comprises a Partial Virtual Bitmap subfield, the Partial Virtual Bitmap subfield comprises one or more first bits and one or more second bits, a bit set to 1 among the one or more first bits indicates that traffic for a non-AP multi-link device corresponding to the bit has been buffered to the AP multi-link device, and a bit set to 1 among the one or more second bits indicates whether traffic for a non-AP station corresponding to the bit has been buffered to the AP multi-link device;
when the traffic for the non-AP multi-link device has been buffered to the AP multi-link device, configure a Per-Link Traffic Indication List subfield of the Multi-Link Traffic element, based on which of the multiple links is a link in which the traffic for the non-AP multi-link device has been buffered or which of the multiple links is a link in which the AP multi-link device recommends the non-AP multi-link device to retrieve traffic transmission; and
transmit the beacon frame by using the transceiver, wherein the Per-Link Traffic Indication List subfield comprises n Per-Link Traffic Indication Bitmap subfields,
wherein n is a value obtained by summing the number of bits set to 1 among the one or more first bits and the number of bits set to 1 among the one or more second bits, and
wherein the n Per-Link Traffic Indication Bitmap subfields are mapped to a non-AP multi-link device corresponding to the bit set to 1 among the one or more first bits and a non-AP station corresponding to the bit set to 1 among the one or more second bits, respectively.

11. The multi-link device of claim 10, wherein the processor is configured to configure, as a reserved bit, the Per-Link Traffic Indication Bitmap subfield that is mapped to the non-AP station corresponding to the bit set to 1 among the one or more second bits.

12. The multi-link device of claim 10, wherein the reserved bit has a value of 0.

13. The multi-link device of claim 10, wherein when the non-AP multi-link device successfully performs TID-to-link mapping with the AP multi-link device and that not all TIDs are mapped to all links, the Per-Link Traffic Indication Bitmap subfield mapped to the non-AP multi-link device indicates whether the traffic for the non-AP multi-link device is buffered in each of the multiple links, wherein when default mapping is applied to a link between the non-AP multi-link device and the AP multi-link device, the Per-Link Traffic Indication Bitmap subfield mapped to the non-AP multi-link device indicates which of the multiple links is a link in which the non-AP multi-link device is recommended to retrieve traffic transmission, and
wherein in the default mapping, all TIDs are mapped to all links.

14. The multi-link device of claim 13, wherein the processor is configured to configure, as a reserved bit, a bit corresponding to a link that is not set up by the AP multi-link device or the non-AP multi-link device among bits in the Per-Link Traffic Indication Bitmap subfield mapped to the non-AP multi-link device.

15. The multi-link device of claim 13, wherein the processor is configured to configure, as a reserved bit, a bit corresponding to a disabled link of the non-AP multi-link device among the bits in the Per-Link Traffic Indication Bitmap subfield mapped to the non-AP multi-link device, and
wherein the disabled link is a link in which uplink transmission and downlink transmission have been stopped.

16. The multi-link device of claim 13, wherein the multiple link IDs are mapped, in ascending order, to the bits in the Per-Link Traffic Indication Bitmap subfield mapped to the non-AP multi-link device.

17. The multi-link device of claim 10, wherein when an AP having transmitted the beacon frame in the AP multi-link device does not belong to a multiple BSSID set, the range of values that the AP multi-link device is capable of assigning as an association ID (AID) is determined based on a value of a Group Addressed BU Indication Exponent subfield, and
wherein the value of the Group Addressed BU Indication Exponent subfield indicates the number of bits that is to be used to indicate a buffered group addressed frame corresponding to an AP different from the AP having transmitted the beacon frame in the AP multi-link device.

18. The multi-link device of claim 17, wherein when the AP having transmitted the beacon frame in the AP multi-link device belongs to the multiple BSSID set, the range of values that the AP multi-link device is capable of assigning as an AID is determined based on the value of the Group Addressed BU Indication Exponent subfield and a bitmap limit, and
wherein the bitmap limit is 48 bits.

19. A method for operating a non-access point (non-AP) multi-link device comprising multiple stations each operating in multiple links, the method comprising:
receiving a beacon frame comprising a TIM element and a Multi-Link Traffic element from an AP multi-link device;
determining, based on a Partial Virtual Bitmap subfield of the TIM element, whether traffic for the non-AP multi-link device has been buffered to the AP multi-link device, wherein the Partial Virtual Bitmap subfield comprises one or more first bits and one or more second bits, a bit set to 1 among the one or more first bits indicates that traffic for a non-AP multi-link device corresponding to the bit has been buffered to the AP multi-link device, and a bit set to 1 among the one or more second bits indicates whether traffic for a non-AP station corresponding to the bit has been buffered to the AP multi-link device; and
when the traffic for the non-AP multi-link device has been buffered to the AP multi-link device, determining, based on a Per-Link Traffic Indication List subfield of the Multi-Link Traffic element, which of the multiple links is a link in which the traffic for the non-AP multi-link device has been buffered or which of the multiple links is a link in which the AP multi-link device recommends the non-AP multi-link device to retrieve traffic transmission,
wherein the Per-Link Traffic Indication List subfield comprises n Per-Link Traffic Indication Bitmap subfields,
wherein n is a value obtained by summing the number of bits set to 1 among the one or more first bits and the number of bits set to 1 among the one or more second bits, and
wherein the n Per-Link Traffic Indication Bitmap subfields are mapped to a non-AP multi-link device corresponding to the bit set to 1 among the one or more first bits and a non-AP station corresponding to the bit set to 1 among the one or more second bits, respectively.

20. The method of claim 19, wherein the Per-Link Traffic Indication Bitmap subfield mapped to the non-AP station corresponding to the bit set to 1 among the one or more second bits is configured as a reserved bit.
